(19) United States
(12) Patent Application Publication
(10) Pub. No.: US 2026/0287855 A1
(43) Pub. Date: Sep. 24, 2026

(54) OPTICAL PHOTOGRAPHING LENS SYSTEM, IMAGE CAPTURING UNIT AND ELECTRONIC DEVICE

(71) Applicant: LARGAN PRECISION CO., LTD., Taichung City (TW)

(72) Inventors: Tzu-Hsiang HUNG, Taichung City (TW); Yu-Han SHIH, Taichung City (TW)

(73) Assignee: LARGAN PRECISION CO., LTD., Taichung City (TW)

(21) Appl. No.: 19/245,511

(22) Filed: Jun. 23, 2025

(30) Foreign Application Priority Data
Mar. 24, 2025 (TW) 114110995

(51) Int. Cl. G02B 13/00; G02B 9/64

(52) U.S. Cl. CPC G02B 13/0045; G02B 9/64

(57) ABSTRACT

An optical photographing lens system includes eight lens elements which are, in order from an object side to an image side along an optical path: a first lens element, a second lens element, a third lens element, a fourth lens element, a fifth lens element, a sixth lens element, a seventh lens element and an eighth lens element. The sixth lens element has an image-side surface being convex in a paraxial region thereof. The seventh lens element with positive refractive power has an object-side surface being convex in a paraxial region thereof and an image-side surface being concave in a paraxial region thereof. The eighth lens element with negative refractive power has an object-side surface being convex in a paraxial region thereof and an image-side surface being concave in a paraxial region thereof.

### RELATED APPLICATIONS

This application claims priority to Taiwan Application 114110995, filed on Mar. 24, 2025, which is incorporated by reference herein in its entirety.

### BACKGROUND

### Technical Field

The present disclosure relates to an optical photographing lens system, an image capturing unit and an electronic device, more particularly to an optical photographing lens system and an image capturing unit applicable to an electronic device.

### Description of Related Art

With the development of semiconductor manufacturing technology, the performance of image sensors has improved, and the pixel size thereof has been scaled down. Therefore, featuring high image quality becomes one of the indispensable features of an optical system nowadays.

Furthermore, due to the rapid changes in technology, electronic devices equipped with optical systems are trending towards multi-functionality for various applications, and therefore the functionality requirements for the optical systems have been increasing. However, it is difficult for a conventional optical system to obtain a balance among the requirements such as high image quality, low sensitivity, a proper aperture size, miniaturization and a desirable field of view.

### SUMMARY

According to one aspect of the present disclosure, an optical photographing lens system includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

Preferably, the fifth lens element has negative refractive power. Preferably, the image-side surface of the sixth lens element is convex in a paraxial region thereof. Preferably, the seventh lens element has positive refractive power. Preferably, the object-side surface of the seventh lens element is convex in a paraxial region thereof. Preferably, the image-side surface of the seventh lens element is concave in a paraxial region thereof. Preferably, the image-side surface of the seventh lens element has at least one inflection point. Preferably, the eighth lens element has negative refractive power. Preferably, the object-side surface of the eighth lens element is convex in a paraxial region thereof. Preferably, the image-side surface of the eighth lens element is concave in a paraxial region thereof. Preferably, the image-side surface of the eighth lens element has at least one inflection point.

When a curvature radius of the object-side surface of the first lens element is R1, a curvature radius of the image-side surface of the seventh lens element is R14, an Abbe number of the third lens element is V3, an Abbe number of the fifth lens element is V5, an axial distance between the sixth lens element and the seventh lens element is T67, and an axial distance between the seventh lens element and the eighth lens element is T78, the following conditions are preferably satisfied:

$$- 2.50 < R 14 / R 1 < 1.1 ;$$

$$0.2 < V 5 / V 3 < 0.7 ; and$$

$$0 < T 67 / T 78 < 0.60 .$$

According to another aspect of the present disclosure, an optical photographing lens system includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements has an object-side surface facing toward the object side and an image-side surface facing toward the image side.

Preferably, the third lens element has positive refractive power. Preferably, the image-side surface of the sixth lens element is convex in a paraxial region thereof. Preferably, the seventh lens element has positive refractive power. Preferably, the object-side surface of the seventh lens element is convex in a paraxial region thereof. Preferably, the image-side surface of the seventh lens element is concave in a paraxial region thereof. Preferably, the object-side surface of the seventh lens element has at least one inflection point. Preferably, the eighth lens element has negative refractive power. Preferably, the object-side surface of the eighth lens element is convex in a paraxial region thereof. Preferably, the image-side surface of the eighth lens element is concave in a paraxial region thereof.

When a curvature radius of the object-side surface of the first lens element is R1, a curvature radius of the image-side surface of the seventh lens element is R14, a central thickness of the fifth lens element is CT5, a central thickness of the sixth lens element is CT6, a central thickness of the seventh lens element is CT7, an axial distance between the fifth lens element and the sixth lens element is T56, and a maximum value among all axial distances between each of all adjacent lens elements of the optical photographing lens system is ATmax, the following conditions are preferably satisfied:

$$- 2.00 < R 14 / R 1 < 1. ;$$

$$0.1 < ( CT 5 + T 56 ) / CT 6 < 0.9 ; and$$

$$0.4 < ATmax / CT 7 < 2.2 .$$

According to another aspect of the present disclosure, an image capturing unit includes the aforementioned optical photographing lens system and an image sensor, wherein the image sensor is disposed on an image surface of the optical photographing lens system.

According to another aspect of the present disclosure, an electronic device includes an image capturing unit. The image capturing unit includes the aforementioned optical photographing lens system and an image sensor, wherein the image sensor is disposed on an image surface of the optical photographing lens system.

### BRIEF DESCRIPTION OF THE DRAWINGS

The disclosure can be better understood by reading the following detailed description of the embodiments, with reference made to the accompanying drawings as follows:

FIG. 1 is a schematic view of an image capturing unit according to the 1st embodiment of the present disclosure;

FIG. 2 shows spherical aberration curves, astigmatic field curves and a distortion curve of the image capturing unit according to the 1st embodiment;

FIG. 3 is a schematic view of an image capturing unit according to the 2nd embodiment of the present disclosure;

FIG. 4 shows spherical aberration curves, astigmatic field curves and a distortion curve of the image capturing unit according to the 2nd embodiment;

FIG. 5 is a schematic view of an image capturing unit according to the 3rd embodiment of the present disclosure;

FIG. 6 shows spherical aberration curves, astigmatic field curves and a distortion curve of the image capturing unit according to the 3rd embodiment;

FIG. 7 is a schematic view of an image capturing unit according to the 4th embodiment of the present disclosure;

FIG. 8 shows spherical aberration curves, astigmatic field curves and a distortion curve of the image capturing unit according to the 4th embodiment;

FIG. 9 is a schematic view of an image capturing unit according to the 5th embodiment of the present disclosure;

FIG. 10 shows spherical aberration curves, astigmatic field curves and a distortion curve of the image capturing unit according to the 5th embodiment;

FIG. 11 is a schematic view of an image capturing unit according to the 6th embodiment of the present disclosure;

FIG. 12 shows spherical aberration curves, astigmatic field curves and a distortion curve of the image capturing unit according to the 6th embodiment;

FIG. 13 is a schematic view of an image capturing unit according to the 7th embodiment of the present disclosure;

FIG. 14 shows spherical aberration curves, astigmatic field curves and a distortion curve of the image capturing unit according to the 7th embodiment;

FIG. 15 is a schematic view of an image capturing unit according to the 8th embodiment of the present disclosure;

FIG. 16 shows spherical aberration curves, astigmatic field curves and a distortion curve of the image capturing unit according to the 8th embodiment;

FIG. 17 is a schematic view of an image capturing unit according to the 9th embodiment of the present disclosure;

FIG. 18 shows spherical aberration curves, astigmatic field curves and a distortion curve of the image capturing unit according to the 9th embodiment;

FIG. 19 is a perspective view of an image capturing unit according to the 10th embodiment of the present disclosure;

FIG. 20 is one schematic view of an electronic device according to the 11th embodiment of the present disclosure;

FIG. 21 is another schematic view of the electronic device in FIG. 20;

FIG. 22 is one perspective view of an electronic device according to the 12th embodiment of the present disclosure;

FIG. 23 is another perspective view of the electronic device in FIG. 22;

FIG. 24 is a block diagram of the electronic device in FIG. 22;

FIG. 25 is a perspective view of an electronic device according to the 13th embodiment of the present disclosure;

FIG. 26 is a perspective view of an electronic device according to the 14th embodiment of the present disclosure;

FIG. 27 is a schematic view of an electronic device according to the 15th embodiment of the present disclosure;

FIG. 28 is a schematic view of an electronic device according to the 16th embodiment of the present disclosure;

FIG. 29 shows a schematic view of inflection points and critical points on lens surfaces according to the 1st embodiment of the present disclosure;

FIG. 30 shows a schematic view of ET6, ET7, ET8, ET67, ET78, SAG3R1, SAG3R2, SAG7R2, Y6R1 and Y7R2 according to the 1st embodiment of the present disclosure; and

FIG. 31 shows a schematic view of a configuration of one light-folding element in an optical photographing lens system according to one embodiment of the present disclosure.

### DETAILED DESCRIPTION

An optical photographing lens system includes eight lens elements. The eight lens elements are, in order from an object side to an image side along an optical path, a first lens element, a second lens element, a third lens element, a fourth lens element, a fifth lens element, a sixth lens element, a seventh lens element and an eighth lens element. Each of the eight lens elements of the optical photographing lens system has an object-side surface facing toward the object side and an image-side surface facing toward the image side.

The image-side surface of the second lens element can be concave in a paraxial region thereof. Therefore, it is favorable for controlling the shape of the image-side surface of the second lens element to balance spherical aberration and coma generated by the first lens element.

The third lens element can have positive refractive power. Therefore, it is favorable for converging light rays incident from large viewing angles at the object-side end so as to prevent excessive incident angles that may cause light divergence. The image-side surface of the third lens element can be convex in a paraxial region thereof. Therefore, it is favorable for enhancing the converging capability of the third lens element, thereby facilitating size and weight reductions.

The object-side surface of the fourth lens element can be convex in a paraxial region thereof. Therefore, it is favorable for converging light and working with the front and rear lens elements so as to balance the travelling direction of light.

The fifth lens element can have negative refractive power. Therefore, it is favorable for balancing the overall distribution of refractive power and correcting aberrations resulting from size reduction.

The sixth lens element can have positive refractive power. Therefore, it is favorable for enhancing the light-converging capability at the image-side end of the optical photographing lens system, thereby effectively controlling the light path. The image-side surface of the sixth lens element can be convex in a paraxial region thereof. Therefore, it is favorable for the optimization of light refraction in the optical photographing lens system according to the specifications required by the application device.

The seventh lens element can have positive refractive power. Therefore, it is favorable for reducing the length at the image-side end of the optical photographing lens system, thereby preventing the total track length from becoming excessively long. The object-side surface of the seventh lens element can be convex in a paraxial region thereof. Therefore, it is favorable for strengthening the positive refractive power of the seventh lens element and correcting astigmatism. The image-side surface of the seventh lens element can be concave in a paraxial region thereof. Therefore, it is favorable for adjusting the refraction direction of light at the seventh lens element so as to enlarge the image surface.

The eighth lens element can have negative refractive power. Therefore, it is favorable for balancing the refractive power at the image-side end of the optical photographing lens system to improve the light-converging quality on the image surface across various fields of view and reduce aberrations. The object-side surface of the eighth lens element can be convex in a paraxial region thereof. Therefore, it is favorable for converging light rays to prevent non-imaging light from reflecting within the lens. The image-side surface of the eighth lens element can be concave in a paraxial region thereof. Therefore, it is favorable for adjusting the surface shape and refractive power of the eighth lens element so as to correct field curvature and distortion and reduce the back focal length.

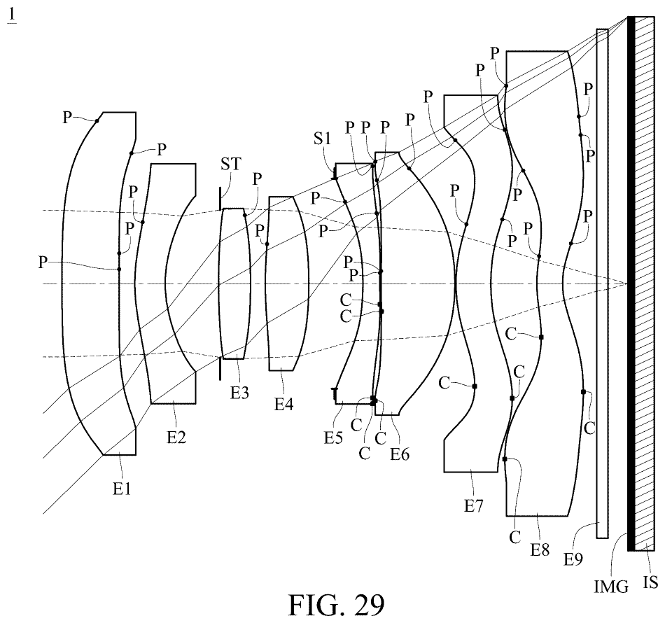

According to the present disclosure, the object-side surface of the seventh lens element can have at least one inflection point. Therefore, it is favorable for controlling the incident angle of light on the object-side surface of the seventh lens element so as to reduce surface reflections of peripheral field rays. The image-side surface of the seventh lens element can have at least one inflection point. Therefore, it is favorable for reducing size and correcting off-axis aberrations. The image-side surface of the eighth lens element has at least one inflection point. Therefore, it is favorable for enhancing the light-converging quality across various fields of view while maintaining lens miniaturization. Please refer to FIG. 29, which shows a schematic view of the inflection points P of the object-side surface of the seventh lens element E7, the image-side surface of the seventh lens element E7 and the image-side surface of the eighth lens element E8 according to the 1st embodiment of the present disclosure. FIG. 29 shows, in the 1st embodiment of the present disclosure, the inflection points P located on the object-side surface of the seventh lens element E7, the image-side surface of the seventh lens element E7 and the image-side surface of the eighth lens element E8, along with the inflection points P on the object-side surface and the image-side surface of the first lens element E1, the object-side surface of the second lens element E2, the image-side surface of the third lens element E3, the object-side surface of the fourth lens element E4, the object-side surface and the image-side surface of the fifth lens element E5, the object-side surface and the image-side surface of the sixth lens element E6, and the object-side surface of the eighth lens element E8, as an exemplary illustration. However, in various embodiments of the present disclosure, each of the lens surfaces of the lens elements can have one or more inflection points.

According to the present disclosure, the object-side surface of the seventh lens element can have at least one critical point in an off-axis region thereof. Therefore, it is favorable for further enhancing design flexibility and reducing the generation of stray light. The image-side surface of the eighth lens element can have at least one critical point in an off-axis region thereof. Therefore, it is favorable for the peripheral shape of the image-side surface of the eighth lens element to have a certain degree of variation, thereby improving peripheral illuminance and image quality on the image surface. Please refer to FIG. 29, which shows a schematic view of the critical points C in an off-axis region of the object-side surface of the seventh lens element E7 and the image-side surface of the eighth lens element E8 according to the 1st embodiment of the present disclosure. FIG. 29 shows, in the 1st embodiment of the present disclosure, the critical points C located in an off-axis region on the object-side surface of the seventh lens element E7 and the image-side surface of the eighth lens element E8, along with the critical points C in an off-axis region on the image-side surface of the fifth lens element E5, the object-side surface of the sixth lens element E6, the image-side surface of the seventh lens element E7, and the object-side surface of the eighth lens element E8, as an exemplary illustration. However, in various embodiments of the present disclosure, each of the lens surfaces of the lens elements can have one or more critical points in an off-axis region thereof.

According to the present disclosure, each of at least four lens elements in the optical photographing lens system can have a refractive index smaller than 1.75. In other words, among all lens elements in the optical photographing lens system, there can be at least four lens elements each having a refractive index smaller than 1.75. Therefore, it is favorable for aligning with the overall design, thereby allowing the selected materials to better meet the application requirements of the product. Moreover, among all lens elements in the optical photographing lens system, there can also be at least five lens elements each having a refractive index smaller than 1.75. Moreover, among all lens elements in the optical photographing lens system, there can also be at least six lens elements each having a refractive index smaller than 1.75.

According to the present disclosure, at least five lens elements in the optical photographing lens system can be made of plastic material. In other words, among all lens elements in the optical photographing lens system, there can be at least five lens elements made of plastic material. Therefore, it is favorable for effectively reducing the lens weight and lowering the manufacturing difficulty of aspherical lens elements.

When a curvature radius of the object-side surface of the first lens element is R1, and a curvature radius of the image-side surface of the seventh lens element is R14, the following condition can be satisfied: −2.50<R14/R1<1.10. Therefore, it is favorable for adjusting the light path, correcting spherical aberration and astigmatism, thereby enhancing the image resolution quality and optical performance of the lens. Moreover, the following condition can also be satisfied: −2.00<R14/R1<1.00. Moreover, the following condition can also be satisfied: −1.80<R14/R1<1.00. Moreover, the following condition can also be satisfied: −1.50<R14/R1<0.95. Moreover, the following condition can also be satisfied: −1.34≤R14/R1≤0.81.

When an Abbe number of the third lens element is V3, and an Abbe number of the fifth lens element is V5, the following condition can be satisfied: 0.20<V5/V3<0.70. Therefore, it is favorable for effectively correcting the focal positions of light in different wavelength bands so as to enhance sharpness and color contrast, thereby achieving image quality optimization. Moreover, the following condition can also be satisfied: 0.25<V5/V3<0.60. Moreover, the following condition can also be satisfied: 0.28<V5/V3<0.55. Moreover, the following condition can also be satisfied: 0.33≤V5/V3≤0.51.

When an axial distance between the sixth lens element and the seventh lens element is T67, and an axial distance between the seventh lens element and the eighth lens element is T78, the following condition can be satisfied: 0<T67/T78<0.60. Therefore, it is favorable for adjusting the spatial configuration of the seventh lens element in coordination with the overall design so as to reduce manufacturing tolerances and field curvature. Moreover, the following condition can also be satisfied: 0<T67/T78<0.50. Moreover, the following condition can also be satisfied: 0.01<T67/T78<0.40. Moreover, the following condition can also be satisfied: 0.02≤T67/T78≤0.34. Moreover, the following condition can also be satisfied: 0.01<T67/T78<0.20.

When a central thickness of the fifth lens element is CT5, a central thickness of the sixth lens element is CT6, and an axial distance between the fifth lens element and the sixth lens element is T56, the following condition can be satisfied: 0.10<(CT5+T56)/CT6<0.90. Therefore, it is favorable for adjusting the central thickness ratio and axial distance of the lens elements so as to improve manufacturing yield. Moreover, the following condition can also be satisfied: 0.10< (CT5+T56)/CT6<0.80. Moreover, the following condition can also be satisfied: 0.15< (CT5+T56)/CT6<0.70. Moreover, the following condition can also be satisfied: 0.20< (CT5+T56)/CT6<0.60. Moreover, the following condition can also be satisfied: 0.25≤(CT5+T56)/CT6≤0.51.

When a maximum value among all axial distances between each of all adjacent lens elements of the optical photographing lens system is ATmax, and a central thickness of the seventh lens element is CT7, the following condition can be satisfied: 0.40<ATmax/CT7<2.20. Therefore, it is favorable for improving space utilization and maintaining assembly stability, thereby enhancing productivity. Moreover, the following condition can also be satisfied: 0.50<ATmax/CT7<1.90. Moreover, the following condition can also be satisfied: 0.60<ATmax/CT7<1.80. Moreover, the following condition can also be satisfied: 0.87≤ATmax/CT7≤1.70.

When an axial distance between the object-side surface of the first lens element and an image surface is TL, and a focal length of the optical photographing lens system is f, the following condition can be satisfied: 1.40<TL/f<2.70. Therefore, it is favorable for the optical photographing lens system to achieve a balance between total track length and field of view. Moreover, the following condition can also be satisfied: 1.45≤TL/f≤2.36.

When the focal length of the optical photographing lens system is f, and a composite focal length of the first lens element and the second lens element is f12, the following condition can be satisfied: −0.50<f/f12<0.50. Therefore, it is favorable for balancing the focal lengths of the first lens element and the second lens element to regulate the light incidence at the object-side end of the optical photographing lens system. Moreover, the following condition can also be satisfied: −0.40<f/f12<0.40.

When an Abbe number of the second lens element is V2, and the Abbe number of the third lens element is V3, the following condition can be satisfied: 0.20<V2/V3<1.00. Therefore, it is favorable for adjusting the distribution of lens materials to correct chromatic aberration, thereby enhancing color saturation and image clarity. Moreover, the following condition can also be satisfied: 0.30<V2/V3<0.90. Moreover, the following condition can also be satisfied: 0.35<V2/V3<0.85.

When an axial distance between the first lens element and the second lens element is T12, and an axial distance between the second lens element and the third lens element is T23, the following condition can be satisfied: 0<T12/T23<2.00. Therefore, it is favorable for the second lens element to cooperate with the front and rear lens elements, facilitating the coupling design between the lens portion outside the optically effective radius and the mechanical structure. Moreover, the following condition can also be satisfied: 0.05<T12/T23<1.80.

When a curvature radius of the object-side surface of the fifth lens element is R9, and a curvature radius of the object-side surface of the eighth lens element is R15, the following condition can be satisfied: 0<|R15/R9|<0.80. Therefore, it is favorable for the object-side surface of the eighth lens element to have a more curved shape at central region so as to correct distortion and reduce the total track length. Moreover, the following condition can also be satisfied: 0.02<|R15/R9|<0.70.

When a focal length of the first lens element is f1, and a focal length of the sixth lens element is f6, the following condition can be satisfied: −0.80<f6/f1<4.00. Therefore, it is favorable for adjusting the distribution of refractive power among the lens elements so as to correct aberrations. Moreover, the following condition can also be satisfied: −0.70<f6/f1<3.50. Moreover, the following condition can also be satisfied: −0.65<f6/f1<3.00.

When a maximum image height of the optical photographing lens system (which can be half of a diagonal length of an effective photosensitive area of an image sensor) is ImgH, and an entrance pupil diameter of the optical photographing lens system is EPD, the following condition can be satisfied: 1.45<ImgH/EPD<2.40. Therefore, it is favorable for achieving a balance between aperture configuration and image surface size in the optical photographing lens system, thereby enhancing image quality in dynamic and low-light shooting scenarios. Moreover, the following condition can also be satisfied: 1.55<ImgH/EPD<2.30. Moreover, the following condition can also be satisfied: 1.62≤ImgH/EPD≤2.05.

When a curvature radius of the image-side surface of the second lens element is R4, and a curvature radius of the image-side surface of the third lens element is R6, the following condition can be satisfied: −1.30<R4/R6<0.10. Therefore, it is favorable for correcting spherical aberration and coma so as to improve image quality. Moreover, the following condition can also be satisfied: −1.10<R4/R6<0. Moreover, the following condition can also be satisfied: −0.95<R4/R6<−0.05.

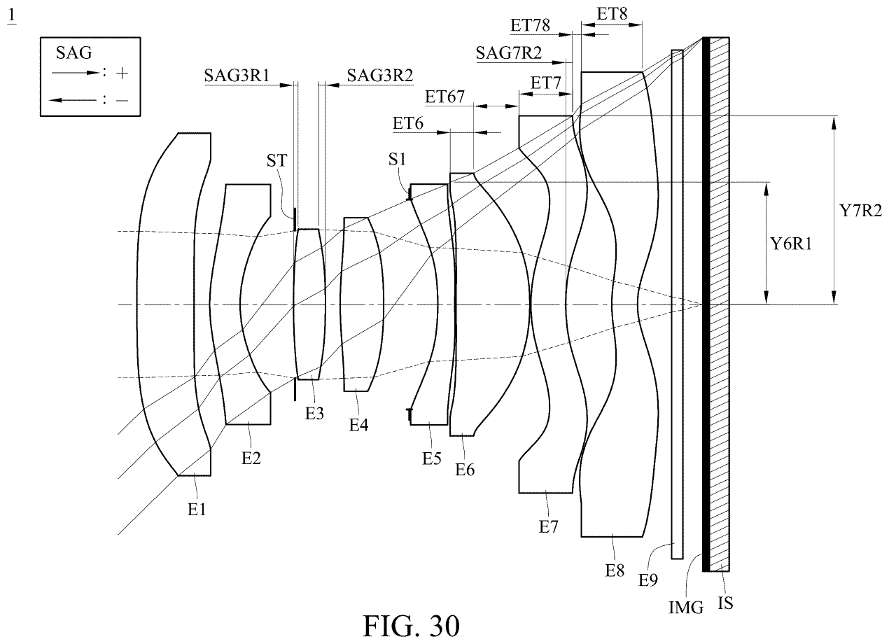

When a distance in parallel with an optical axis between a maximum effective radius position of the image-side surface of the sixth lens element and a maximum effective radius position of the object-side surface of the seventh lens element is ET67, and a distance in parallel with the optical axis between a maximum effective radius position of the image-side surface of the seventh lens element and a maximum effective radius position of the object-side surface of the eighth lens element is ET78, the following condition can be satisfied: 0.05<ET78/ET67<0.65. Therefore, it is favorable for harmonizing the peripheral light paths at the image-side end of the optical photographing lens system so as to improve peripheral image quality. Moreover, the following condition can also be satisfied: 0.10<ET78/ET67<0.55. Please refer to FIG. 30, which shows a schematic view of ET67 and ET78 according to the 1st embodiment of the present disclosure.

When a displacement in parallel with the optical axis from an axial vertex of the object-side surface of the third lens element to a maximum effective radius position of the object-side surface of the third lens element is SAG3R1, and a displacement in parallel with the optical axis from an axial vertex of the image-side surface of the third lens element to a maximum effective radius position of the image-side surface of the third lens element is SAG3R2, the following condition can be satisfied: −1.00<SAG3R1/SAG3R2<0.35. Therefore, it is favorable for adjusting the peripheral surface design of the third lens element to facilitate light guidance and aberration correction. Moreover, the following condition can also be satisfied: −0.80<SAG3R1/SAG3R2<0. Please refer to FIG. 30, which shows a schematic view of SAG3R1 and SAG3R2 according to the 1st embodiment of the present disclosure. When the direction from the axial vertex of one surface to the maximum effective radius position of the same surface is facing towards the image side of the optical photographing lens system, the value of displacement is positive; when the direction from the axial vertex of the surface to the maximum effective radius position of the same surface is facing towards the object side of the optical photographing lens system, the value of displacement is negative.

When a displacement in parallel with the optical axis from an axial vertex of the image-side surface of the seventh lens element to the maximum effective radius position of the image-side surface of the seventh lens element is SAG7R2, and the central thickness of the seventh lens element is CT7, the following condition can be satisfied: −0.30<SAG7R2/CT7<1.20. Therefore, it is favorable for effectively preventing excessive extension of the peripheral shape on the image-side surface of the seventh lens element so as to maintain molding stability and manufacturing quality of the lens element. Moreover, the following condition can also be satisfied: −0.10<SAG7R2/CT7<1.00. Moreover, the following condition can also be satisfied: 0<SAG7R2/CT7<0.90. Please refer to FIG. 30, which shows a schematic view of SAG7R2 according to the 1st embodiment of the present disclosure. When the direction from the axial vertex of one surface to the maximum effective radius position of the same surface is facing towards the image side of the optical photographing lens system, the value of displacement is positive; when the direction from the axial vertex of the surface to the maximum effective radius position of the same surface is facing towards the object side of the optical photographing lens system, the value of displacement is negative.

When a focal length of the fifth lens element is f5, and the focal length of the sixth lens element is f6, the following condition can be satisfied: −5.00<f5/f6<0. Therefore, it is favorable for the refractive power of the fifth lens element and the refractive power of the sixth lens element to work in coordination so as to enhance the image quality of moments captured during dynamic photography. Moreover, the following condition can also be satisfied: −4.00<f5/f6<−0.10. Moreover, the following condition can also be satisfied: −3.60<f5/f6<−0.20.

When the focal length of the first lens element is f1, and the focal length of the fifth lens element is f5, the following condition can be satisfied: −4.00<f5/f1<0.50. Therefore, it is favorable for optimizing the convergence or divergence of light so as to enhance the light-converging quality across the entire field of view. Moreover, the following condition can also be satisfied: −3.50<f5/f1<0.40. Moreover, the following condition can also be satisfied: −3.00<f5/f1<0.30.

When a curvature radius of the image-side surface of the eighth lens element is R16, and an axial distance between the image-side surface of the eighth lens element and the image surface is BL, the following condition can be satisfied: 0.60<R16/BL<2.00. Therefore, it is favorable for effectively controlling the back focal length to prevent the total track length from becoming excessively long. Moreover, the following condition can also be satisfied: 0.70<R16/BL<1.60. Moreover, the following condition can also be satisfied: 0.80<R16/BL<1.50.

When a distance in parallel with the optical axis between a maximum effective radius position of the object-side surface of the sixth lens element and the maximum effective radius position of the image-side surface of the sixth lens element is ET6, and the central thickness of the sixth lens element is CT6, the following condition can be satisfied: 0.15<ET6/CT6<0.80. Therefore, it is favorable for preventing deformation or warping during manufacturing by controlling the thickness ratio across the radius of the sixth lens element, while maintaining the manufacturability of the lens element. Moreover, the following condition can also be satisfied: 0.20<ET6/CT6<0.60. Please refer to FIG. 30, which shows a schematic view of ET6 according to the 1st embodiment of the present disclosure.

When a distance in parallel with the optical axis between the maximum effective radius position of the object-side surface of the seventh lens element and the maximum effective radius position of the image-side surface of the seventh lens element is ET7, and a distance in parallel with the optical axis between the maximum effective radius position of the object-side surface of the eighth lens element and a maximum effective radius position of the image-side surface of the eighth lens element is ET8, the following condition can be satisfied: 0.75<ET7/ET8<2.50. Therefore, it is favorable for balancing the travelling direction of light to reduce the generation of stray light and correct off-axis aberrations. Moreover, the following condition can also be satisfied: 0.80<ET7/ET8<2.40. Please refer to FIG. 30, which shows a schematic view of ET7 and ET8 according to the 1st embodiment of the present disclosure.

When a maximum effective radius of the object-side surface of the sixth lens element is Y6R1, and a maximum effective radius of the image-side surface of the seventh lens element is Y7R2, the following condition can be satisfied: 0.50<Y6R1/Y7R2<0.75. Therefore, it is favorable for reducing the refraction angle of light by adjusting the proportional relationship between the optically effective radii of the sixth lens element and the seventh lens element to prevent total internal reflection. Please refer to FIG. 30, which shows a schematic view of Y6R1 and Y7R2 according to the 1st embodiment of the present disclosure.

According to the present disclosure, the aforementioned features and conditions can be utilized in numerous combinations so as to achieve corresponding effects.

According to the present disclosure, the lens elements of the optical photographing lens system can be made of either glass or plastic material. When the lens elements are made of glass material, the refractive power distribution of the optical photographing lens system may be more flexible, and the influence on imaging caused by external environment temperature change may be reduced. The glass lens element can either be made by grinding or molding. When the lens elements are made of plastic material, the manufacturing costs can be effectively reduced. Furthermore, surfaces of each lens element can be arranged to be spherical or aspheric. Spherical lens elements are simple in manufacture. Aspheric lens element design allows more control variables for eliminating aberrations thereof and reducing the required number of lens elements, and the total track length of the optical photographing lens system can therefore be effectively shortened. Additionally, the aspheric surfaces may be formed by plastic injection molding or glass molding.

According to the present disclosure, when a lens surface is aspheric, it means that the lens surface has an aspheric shape throughout its optically effective area, or a portion(s) thereof.

According to the present disclosure, one or more of the lens elements' material may optionally include an additive which generates light absorption and interference effects and alters the lens elements' transmittance in a specific range of wavelength for a reduction in unwanted stray light or color deviation. For example, the additive may optionally filter out light in the wavelength range of 600 nm to 800 nm to reduce excessive red light and/or near infrared light; or may optionally filter out light in the wavelength range of 350 nm to 450 nm to reduce excessive blue light and/or near ultraviolet light from interfering the final image. The additive may be homogeneously mixed with a plastic material to be used in manufacturing a mixed-material lens element by injection molding. Moreover, the additive may be coated on the lens surfaces to provide the abovementioned effects.

According to the present disclosure, each of an object-side surface and an image-side surface has a paraxial region and an off-axis region. The paraxial region refers to the region of the surface where light rays travel close to the optical axis, and the off-axis region refers to the region of the surface away from the paraxial region. Particularly, unless otherwise stated, when the lens element has a convex surface, it indicates that the surface is convex in the paraxial region thereof; when the lens element has a concave surface, it indicates that the surface is concave in the paraxial region thereof. Moreover, when a region of refractive power, curvature radius or focus of a lens element is not defined, it indicates that the region of refractive power, curvature radius or focus of the lens element is in the paraxial region thereof.

According to the present disclosure, an inflection point is a point on the surface of the lens element at which the surface changes from concave to convex, or vice versa. A critical point is a non-axial point of the lens surface where its tangent is perpendicular to the optical axis.

According to the present disclosure, the image surface of the optical photographing lens system, based on the corresponding image sensor, can be flat or curved, especially a curved surface being concave facing towards the object side of the optical photographing lens system.

According to the present disclosure, an image correction unit, such as a field flattener, can be optionally disposed between the lens element closest to the image side of the optical photographing lens system along the optical path and the image surface for correction of aberrations such as field curvature. The optical properties of the image correction unit, such as curvature, thickness, index of refraction, position and surface shape (convex or concave surface with spherical, aspheric, diffractive or Fresnel types), can be adjusted according to the design of the image capturing unit. In general, a preferable image correction unit is, for example, a thin transparent element having a concave object-side surface and a planar image-side surface, and the thin transparent element is disposed near the image surface.

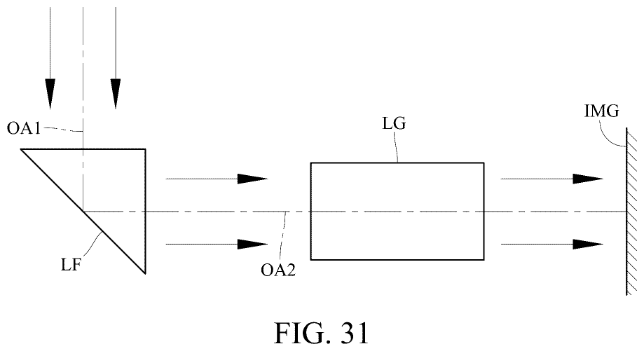

According to the present disclosure, at least one light-folding element, such as a prism or a mirror, can be optionally provided between an imaged object and the image surface on the imaging optical path, and the surface shape of the prism or mirror can be planar, spherical, aspheric or freeform, such that the optical photographing lens system can be more flexible in space arrangement, so that the miniaturization of an electronic device is not restricted by the total track length of the optical photographing lens system. Specifically, please refer to FIG. 31, which shows a schematic view of a configuration of one light-folding element in an optical photographing lens system according to one embodiment of the present disclosure. In FIG. 31, the optical photographing lens system can have, in order from an imaged object (not shown in the figures) to an image surface IMG along an optical path, a first optical axis OA1, a light-folding element LF and a second optical axis OA2. The light-folding element LF can be disposed between the imaged object and a lens group LG of the optical photographing lens system as shown in FIG. 31. The optical photographing lens system can be optionally provided with two or more light-folding elements, and the present disclosure is not limited to the types, numbers or positions of the light-folding elements of the embodiments disclosed in the aforementioned figures.

According to the present disclosure, the optical photographing lens system can include at least one stop, such as an aperture stop, a glare stop or a field stop. Said glare stop or said field stop can be disposed between an imaged object and the first lens element, between adjacent lens elements, or between the last lens element and the image surface, and is set for eliminating the stray light and thereby improving image quality thereof.

According to the present disclosure, an aperture stop can be configured as a front stop or a middle stop. A front stop disposed between an imaged object and the first lens element can provide a longer distance between an exit pupil of the optical photographing lens system and the image surface to produce a telecentric effect, and thereby improves the image-sensing efficiency of an image sensor (for example, CCD or CMOS). A middle stop disposed between the first lens element and the image surface is favorable for enlarging the viewing angle of the optical photographing lens system and thereby provides a wider field of view for the same.

According to the present disclosure, the optical photographing lens system can include an aperture control unit. The aperture control unit may be a mechanical component or a light modulator, which can control the size and shape of the aperture through electricity or electrical signals. The mechanical component can include a movable member, such as a blade assembly or a light shielding sheet. The light modulator can include a shielding element, such as a filter, an electrochromic material or a liquid-crystal layer. The aperture control unit controls the amount of incident light or exposure time to enhance the capability of image quality adjustment. In addition, the aperture control unit can be the aperture stop of the present disclosure, which changes the f-number to obtain different image effects, such as the depth of field or lens speed.

According to the present disclosure, the optical photographing lens system can include one or more optical elements for limiting the form of light passing through the optical photographing lens system. Each optical element can be, but not limited to, a filter, a polarizer, etc., and each optical element can be, but not limited to, a single-piece element, a composite component, a thin film, etc. The optical element can be located at the object side or the image side of the optical photographing lens system or between any two adjacent lens elements so as to allow light in a specific form to pass through, thereby meeting application requirements.

According to the present disclosure, the optical photographing lens system can include at least one optical lens element, an optical element, or a carrier, which has at least one surface with a low reflection layer. The low reflection layer can effectively reduce stray light generated due to light reflection at the interface. The low reflection layer can be disposed in an optical non-effective area of an object-side surface or an image-side surface of the said optical lens element, or a connection surface between the object-side surface and the image-side surface. The said optical element can be a light-blocking element, an annular spacer, a barrel element, a cover glass, a blue glass, a filter, a color filter, an optical path folding element (e.g., a reflective element), a prism, a mirror, etc. The said carrier can be a base for supporting a lens assembly, a micro lens disposed on an image sensor, a substrate surrounding the image sensor, a glass plate for protecting the image sensor, etc.

According to the present disclosure, the optical photographing lens system can further include a light-blocking element. The light-blocking element can have a non-circular opening, and the non-circular opening can have different effective radii in different directions which are perpendicular to the optical axis. Therefore, it is favorable for the light-blocking element to coordinate with the shape of non-circular lens elements or aperture stop so as to reduce the size of the optical photographing lens system and make full use of the light passing through said non-circular lens elements or aperture stop, thereby reducing stray light. Moreover, the light-blocking element can be provided with a wavy structure or a jagged structure at a periphery of an inner hole portion thereof.

According to the present disclosure, the object side and image side are defined in accordance with the direction of the optical axis, and the axial optical data are calculated along the optical axis. Furthermore, if the optical axis is deflected by a reflective element, the axial optical data are also calculated along the deflected optical axis.

According to the above description of the present disclosure, the following specific embodiments are provided for further explanation.

### 1st Embodiment

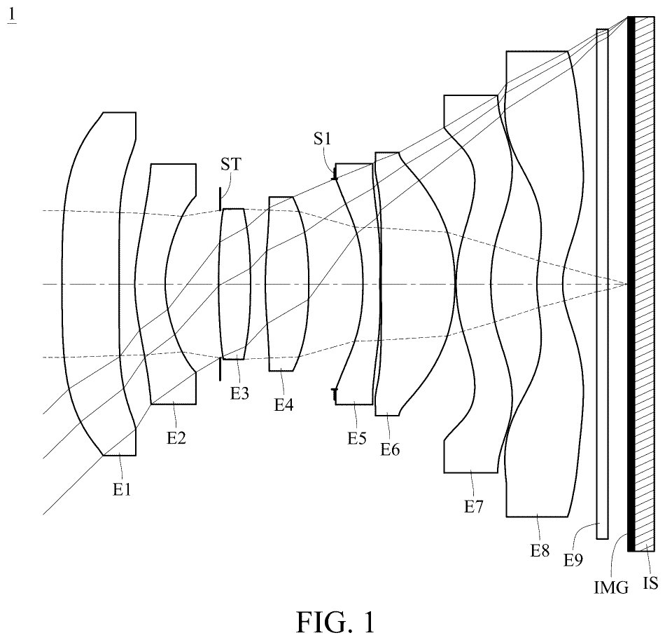

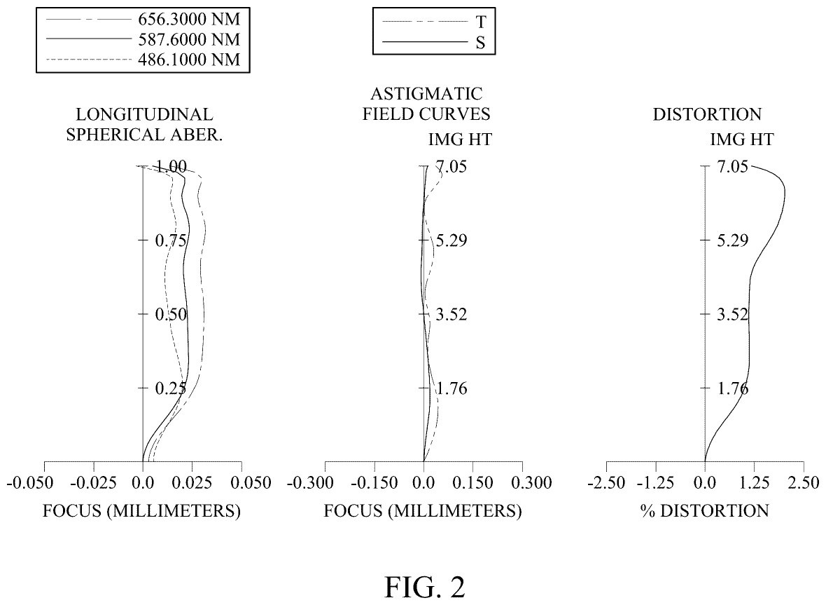

FIG. 1 is a schematic view of an image capturing unit according to the 1st embodiment of the present disclosure. FIG. 2 shows, in order from left to right, spherical aberration curves, astigmatic field curves and a distortion curve of the image capturing unit according to the 1st embodiment. In FIG. 1, the image capturing unit 1 includes the optical photographing lens system (its reference numeral is omitted) of the present disclosure and an image sensor IS. The optical photographing lens system includes, in order from an object side to an image side along an optical path, a first lens element E1, a second lens element E2, an aperture stop ST, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has three inflection points.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The image-side surface of the fifth lens element E5 has three critical points in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has two critical points in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has three inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The equation of the aspheric surface profiles of the aforementioned lens elements of the 1st embodiment is expressed as follows:

$$X ( Y ) = ( {Y}^{2} / R ) / ( 1 + s q r t ( 1 - ( 1 + k ) \times {( Y / R )}^{2} ) ) + {\sum }_{i} ( Ai ) \times ( {Y}^{i} ) ,$$

where,
X is the displacement in parallel with an optical axis from an axial vertex on the aspheric surface to a point at a distance of Y from the optical axis on the aspheric surface;
Y is the vertical distance from the point on the aspheric surface to the optical axis;
R is the curvature radius;
k is the conic coefficient; and
Ai is the i-th aspheric coefficient, and in the embodiments, i may be, but is not limited to, 4, 6, 8, 10, 12, 14, 16, 18, 20, 22, 24, 26 and 28.

In the optical photographing lens system of the image capturing unit 1 according to the 1st embodiment, when a focal length of the optical photographing lens system is f, an f-number of the optical photographing lens system is Fno, and half of a maximum field of view of the optical photographing lens system is HFOV, these parameters have the following values: f=7.08 millimeters (mm), Fno=1.83, and HFOV=44.5 degrees (deg.).

When the maximum field of view of the optical photographing lens system is FOV, the following condition is satisfied: FOV=89.0 degrees.

When an axial distance between the object-side surface of the first lens element E1 and the image surface IMG is TL, and the focal length of the optical photographing lens system is f, the following condition is satisfied: TL/f=2.11.

When a maximum image height of the optical photographing lens system is ImgH, and an entrance pupil diameter of the optical photographing lens system is EPD, the following condition is satisfied: ImgH/EPD=1.82.

When the focal length of the optical photographing lens system is f, and a composite focal length of the first lens element E1 and the second lens element E2 is f12, the following condition is satisfied: f/f12=−0.26.

When a focal length of the first lens element E1 is f1, and a focal length of the fifth lens element E5 is f5, the following condition is satisfied: f5/f1=−0.03.

When the focal length of the first lens element E1 is f1, and a focal length of the sixth lens element E6 is f6, the following condition is satisfied: f6/f1=0.03.

When the focal length of the fifth lens element E5 is f5, and the focal length of the sixth lens element E6 is f6, the following condition is satisfied: f5/f6=−1.05.

When a curvature radius of the object-side surface of the first lens element E1 is R1, and a curvature radius of the image-side surface of the seventh lens element E7 is R14, the following condition is satisfied: R14/R1=0.07.

When a curvature radius of the image-side surface of the second lens element E2 is R4, and a curvature radius of the image-side surface of the third lens element E3 is R6, the following condition is satisfied: R4/R6=−0.17.

When a curvature radius of the object-side surface of the fifth lens element E5 is R9, and a curvature radius of the object-side surface of the eighth lens element E8 is R15, the following condition is satisfied: |R15/R9|=0.48.

When a curvature radius of the image-side surface of the eighth lens element E8 is R16, and an axial distance between the image-side surface of the eighth lens element E8 and the image surface IMG is BL, the following condition is satisfied:

$$R 16 / BL = 1.14 .$$

When an axial distance between the first lens element E1 and the second lens element E2 is T12, and an axial distance between the second lens element E2 and the third lens element E3 is T23, the following condition is satisfied: T12/T23=0.29. In this embodiment, an axial distance between two adjacent lens elements is a distance in a paraxial region between two adjacent lens surfaces of the two adjacent lens elements.

When a central thickness of the fifth lens element E5 is CT5, a central thickness of the sixth lens element E6 is CT6, and an axial distance between the fifth lens element E5 and the sixth lens element E6 is T56, the following condition is satisfied: (CT5+T56)/CT6=0.25.

When a maximum value among all axial distances between each of all adjacent lens elements of the optical photographing lens system is ATmax, and a central thickness of the seventh lens element E7 is CT7, the following condition is satisfied: ATmax/CT7=1.55. In this embodiment, among the first lens element E1 to the eighth lens element E8, an axial distance between the fourth lens element E4 and the fifth lens element E5 is larger than axial distances between any other pair of adjacent lens elements, and ATmax is equal to the axial distance between the fourth lens element E4 and the fifth lens element E5.

When an axial distance between the sixth lens element E6 and the seventh lens element E7 is T67, and an axial distance between the seventh lens element E7 and the eighth lens element E8 is T78, the following condition is satisfied: T67/T78=0.02.

When an Abbe number of the second lens element E2 is V2, and an Abbe number of the third lens element E3 is V3, the following condition is satisfied: V2/V3=0.67.

When the Abbe number of the third lens element E3 is V3, and an Abbe number of the fifth lens element E5 is V5, the following condition is satisfied: V5/V3=0.36.

When a distance in parallel with the optical axis between a maximum effective radius position of the object-side surface of the sixth lens element E6 and a maximum effective radius position of the image-side surface of the sixth lens element E6 is ET6, and the central thickness of the sixth lens element E6 is CT6, the following condition is satisfied: ET6/CT6=0.32.

When a distance in parallel with the optical axis between the maximum effective radius position of the image-side surface of the sixth lens element E6 and a maximum effective radius position of the object-side surface of the seventh lens element E7 is ET67, and a distance in parallel with the optical axis between a maximum effective radius position of the image-side surface of the seventh lens element E7 and a maximum effective radius position of the object-side surface of the eighth lens element E8 is ET78, the following condition is satisfied: ET78/ET67=0.20.

When a distance in parallel with the optical axis between the maximum effective radius position of the object-side surface of the seventh lens element E7 and the maximum effective radius position of the image-side surface of the seventh lens element E7 is ET7, and a distance in parallel with the optical axis between the maximum effective radius position of the object-side surface of the eighth lens element E8 and a maximum effective radius position of the image-side surface of the eighth lens element E8 is ET8, the following condition is satisfied: ET7/ET8=0.88.

When a maximum effective radius of the object-side surface of the sixth lens element E6 is Y6R1, and a maximum effective radius of the image-side surface of the seventh lens element E7 is Y7R2, the following condition is satisfied: Y6R1/Y7R2=0.65.

When a displacement in parallel with the optical axis from an axial vertex of the object-side surface of the third lens element E3 to a maximum effective radius position of the object-side surface of the third lens element E3 is SAG3R1, and a displacement in parallel with the optical axis from an axial vertex of the image-side surface of the third lens element E3 to a maximum effective radius position of the image-side surface of the third lens element E3 is SAG3R2, the following condition is satisfied: SAG3R1/SAG3R2=−0.67. In this embodiment, the direction of SAG3R1 faces the image side, and thus the value of SAG3R1 is positive; the direction of SAG3R2 faces the object side, and thus the value of SAG3R2 is negative.

When a displacement in parallel with the optical axis from an axial vertex of the image-side surface of the seventh lens element E7 to the maximum effective radius position of the image-side surface of the seventh lens element E7 is SAG7R2, and the central thickness of the seventh lens element E7 is CT7, the following condition is satisfied: SAG7R2/CT7=0.20. In this embodiment, the direction of SAG7R2 faces the image side, and thus the value of SAG7R2 is positive.

The detailed optical data of the 1st embodiment are shown in Table 1A and the aspheric surface data are shown in Table 1B below.

TABLE 1A
1st Embodiment
f = 7.08 mm, Fno = 1.83, HFOV = 44.5 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 82.3886 | (ASP) | 1.510 | Glass | 1.589 | 61.2 | 236.69 |
| 2 | | 200.0000 | (ASP) | 0.413 | | | | |
| 3 | Lens 2 | 4.4440 | (ASP) | 0.802 | Plastic | 1.566 | 37.4 | −24.01 |
| 4 | | 3.1305 | (ASP) | 1.448 | | | | |
| 5 | Ape. Stop | Plano | | −0.039 | | | | |
| 6 | Lens 3 | 16.8542 | (ASP) | 0.843 | Plastic | 1.544 | 56.0 | 16.43 |
| 7 | | −18.6872 | (ASP) | 0.390 | | | | |
| 8 | Lens 4 | 8.9696 | (ASP) | 1.149 | Plastic | 1.544 | 56.0 | 9.46 |
| 9 | | −11.5299 | (ASP) | 0.678 | | | | |
| 10 | Stop | Plano | | 0.750 | | | | |
| 11 | Lens 5 | −7.6348 | (ASP) | 0.450 | Plastic | 1.660 | 20.4 | −7.55 |
| 12 | | 14.7001 | (ASP) | 0.030 | | | | |
| 13 | Lens 6 | 12.4459 | (ASP) | 1.950 | Plastic | 1.544 | 56.0 | 7.17 |
| 14 | | −5.3644 | (ASP) | 0.030 | | | | |
| 15 | Lens 7 | 4.1619 | (ASP) | 0.919 | Plastic | 1.566 | 37.4 | 25.73 |
| 16 | | 5.3617 | (ASP) | 1.216 | | | | |
| 17 | Lens 8 | 3.7011 | (ASP) | 0.677 | Plastic | 1.551 | 44.8 | −8.79 |
| 18 | | 1.9609 | (ASP) | 0.900 | | | | |

| | | | | | | | |
|---|---|---|---|---|---|---|---|
| 19 | Filter | Plano | 0.300 | Glass | 1.517 | 64.2 | — |
| 20 | | Plano | 0.526 | | | | |
| 21 | Image | Plano | — | | | | |

Note:
Reference wavelength is 587.6 nm (d-line).
An effective radius of the stop S1 (Surface 10) is 2.772 mm.

TABLE 1B
Aspheric Coefficients

| Surface # | 1 | 2 | 3 | 4 |
|---|---|---|---|---|
| k= | 0.00000E+00 | 0.00000E+00 | −8.99423E−01 | −9.65619E−01 |
| A4= | 2.81555704E−03 | −3.66008408E−03 | −2.08778293E−02 | −1.33336142E−02 |
| A6= | −1.77252485E−04 | 2.47515656E−03 | 4.56649078E−03 | 9.34645400E−04 |
| A8= | 4.10035206E−05 | −5.95215508E−04 | −9.52066506E−04 | 2.41974852E−03 |
| A10= | −6.65676930E−06 | 9.59274749E−05 | 1.76132973E−04 | −1.92342496E−03 |
| A12= | 6.83051635E−07 | −1.00801573E−05 | −2.64185196E−05 | 8.63517027E−04 |
| A14= | −4.13060557E−08 | 6.54389963E−07 | 2.71029646E−06 | −2.39233012E−04 |
| A16= | 1.35354246E−09 | −2.37387520E−08 | −1.64169466E−07 | 3.99703389E−05 |
| A18= | −1.86093207E−11 | 3.64650991E−10 | 4.90805891E−09 | −3.66812282E−06 |
| A20= | — | — | −4.58614790E−11 | 1.42214291E−07 |
| Surface # | 6 | 7 | 8 | 9 |
| k= | 3.11903E+01 | 5.57632E+01 | 0.00000E+00 | 0.00000E+00 |
| A4= | −3.94234729E−03 | −1.16605676E−02 | −1.28788678E−02 | −8.88587303E−03 |
| A6= | 2.78967341E−03 | 3.42350010E−03 | 1.99618682E−03 | 7.50041473E−04 |
| A8= | −3.29431091E−03 | −4.88192961E−04 | −1.67442288E−04 | −4.90159065E−04 |
| A10= | 3.08594436E−03 | −1.49731219E−04 | −4.68950162E−05 | 2.62853510E−04 |
| A12= | −1.78751525E−03 | 1.83034545E−04 | 2.35515908E−05 | −7.66392426E−05 |
| A14= | 6.38456803E−04 | −7.81734238E−05 | −4.94773089E−06 | 1.28187889E−05 |
| A16= | −1.36234422E−04 | 1.82023041E−05 | 5.33245729E−07 | −1.17606936E−06 |
| A18= | 1.59139977E−05 | −2.23754195E−06 | −2.14694949E−08 | 4.71701852E−08 |
| A20= | −7.80703640E−07 | 1.15269101E−07 | — | — |
| Surface # | 11 | 12 | 13 | 14 |
| k= | 0.00000E+00 | −4.89200E+00 | 9.75561E+00 | 0.00000E+00 |
| A4= | −2.34623747E−02 | −8.28597059E−02 | −8.03668575E−02 | −9.97674561E−03 |
| A6= | 9.43234381E−03 | 7.09347637E−02 | 7.85271831E−02 | 2.64852764E−03 |
| A8= | −4.78187310E−03 | −4.08503420E−02 | −4.68981196E−02 | −1.15802438E−03 |
| A10= | 2.07793987E−03 | 1.55554245E−02 | 1.81042764E−02 | 5.88597172E−04 |
| A12= | −5.70339297E−04 | −3.99535050E−03 | −4.75593074E−03 | −2.21690538E−04 |
| A14= | 9.64148900E−05 | 7.08601955E−04 | 8.71338230E−04 | 5.66755379E−05 |
| A16= | −9.82644191E−06 | −8.75468726E−05 | −1.11644761E−04 | −9.85819430E−06 |
| A18= | 5.55008997E−07 | 7.44036032E−06 | 9.80537607E−06 | 1.17147964E−06 |
| A20= | −1.33523003E−08 | −4.16355551E−07 | −5.61402949E−07 | −9.38060338E−08 |
| A22= | — | 1.38455978E−08 | 1.88353074E−08 | 4.83934940E−09 |
| A24= | — | −2.07552066E−10 | −2.80463193E−10 | −1.44827614E−10 |
| A26= | — | — | — | 1.90183600E−12 |
| Surface # | 15 | 16 | 17 | 18 |
| k= | −7.57871E−01 | 0.00000E+00 | −1.00000E+00 | −1.00000E+00 |
| A4= | 4.61449456E−04 | 1.36053317E−02 | −5.04558483E−02 | −6.40369658E−02 |
| A6= | −2.37694489E−03 | −4.81001326E−03 | 6.19376924E−03 | 1.30389368E−02 |
| A8= | 3.52021119E−04 | 4.05605748E−04 | 6.52835210E−05 | −2.18260632E−03 |
| A10= | −9.01470427E−05 | 5.98255927E−06 | −2.12263832E−04 | 2.76140418E−04 |
| A12= | 2.35742893E−05 | −3.73684715E−06 | 4.51759081E−05 | −2.56379464E−05 |
| A14= | −3.72017261E−06 | 2.90527680E−07 | −5.20717341E−06 | 1.73861833E−06 |
| A16= | 3.60693147E−07 | −8.96849064E−09 | 3.84981865E−07 | −8.60011594E−08 |
| A18= | −2.27730129E−08 | −1.70261341E−11 | −1.93046995E−08 | 3.08628793E−09 |
| A20= | 9.40208299E−10 | 9.08263957E−12 | 6.67067945E−10 | −7.92647091E−11 |
| A22= | −2.32442683E−11 | −2.40553289E−13 | −1.57016330E−11 | 1.41737982E−12 |
| A24= | 2.58861595E−13 | 2.12044419E−15 | 2.41037792E−13 | −1.67408201E−14 |
| A26= | — | — | −2.17935363E−15 | 1.17302317E−16 |
| A28= | — | — | 8.81304990E−18 | −3.69017136E−19 |

In Table 1A, the curvature radius, the thickness and the focal length are shown in millimeters (mm). Surface numbers 0-21 represent the surfaces sequentially arranged from the object side to the image side along the optical axis. In Table 1B, k represents the conic coefficient of the equation of the aspheric surface profiles. A4-A28 represent the aspheric coefficients ranging from the 4th order to the 28th order. The tables presented below for each embodiment are the corresponding schematic parameter and aberration curves, and the definitions of the tables are the same as Table 1A and Table 1B of the 1st embodiment. Therefore, an explanation in this regard will not be provided again.

### 2nd Embodiment

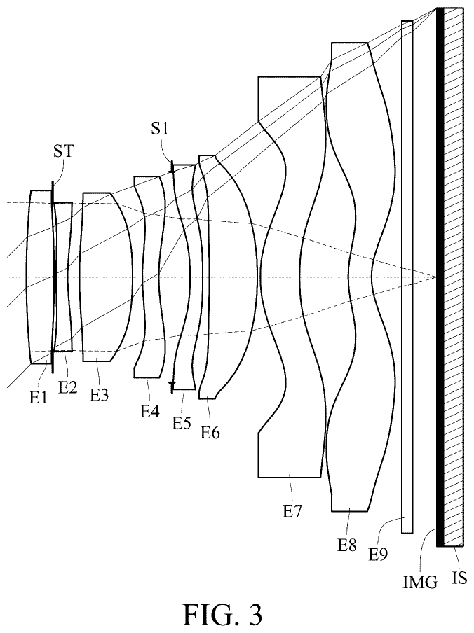

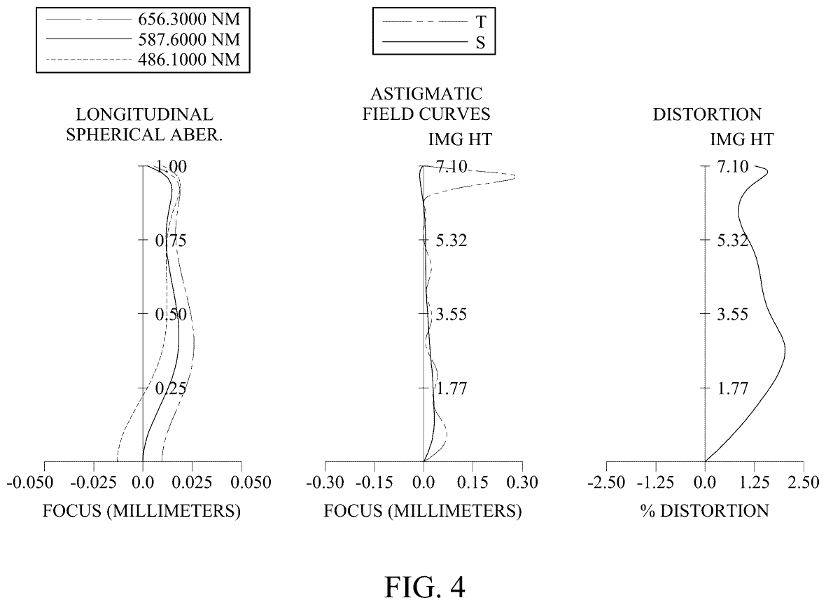

FIG. 3 is a schematic view of an image capturing unit according to the 2nd embodiment of the present disclosure. FIG. 4 shows, in order from left to right, spherical aberration curves, astigmatic field curves and a distortion curve of the image capturing unit according to the 2nd embodiment. In FIG. 3, the image capturing unit 2 includes the optical photographing lens system (its reference numeral is omitted) of the present disclosure and an image sensor IS. The optical photographing lens system includes, in order from an object side to an image side along an optical path, a first lens element E1, an aperture stop ST, a second lens element E2, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with positive refractive power has an object-side surface being convex in a paraxial region thereof and an image-side surface being convex in a paraxial region thereof. The first lens element E1 is made of glass material and has the object-side surface and the image-side surface being both aspheric. The image-side surface of the first lens element E1 has one inflection point.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The image-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has four inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 2nd embodiment are shown in Table 2A and the aspheric surface data are shown in Table 2B below.

TABLE 2A
2nd Embodiment
f = 6.89 mm, Fno = 1.75, HFOV = 45.5 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 18.7491 | (ASP) | 0.734 | Glass | 1.855 | 36.6 | 14.04 |
| 2 | | −32.8110 | (ASP) | −0.036 | | | | |
| 3 | Ape. Stop | Plano | | 0.086 | | | | |
| 4 | Lens 2 | 12.4643 | (ASP) | 0.308 | Plastic | 1.614 | 26.0 | −18.31 |
| 5 | | 5.8540 | (ASP) | 0.309 | | | | |
| 6 | Lens 3 | 11.7101 | (ASP) | 1.400 | Plastic | 1.544 | 56.0 | 10.10 |
| 7 | | −9.9164 | (ASP) | 0.259 | | | | |
| 8 | Lens 4 | 5.5617 | (ASP) | 0.434 | Plastic | 1.614 | 26.0 | −197.34 |
| 9 | | 5.1597 | (ASP) | 0.345 | | | | |
| 10 | Stop | Plano | | 0.480 | | | | |
| 11 | Lens 5 | −6.7188 | (ASP) | 0.330 | Plastic | 1.661 | 20.3 | −12.13 |
| 12 | | −42.3847 | (ASP) | 0.174 | | | | |
| 13 | Lens 6 | −57.5768 | (ASP) | 1.267 | Plastic | 1.544 | 56.0 | 15.36 |
| 14 | | −7.3549 | (ASP) | 0.079 | | | | |
| 15 | Lens 7 | 3.2904 | (ASP) | 1.033 | Plastic | 1.544 | 56.0 | 12.21 |
| 16 | | 5.8002 | (ASP) | 1.285 | | | | |
| 17 | Lens 8 | 2.7705 | (ASP) | 0.612 | Plastic | 1.544 | 56.0 | −11.69 |
| 18 | | 1.7796 | (ASP) | 0.800 | | | | |

| | | | | | | | |
|---|---|---|---|---|---|---|---|
| 19 | Filter | Plano | 0.280 | Glass | 1.517 | 64.2 | — |
| 20 | | Plano | 0.643 | | | | |
| 21 | Image | Plano | — | | | | |

Note:
Reference wavelength is 587.6 nm (d-line).
An effective radius of the stop S1 (Surface 10) is 2.781 mm.

TABLE 2B
Aspheric Coefficients

| Surface # | 1 | 2 | 4 | 5 |
|---|---|---|---|---|
| k= | 0.00000E+00 | 0.00000E+00 | 0.00000E+00 | 0.00000E+00 |
| A4= | −1.13082519E−03 | −5.56652596E−03 | −2.82827481E−02 | −2.27829085E−02 |
| A6= | −4.95015793E−04 | 2.65835317E−03 | 5.17766799E−03 | −4.96925851E−04 |
| A8= | 3.14896878E−04 | −2.97366920E−04 | 1.46896962E−03 | 3.26587066E−03 |
| A10= | −7.88459615E−05 | −1.30369519E−04 | −1.58382341E−03 | −2.01488302E−03 |
| A12= | 1.03330613E−05 | 4.51474408E−05 | 4.98670517E−04 | 6.48928177E−04 |
| A14= | −4.66253225E−07 | −3.76140597E−06 | −6.94109129E−05 | −1.10018104E−04 |
| A16= | — | — | 3.69505632E−06 | 9.74381079E−06 |
| A18= | — | — | −2.61367730E−08 | −3.89986773E−07 |
| Surface # | 6 | 7 | 8 | 9 |
| k= | 0.00000E+00 | 0.00000E+00 | 0.00000E+00 | 0.00000E+00 |
| A4= | −9.77511916E−04 | −2.44167774E−02 | −3.17008388E−02 | −1.25882410E−02 |
| A6= | −2.40459101E−03 | 6.73180163E−03 | 1.88647616E−03 | −3.45503606E−03 |
| A8= | 4.39899981E−04 | −2.82152542E−03 | −3.85863563E−04 | 2.16099058E−03 |
| A10= | −3.61691046E−06 | 9.27863172E−04 | 9.94074386E−05 | −9.12772784E−04 |
| A12= | −6.13028476E−05 | −2.13231194E−04 | −1.32841346E−05 | 3.03195467E−04 |
| A14= | 3.13979019E−05 | 2.97193622E−05 | 1.42010939E−06 | −7.47733401E−05 |
| A16= | −6.32679401E−06 | −1.68585195E−06 | −6.91740875E−08 | 1.23346292E−05 |
| A18= | 5.88980726E−07 | −8.79069970E−08 | — | −1.25386913E−06 |
| A20= | −2.14077075E−08 | 1.28364559E−08 | — | 7.09072972E−08 |
| A22= | — | — | — | −1.71268982E−09 |
| Surface # | 11 | 12 | 13 | 14 |
| k= | 0.00000E+00 | 0.00000E+00 | 0.00000E+00 | 0.00000E+00 |
| A4= | −4.65428690E−02 | −7.44073375E−02 | −2.70266568E−02 | −1.58053865E−03 |
| A6= | 3.54535221E−02 | 6.18653733E−02 | 3.58723103E−02 | −6.76342874E−03 |
| A8= | −1.83450501E−02 | −3.44399148E−02 | −2.10660226E−02 | 7.88558860E−03 |
| A10= | 6.86101955E−03 | 1.28297149E−02 | 7.26937482E−03 | −5.04606272E−03 |
| A12= | −1.67936846E−03 | −3.24044362E−03 | −1.62218928E−03 | 2.10406659E−03 |
| A14= | 2.61677792E−04 | 5.69284816E−04 | 2.38457713E−04 | −6.07830932E−04 |
| A16= | −2.51168864E−05 | −6.99211771E−05 | −2.26033321E−05 | 1.23663104E−04 |
| A18= | 1.35776220E−06 | 5.90269840E−06 | 1.29421032E−06 | −1.76272271E−05 |
| A20= | −3.17319285E−08 | −3.27667662E−07 | −3.89025905E−08 | 1.71937094E−06 |
| A22= | — | 1.08375243E−08 | 4.59567067E−10 | −1.09122748E−07 |
| A24= | — | −1.63149651E−10 | −2.83576604E−12 | 4.05349118E−09 |
| A26= | — | — | — | −6.67480670E−11 |
| Surface # | 15 | 16 | 17 | 18 |
| k= | −1.00000E+00 | 0.00000E+00 | −1.00000E+00 | −1.00000E+00 |
| A4= | −2.25982491E−03 | 1.12908641E−02 | −5.62536442E−02 | −6.48067667E−02 |
| A6= | −2.64725646E−03 | −3.11147034E−03 | 8.44144218E−03 | 1.17943932E−02 |
| A8= | 1.05886618E−03 | 2.04023360E−04 | −1.28690033E−03 | −1.75683301E−03 |
| A10= | −3.46253563E−04 | 6.20167109E−06 | 1.69085902E−04 | 1.92865991E−04 |
| A12= | 7.41086114E−05 | −1.99277777E−06 | −1.52664494E−05 | −1.50432156E−05 |
| A14= | −1.04840949E−05 | 1.57983540E−07 | 9.10940800E−07 | 8.32621823E−07 |
| A16= | 1.00007517E−06 | −6.91819572E−09 | −3.60997043E−08 | −3.27771643E−08 |
| A18= | −6.40195658E−08 | 1.80560743E−10 | 9.43737488E−10 | 9.10742537E−10 |
| A20= | 2.64078467E−09 | −2.63680266E−12 | −1.56818575E−11 | −1.74269891E−11 |
| A22= | −6.33141065E−11 | 1.66092802E−14 | 1.50390629E−13 | 2.18011281E−13 |
| A24= | 6.68005299E−13 | — | −6.34751547E−16 | −1.60093748E−15 |
| A26= | — | — | — | 5.21895522E−18 |

In the 2nd embodiment, the equation of the aspheric surface profiles of the aforementioned lens elements is the same as the equation of the 1st embodiment. Also, the definitions of these parameters shown in Table 2C below are the same as those stated in the 1st embodiment, with corresponding values for the 2nd embodiment; therefore, an explanation in this regard will not be provided again.

Moreover, these parameters can be calculated from Table 2A and Table 2B as the following values and satisfy the following conditions:

TABLE 2C
Values of Optical and Physical Parameters/Definitions

| | | | |
|---|---|---|---|
| f [mm] | 6.89 | R16/BL | 1.03 |
| Fno | 1.75 | T12/T23 | 0.16 |
| HFOV [deg.] | 45.5 | (CT5 + T56)/CT6 | 0.40 |
| FOV [deg.] | 91.0 | ATmax/CT7 | 1.24 |
| TL/f | 1.57 | T67/T78 | 0.06 |
| ImgH/EPD | 1.80 | V2/V3 | 0.46 |
| f/f12 | 0.13 | V5/V3 | 0.36 |
| f5/f1 | −0.86 | ET6/CT6 | 0.33 |
| f6/f1 | 1.09 | ET78/ET67 | 0.26 |
| f5/f6 | −0.79 | ET7/ET8 | 1.74 |
| R14/R1 | 0.31 | Y6R1/Y7R2 | 0.57 |
| R4/R6 | −0.59 | SAG3R1/SAG3R2 | −0.21 |
| \|R15/R9\| | 0.41 | SAG7R2/CT7 | 0.54 |

### 3rd Embodiment

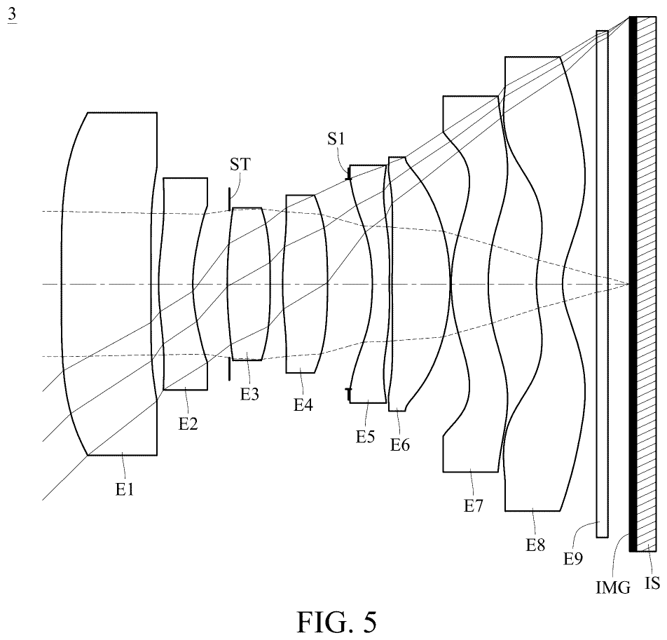

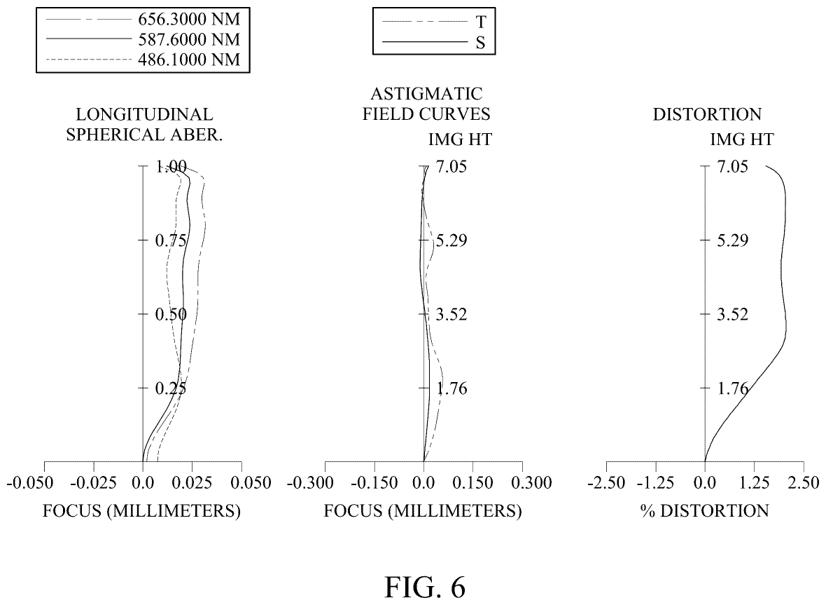

FIG. 5 is a schematic view of an image capturing unit according to the 3rd embodiment of the present disclosure. FIG. 6 shows, in order from left to right, spherical aberration curves, astigmatic field curves and a distortion curve of the image capturing unit according to the 3rd embodiment. In FIG. 5, the image capturing unit 3 includes the optical photographing lens system (its reference numeral is omitted) of the present disclosure and an image sensor IS. The optical photographing lens system includes, in order from an object side to an image side along an optical path, a first lens element E1, a second lens element E2, an aperture stop ST, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with negative refractive power has an object-side surface being concave in a paraxial region thereof and an image-side surface being concave in a paraxial region thereof. The first lens element E1 is made of glass material and has the object-side surface and the image-side surface being both aspheric. The object-side surface of the first lens element E1 has one inflection point. The image-side surface of the first lens element E1 has three inflection points. The object-side surface of the first lens element E1 has one critical point in an off-axis region thereof. The image-side surface of the first lens element E1 has two critical points in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The object-side surface of the fourth lens element E4 has one inflection point. The object-side surface of the fourth lens element E4 has one critical point in an off-axis region thereof.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has three inflection points. The image-side surface of the fifth lens element E5 has two critical points in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has five inflection points. The image-side surface of the sixth lens element E6 has one inflection point. The object-side surface of the sixth lens element E6 has four critical points in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has one inflection point. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 3rd embodiment are shown in Table 3A and the aspheric surface data are shown in Table 3B below.

TABLE 3A
3rd Embodiment
f = 7.01 mm, Fno = 1.83, HFOV = 44.7 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −930.3206 | (ASP) | 2.363 | Glass | 1.589 | 61.2 | −234.35 |
| 2 | | 162.2781 | (ASP) | 0.201 | | | | |
| 3 | Lens 2 | 5.8127 | (ASP) | 0.902 | Plastic | 1.566 | 37.4 | −30.21 |
| 4 | | 4.0948 | (ASP) | 0.965 | | | | |
| 5 | Ape. Stop | Plano | | −0.057 | | | | |
| 6 | Lens 3 | 11.8898 | (ASP) | 1.135 | Plastic | 1.544 | 56.0 | 13.94 |
| 7 | | −20.2404 | (ASP) | 0.325 | | | | |
| 8 | Lens 4 | 7.7340 | (ASP) | 1.186 | Plastic | 1.544 | 56.0 | 10.38 |
| 9 | | −19.7963 | (ASP) | 0.551 | | | | |
| 10 | Stop | Plano | | 0.630 | | | | |
| 11 | Lens 5 | −6.8707 | (ASP) | 0.450 | Plastic | 1.660 | 20.4 | −7.48 |
| 12 | | 17.9538 | (ASP) | 0.072 | | | | |
| 13 | Lens 6 | 11.6286 | (ASP) | 1.530 | Plastic | 1.544 | 56.0 | 7.30 |
| 14 | | −5.7529 | (ASP) | 0.030 | | | | |
| 15 | Lens 7 | 4.3076 | (ASP) | 0.976 | Plastic | 1.566 | 37.4 | 29.32 |
| 16 | | 5.3412 | (ASP) | 1.270 | | | | |
| 17 | Lens 8 | 3.2465 | (ASP) | 0.690 | Plastic | 1.551 | 44.8 | −10.13 |
| 18 | | 1.8971 | (ASP) | 0.900 | | | | |

| | | | | | | | |
|---|---|---|---|---|---|---|---|
| 19 | Filter | Plano | 0.300 | Glass | 1.517 | 64.2 | — |
| 20 | | Plano | 0.573 | | | | |
| 21 | Image | Plano | — | | | | |

Note:
Reference wavelength is 587.6 nm (d-line).
An effective radius of the stop S1 (Surface 10) is 2.769 mm.

TABLE 3B
Aspheric Coefficients

| Surface # | 1 | 2 | 3 | 4 |
|---|---|---|---|---|
| k = | 0.00000E+00 | 0.00000E+00 | −1.42524E+00 | −1.76090E+00 |
| A4 = | 2.45691980E−03 | −6.55957575E−03 | −2.49682555E−02 | −1.45507373E−02 |
| A6 = | −1.17127145E−04 | 4.68596741E−03 | 7.40815449E−03 | 1.12986131E−03 |
| A8 = | 1.48443558E−05 | −1.42867775E−03 | −2.34262630E−03 | 2.01616747E−03 |
| A10 = | −1.73089117E−06 | 2.80836650E−04 | 5.81365417E−04 | −1.88043950E−03 |
| A12 = | 1.40066137E−07 | −3.56341694E−05 | −1.02252225E−04 | 9.56153305E−04 |
| A14 = | −6.92829553E−09 | 2.77942617E−06 | 1.21671531E−05 | −2.95434404E−04 |
| A16 = | 1.88190830E−10 | −1.20914846E−07 | −9.19902240E−07 | 5.54109539E−05 |
| A18 = | −2.17875214E−12 | 2.24292065E−09 | 3.95931991E−08 | −5.80029574E−06 |
| A20 = | — | — | −7.36012090E−10 | 2.62403890E−07 |
| Surface # | 6 | 7 | 8 | 9 |
| k = | 1.65093E+01 | 6.55828E+01 | 0.00000E+00 | 0.00000E+00 |
| A4 = | −2.83057337E−03 | −1.09552556E−02 | −1.23779803E−02 | −7.22315156E−03 |
| A6 = | 9.66125198E−04 | 2.25878057E−03 | 1.08782144E−03 | −4.23673674E−05 |
| A8 = | −2.37756191E−03 | −1.07068802E−03 | −4.07156105E−04 | −2.86551626E−04 |
| A10 = | 2.58071322E−03 | 4.73529686E−04 | 1.21268222E−04 | 1.60208881E−04 |
| A12 = | −1.62135283E−03 | −1.39886766E−04 | −2.48428166E−05 | −3.69699777E−05 |
| A14 = | 6.11512797E−04 | 2.44672127E−05 | 3.80110764E−06 | 4.91708509E−06 |
| A16 = | −1.36237238E−04 | −1.70090885E−06 | −3.06090104E−07 | −3.66301111E−07 |
| A18 = | 1.65741051E−05 | −8.09810910E−08 | 9.44645126E−09 | 1.21078923E−08 |
| A20 = | −8.47150008E−07 | 1.55634137E−08 | — | — |
| Surface # | 11 | 12 | 13 | 14 |
| k = | 0.00000E+00 | 1.77373E+01 | 9.35633E+00 | 0.00000E+00 |
| A4 = | −2.48862775E−02 | −7.63941854E−02 | −6.57970748E−02 | −4.42404629E−03 |
| A6 = | 1.07296136E−02 | 5.39882412E−02 | 5.29412301E−02 | 1.25692233E−03 |
| A8 = | −4.57208240E−03 | −2.70220581E−02 | −2.63802285E−02 | 2.20377771E−04 |
| A10 = | 1.72964984E−03 | 9.47659647E−03 | 8.64054537E−03 | −3.97547727E−04 |
| A12 = | −4.12838829E−04 | −2.32671123E−03 | −1.94704219E−03 | 1.96308970E−04 |
| A14 = | 6.02189047E−05 | 4.07149224E−04 | 3.06087433E−04 | −5.97120772E−05 |
| A16 = | −5.30351776E−06 | −5.10219952E−05 | −3.33855183E−05 | 1.23985310E−05 |
| A18 = | 2.60984045E−07 | 4.49698462E−06 | 2.46264076E−06 | −1.78354593E−06 |
| A20 = | −5.54747610E−09 | −2.65308346E−07 | −1.16487448E−07 | 1.74432156E−07 |
| A22 = | — | 9.40862730E−09 | 3.17982208E−09 | −1.10426988E−08 |
| A24 = | — | −1.51556031E−10 | −3.83110941E−11 | 4.07400879E−10 |
| A26 = | — | — | — | −6.63781536E−12 |
| Surface # | 15 | 16 | 17 | 18 |
| k = | −6.92579E−01 | 0.00000E+00 | −1.00000E+00 | −1.00000E+00 |
| A4 = | −1.88989451E−03 | 4.03988141E−03 | −5.12964343E−02 | −6.28659317E−02 |
| A6 = | −8.50630517E−04 | −1.66006235E−03 | 5.89357342E−03 | 1.21083252E−02 |
| A8 = | −1.78130239E−04 | −9.95679644E−05 | 3.81525340E−05 | −1.85962606E−03 |
| A10 = | 6.68109269E−05 | 5.59614845E−05 | −1.91269903E−04 | 2.09629560E−04 |
| A12 = | −1.13390107E−05 | −7.48232238E−06 | 4.00143453E−05 | −1.72600069E−05 |
| A14 = | 1.51470395E−06 | 5.51009374E−07 | −4.39290616E−06 | 1.05383571E−06 |
| A16 = | −1.61518809E−07 | −2.49247219E−08 | 3.00845401E−07 | −4.81698732E−08 |
| A18 = | 1.17158165E−08 | 6.90816953E−10 | −1.35473651E−08 | 1.64466790E−09 |
| A20 = | −5.14588470E−10 | −1.07995906E−11 | 4.03451915E−10 | −4.13061914E−11 |
| A22 = | 1.22643131E−11 | 7.29792090E−14 | −7.68219032E−12 | 7.39427053E−13 |
| A24 = | −1.21964430E−13 | 2.27125227E−18 | 8.49758524E−14 | −8.90891339E−15 |
| A26 = | — | — | −4.16300990E−16 | 6.46007673E−17 |
| A28 = | — | — | — | −2.12536677E−19 |

In the 3rd embodiment, the equation of the aspheric surface profiles of the aforementioned lens elements is the same as the equation of the 1st embodiment. Also, the definitions of these parameters shown in Table 3C below are the same as those stated in the 1st embodiment, with corresponding values for the 3rd embodiment; therefore, an explanation in this regard will not be provided again.

Moreover, these parameters can be calculated from Table 3A and Table 3B as the following values and satisfy the following conditions:

TABLE 3C
Values of Optical and Physical Parameters/Definitions

| | | | |
|---|---|---|---|
| f[mm] | 7.01 | R16/BL | 1.07 |
| Fno | 1.83 | T12/T23 | 0.22 |
| HFOV [deg.] | 44.7 | (CT5 + T56)/CT6 | 0.34 |
| FOV [deg.] | 89.4 | ATmax/CT7 | 1.30 |
| TL/f | 2.14 | T67/T78 | 0.02 |
| ImgH/EPD | 1.84 | V2/V3 | 0.67 |
| f/f12 | −0.26 | V5/V3 | 0.36 |
| f5/f1 | 0.03 | ET6/CT6 | 0.28 |
| f6/f1 | −0.03 | ET78/ET67 | 0.19 |
| f5/f6 | −1.02 | ET7/ET8 | 1.01 |
| R14/R1 | −0.01 | Y6R1/Y7R2 | 0.64 |
| R4/R6 | −0.20 | SAG3R1/SAG3R2 | −0.53 |
| \|R15/R9\| | 0.47 | SAG7R2/CT7 | 0.27 |

### 4th Embodiment

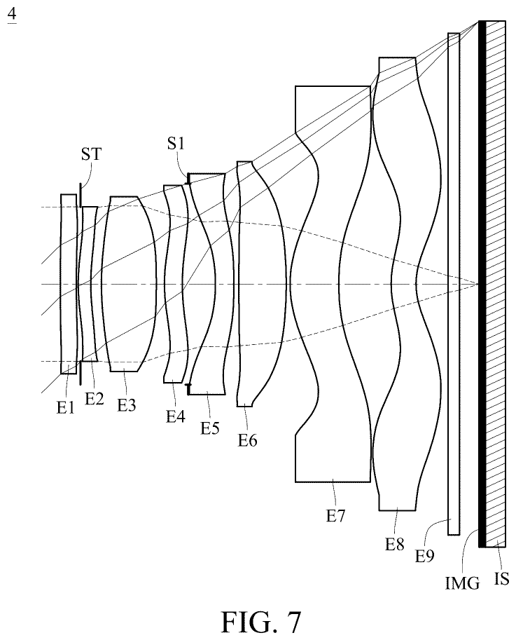

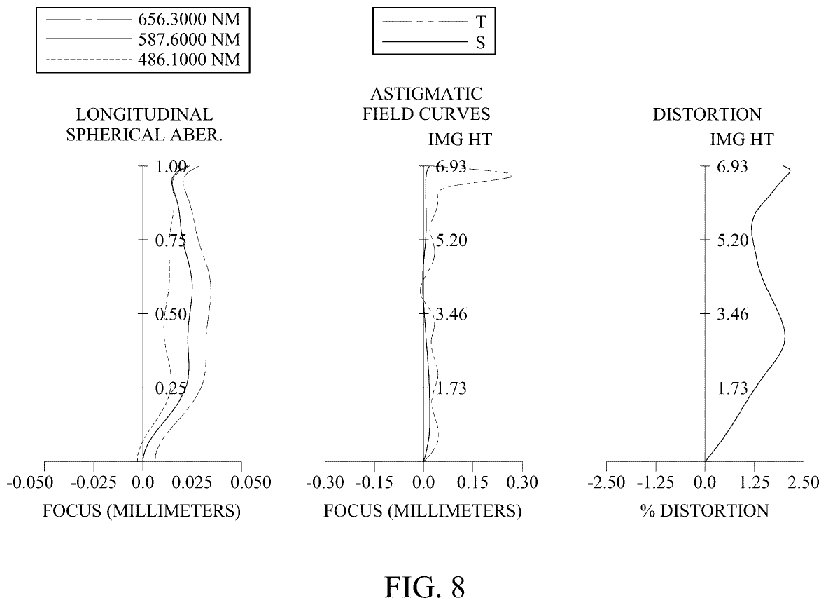

FIG. 7 is a schematic view of an image capturing unit according to the 4th embodiment of the present disclosure. FIG. 8 shows, in order from left to right, spherical aberration curves, astigmatic field curves and a distortion curve of the image capturing unit according to the 4th embodiment. In FIG. 7, the image capturing unit 4 includes the optical photographing lens system (its reference numeral is omitted) of the present disclosure and an image sensor IS. The optical photographing lens system includes, in order from an object side to an image side along an optical path, a first lens element E1, an aperture stop ST, a second lens element E2, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with negative refractive power has an object-side surface being concave in a paraxial region thereof and an image-side surface being concave in a paraxial region thereof. The first lens element E1 is made of plastic material and has the object-side surface and the image-side surface being both aspheric. The object-side surface of the first lens element E1 has three inflection points. The image-side surface of the first lens element E1 has two inflection points. The object-side surface of the first lens element E1 has two critical points in an off-axis region thereof. The image-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points. The image-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has one inflection point. The object-side surface of the sixth lens element E6 has two critical points in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has two critical points in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has three inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 4th embodiment are shown in Table 4A and the aspheric surface data are shown in Table 4B below.

TABLE 4A
4th Embodiment
f = 6.84 mm, Fno = 1.68, HFOV = 44.7 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −113.7409 | (ASP) | 0.420 | Plastic | 1.535 | 55.9 | −73.09 |
| 2 | | 59.5854 | (ASP) | 0.110 | | | | |
| 3 | Ape. Stop | Plano | | −0.062 | | | | |
| 4 | Lens 2 | 5.0308 | (ASP) | 0.332 | Plastic | 1.566 | 37.4 | 95.45 |
| 5 | | 5.4150 | (ASP) | 0.281 | | | | |
| 6 | Lens 3 | 7.8597 | (ASP) | 1.449 | Plastic | 1.544 | 56.0 | 11.51 |
| 7 | | −28.7473 | (ASP) | 0.215 | | | | |
| 8 | Lens 4 | 4.0812 | (ASP) | 0.473 | Plastic | 1.544 | 56.0 | 24.28 |
| 9 | | 5.6643 | (ASP) | 0.151 | | | | |
| 10 | Stop | Plano | | 0.720 | | | | |
| 11 | Lens 5 | −4.8413 | (ASP) | 0.486 | Plastic | 1.680 | 18.2 | −8.22 |
| 12 | | −37.5419 | (ASP) | 0.135 | | | | |
| 13 | Lens 6 | 52.9544 | (ASP) | 1.250 | Plastic | 1.551 | 44.8 | 16.23 |
| 14 | | −10.6610 | (ASP) | 0.103 | | | | |
| 15 | Lens 7 | 3.0640 | (ASP) | 1.283 | Plastic | 1.551 | 44.8 | 10.10 |
| 16 | | 5.8087 | (ASP) | 1.383 | | | | |
| 17 | Lens 8 | 2.5224 | (ASP) | 0.656 | Plastic | 1.566 | 37.4 | −13.76 |
| 18 | | 1.7264 | (ASP) | 0.850 | | | | |

| | | | | | | | |
|---|---|---|---|---|---|---|---|
| 19 | Filter | Plano | 0.300 | Glass | 1.517 | 64.2 | — |
| 20 | | Plano | 0.513 | | | | |
| 21 | Image | Plano | — | | | | |

Note:
Reference wavelength is 587.6 nm (d-line).
An effective radius of the stop S1 (Surface 10) is 2.653 mm.

TABLE 4B
Aspheric Coefficients

| Surface # | 1 | 2 | 4 | 5 |
|---|---|---|---|---|
| k = | 0.00000E+00 | 0.00000E+00 | 0.00000E+00 | 0.00000E+00 |
| A4 = | 1.22309138E−02 | 1.34211449E−02 | −2.44493213E−02 | −3.11285627E−02 |
| A6 = | −5.95831608E−03 | −1.12004035E−02 | 2.20731655E−03 | 8.89947093E−03 |
| A8 = | 1.86219225E−03 | 4.44604172E−03 | −2.84414474E−03 | −5.36025558E−03 |
| A10 = | −3.99866454E−04 | −1.16348326E−03 | 2.11807314E−03 | 2.83889977E−03 |
| A12 = | 4.60122282E−05 | 1.66376596E−04 | −7.52963454E−04 | −8.27724214E−04 |
| A14 = | −2.01444787E−06 | −9.26795159E−06 | 1.48515722E−04 | 1.37641361E−04 |
| A16 = | — | — | −1.51454021E−05 | −1.20468923E−05 |
| A18 = | — | — | 5.94912023E−07 | 4.00453947E−07 |
| Surface # | 6 | 7 | 8 | 9 |
| k = | 0.00000E+00 | 0.00000E+00 | 0.00000E+00 | 0.00000E+00 |
| A4 = | −7.47516197E−03 | −3.04693250E−02 | −3.35270313E−02 | −8.37774775E−03 |
| A6 = | 2.12548580E−03 | 8.41743463E−03 | 5.06141766E−03 | −3.88145359E−03 |
| A8 = | −1.83770080E−03 | −2.38998280E−03 | −1.99239686E−03 | 8.93991491E−04 |
| A10 = | 1.18114729E−03 | 3.63666306E−04 | 6.19017442E−04 | 1.01245735E−04 |
| A12 = | −4.16537867E−04 | 4.17600888E−05 | −1.19219516E−04 | −1.79485187E−04 |
| A14 = | 8.82236696E−05 | −3.59456140E−05 | 1.21293950E−05 | 8.05315834E−05 |
| A16 = | −1.16222719E−05 | 8.23198977E−06 | −4.66629544E−07 | −2.01885069E−05 |
| A18 = | 9.12144039E−07 | −9.05061501E−07 | — | 2.93248345E−06 |
| A20 = | −3.28637927E−08 | 4.09711045E−08 | — | −2.28725775E−07 |
| A22 = | — | — | — | 7.41196101E−09 |
| Surface # | 11 | 12 | 13 | 14 |
| k = | 0.00000E+00 | 0.00000E+00 | 0.00000E+00 | 0.00000E+00 |
| A4 = | −4.07218725E−02 | −6.78912617E−02 | −2.45271225E−02 | 5.06584540E−03 |
| A6 = | 2.29668883E−02 | 5.03048784E−02 | 3.21548590E−02 | −7.84555012E−03 |
| A8 = | −9.01922956E−03 | −2.63586333E−02 | −1.96356054E−02 | 3.96916812E−03 |
| A10 = | 2.85334017E−03 | 9.74509033E−03 | 7.20567690E−03 | −1.34439946E−03 |
| A12 = | −5.87726891E−04 | −2.48238861E−03 | −1.72420255E−03 | 3.34183661E−04 |
| A14 = | 7.09600473E−05 | 4.39768939E−04 | 2.72639372E−04 | −7.04846060E−05 |
| A16 = | −4.41466824E−06 | −5.41872056E−05 | −2.77826589E−05 | 1.35919590E−05 |
| A18 = | 8.92096319E−08 | 4.54314656E−06 | 1.68218212E−06 | −2.19798683E−06 |
| A20 = | 1.68690103E−09 | −2.45173117E−07 | −4.69800657E−08 | 2.59145488E−07 |
| A22 = | — | 7.56029177E−09 | −2.01878229E−10 | −1.98937611E−08 |
| A24 = | — | −9.85839947E−11 | 2.98298979E−11 | 8.75847258E−10 |
| A26 = | — | — | — | −1.66802724E−11 |
| Surface # | 15 | 16 | 17 | 18 |
| k = | −1.00000E+00 | 0.00000E+00 | −1.00000E+00 | −1.00000E+00 |
| A4 = | −5.65204995E−04 | 7.60907472E−03 | −5.53625235E−02 | −6.61106392E−02 |
| A6 = | −6.31706689E−03 | −1.98132874E−03 | 7.89702328E−03 | 1.22272832E−02 |
| A8 = | 2.96412163E−03 | 1.67647181E−04 | −1.17917562E−03 | −1.88592914E−03 |
| A10 = | −8.81132578E−04 | −1.11846806E−05 | 1.55336633E−04 | 2.20104568E−04 |
| A12 = | 1.72494588E−04 | 8.88465799E−07 | −1.41758230E−05 | −1.89058954E−05 |
| A14 = | −2.29942602E−05 | −6.59610344E−08 | 8.56470944E−07 | 1.18842461E−06 |
| A16 = | 2.09516638E−06 | 3.31637207E−09 | −3.43144609E−08 | −5.42643730E−08 |
| A18 = | −1.28011766E−07 | −1.00528937E−10 | 9.03473022E−10 | 1.76996463E−09 |
| A20 = | 4.99794456E−09 | 1.66326392E−12 | −1.50369292E−11 | −3.99858162E−11 |
| A22 = | −1.12225397E−10 | −1.15616571E−14 | 1.43464237E−13 | 5.92017416E−13 |
| A24 = | 1.09756769E−12 | — | −5.97773459E−16 | −5.15225452E−15 |
| A26 = | — | — | — | 1.99396616E−17 |

In the 4th embodiment, the equation of the aspheric surface profiles of the aforementioned lens elements is the same as the equation of the 1st embodiment. Also, the definitions of these parameters shown in Table 4C below are the same as those stated in the 1st embodiment, with corresponding values for the 4th embodiment; therefore, an explanation in this regard will not be provided again.

Moreover, these parameters can be calculated from Table 4A and Table 4B as the following values and satisfy the following conditions:

TABLE 4C
Values of Optical and Physical Parameters/Definitions

| | | | |
|---|---|---|---|
| f [mm] | 6.84 | R16/BL | 1.04 |
| Fno | 1.68 | T12/T23 | 0.17 |
| HFOV [deg.] | 44.7 | (CT5 + T56)/CT6 | 0.50 |
| FOV [deg.] | 89.4 | ATmax/CT7 | 1.08 |
| TL/f | 1.62 | T67/T78 | 0.07 |
| ImgH/EPD | 1.70 | V2/V3 | 0.67 |
| f/f12 | −0.02 | V5/V3 | 0.33 |
| f5/f1 | 0.11 | ET6/CT6 | 0.31 |
| f6/f1 | −0.22 | ET78/ET67 | 0.21 |
| f5/f6 | −0.51 | ET7/ET8 | 2.07 |
| R14/R1 | −0.05 | Y6R1/Y7R2 | 0.59 |
| R4/R6 | −0.19 | SAG3R1/SAG3R2 | −0.52 |
| \|R15/R9\| | 0.52 | SAG7R2/CT7 | 0.65 |

### 5th Embodiment

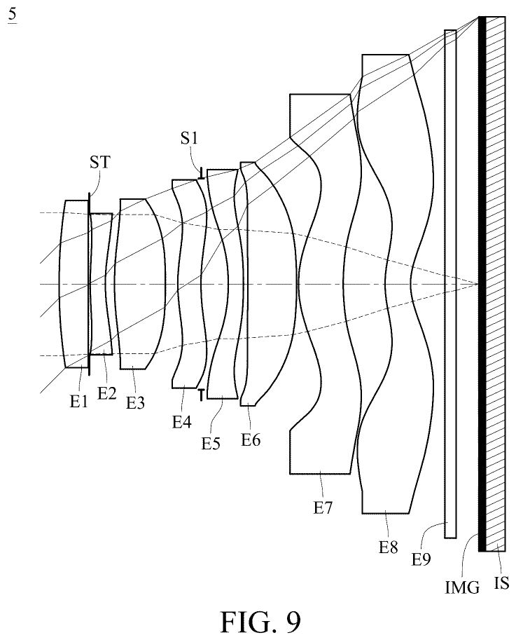

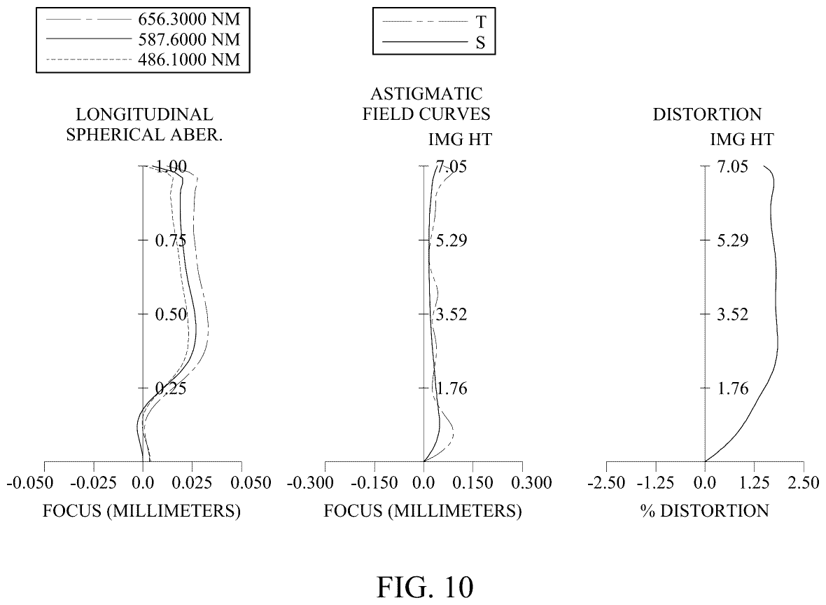

FIG. 9 is a schematic view of an image capturing unit according to the 5th embodiment of the present disclosure. FIG. 10 shows, in order from left to right, spherical aberration curves, astigmatic field curves and a distortion curve of the image capturing unit according to the 5th embodiment. In FIG. 9, the image capturing unit 5 includes the optical photographing lens system (its reference numeral is omitted) of the present disclosure and an image sensor IS. The optical photographing lens system includes, in order from an object side to an image side along an optical path, a first lens element E1, an aperture stop ST, a second lens element E2, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with positive refractive power has an object-side surface being convex in a paraxial region thereof and an image-side surface being concave in a paraxial region thereof. The first lens element E1 is made of glass material and has the object-side surface and the image-side surface being both aspheric. The image-side surface of the first lens element E1 has four inflection points. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points. The image-side surface of the third lens element E3 has one inflection point.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The image-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of plastic material and has the object-side surface and the image-side surface being both aspheric. The object-side surface of the sixth lens element E6 has four inflection points. The image-side surface of the sixth lens element E6 has one inflection point. The object-side surface of the sixth lens element E6 has two critical points in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has three inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 5th embodiment are shown in Table 5A and the aspheric surface data are shown in Table 5B below.

TABLE 5A
5th Embodiment
f = 6.90 mm, Fno = 1.83, HFOV = 45.1 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 16.0125 | (ASP) | 0.770 | Glass | 1.806 | 40.7 | 21.88 |
| 2 | | 169.7965 | (ASP) | 0.021 | | | | |
| 3 | Ape. Stop | Plano | | 0.029 | | | | |
| 4 | Lens 2 | 7.8494 | (ASP) | 0.400 | Plastic | 1.587 | 28.3 | −17.88 |
| 5 | | 4.4064 | (ASP) | 0.241 | | | | |
| 6 | Lens 3 | 7.9037 | (ASP) | 1.345 | Plastic | 1.544 | 56.0 | 10.26 |
| 7 | | −17.8909 | (ASP) | 0.326 | | | | |
| 8 | Lens 4 | 4.2726 | (ASP) | 0.612 | Plastic | 1.544 | 56.0 | 31.17 |
| 9 | | 5.4233 | (ASP) | 0.009 | | | | |
| 10 | Stop | Plano | | 0.711 | | | | |
| 11 | Lens 5 | −5.5608 | (ASP) | 0.400 | Plastic | 1.669 | 19.5 | −10.62 |
| 12 | | −26.2827 | (ASP) | 0.120 | | | | |
| 13 | Lens 6 | −51.4037 | (ASP) | 1.286 | Plastic | 1.544 | 56.0 | 23.67 |
| 14 | | −10.3877 | (ASP) | 0.050 | | | | |
| 15 | Lens 7 | 3.0745 | (ASP) | 1.180 | Plastic | 1.544 | 56.0 | 9.15 |
| 16 | | 6.9567 | (ASP) | 1.104 | | | | |
| 17 | Lens 8 | 2.6403 | (ASP) | 0.674 | Plastic | 1.534 | 56.0 | −11.83 |
| 18 | | 1.6968 | (ASP) | 0.900 | | | | |

| | | | | | | | |
|---|---|---|---|---|---|---|---|
| 19 | Filter | Plano | 0.300 | Glass | 1.517 | 64.2 | — |
| 20 | | Plano | 0.604 | | | | |
| 21 | Image | Plano | — | | | | |

Note:
Reference wavelength is 587.6 nm (d-line).
An effective radius of the stop S1 (Surface 10) is 2.785 mm.

TABLE 5B
Aspheric Coefficients

| Surface # | 1 | 2 | 4 | 5 |
|---|---|---|---|---|
| k = | 0.00000E+00 | 0.00000E+00 | 0.00000E+00 | 0.00000E+00 |
| A4 = | 1.46705262E−03 | −7.53260111E−03 | −3.74889513E−02 | −3.21486586E−02 |
| A6 = | −6.43334650E−04 | 1.13004903E−02 | 1.39809954E−02 | 1.23094466E−02 |
| A8 = | 3.11996203E−04 | −9.97945067E−03 | 1.08995931E−02 | −1.28610197E−02 |
| A10 = | −1.15245167E−04 | 5.65015427E−03 | −4.38650069E−02 | 1.41393069E−02 |
| A12 = | 3.29738363E−05 | −2.06042197E−03 | 6.18471191E−02 | −1.27514832E−02 |
| A14 = | −6.69737552E−06 | 4.62912099E−04 | −5.31887711E−02 | 8.50896927E−03 |
| A16 = | 8.07818743E−07 | −5.81058706E−05 | 3.06353092E−02 | −4.02160810E−03 |
| A18 = | −4.11597300E−08 | 3.12355362E−06 | −1.20718489E−02 | 1.31938119E−03 |
| A20 = | — | — | 3.21654073E−03 | −2.92319161E−04 |
| A22 = | — | — | −5.54294919E−04 | 4.15664605E−05 |
| A24 = | — | — | 5.57496179E−05 | −3.41514811E−06 |
| A26 = | — | — | −2.48430489E−06 | 1.22966973E−07 |
| Surface # | 6 | 7 | 8 | 9 |
| k = | 0.00000E+00 | 0.00000E+00 | 0.00000E+00 | 0.00000E+00 |
| A4 = | −3.21976069E−03 | −2.92625236E−02 | −3.52268428E−02 | −1.42985475E−02 |
| A6 = | −3.06511672E−03 | 1.18065649E−02 | 7.16791118E−03 | 5.66506413E−03 |
| A8 = | 6.07041984E−03 | −9.47162022E−03 | −4.82374999E−03 | −1.05843981E−02 |
| A10 = | −8.20378931E−03 | 8.16525932E−03 | 2.08910331E−03 | 9.83584186E−03 |
| A12 = | 6.40843115E−03 | −5.93776532E−03 | −3.33772211E−05 | −6.02488053E−03 |
| A14 = | −3.20354994E−03 | 3.26837087E−03 | −6.04312986E−04 | 2.62136862E−03 |
| A16 = | 1.05649395E−03 | −1.32018007E−03 | 4.20849473E−04 | −8.24879786E−04 |
| A18 = | −2.27529025E−04 | 3.82636584E−04 | −1.61532468E−04 | 1.86596000E−04 |
| A20 = | 3.07095036E−05 | −7.65966767E−05 | 4.10185161E−05 | −2.98078970E−05 |
| A22 = | −2.35372621E−06 | 9.76995439E−06 | −7.18439914E−06 | 3.26346341E−06 |
| A24 = | 7.80572068E−08 | −6.21584656E−07 | 8.59313689E−07 | −2.32251129E−07 |
| A26 = | — | −9.73152845E−09 | −6.68455171E−08 | 9.66067608E−09 |
| A28 = | — | 4.18376451E−09 | 3.03697439E−09 | −1.78033421E−10 |
| A30 = | — | −1.92464266E−10 | −6.09582723E−11 | — |
| Surface # | 11 | 12 | 13 | 14 |
| k = | 0.00000E+00 | 0.00000E+00 | 0.00000E+00 | 0.00000E+00 |
| A4 = | −5.89918377E−02 | −1.04026149E−01 | −5.12053479E−02 | 1.77285053E−02 |
| A6 = | 7.35191223E−02 | 1.43826825E−01 | 1.08127797E−01 | −3.83226565E−02 |
| A8 = | −7.28329752E−02 | −1.30706089E−01 | −1.06051224E−01 | 3.59692766E−02 |
| A10 = | 5.51220785E−02 | 8.14225120E−02 | 6.66713126E−02 | −2.43768449E−02 |
| A12 = | −3.12279644E−02 | −3.63979942E−02 | −2.97256688E−02 | 1.21829680E−02 |
| A14 = | 1.34519852E−02 | 1.20900335E−02 | 9.80629894E−03 | −4.50224187E−03 |
| A16 = | −4.38850429E−03 | −3.02786984E−03 | −2.43637070E−03 | 1.23357415E−03 |
| A18 = | 1.06942434E−03 | 5.71994073E−04 | 4.57477016E−04 | −2.50508926E−04 |
| A20 = | −1.91625372E−04 | −8.07260799E−05 | −6.44505395E−05 | 3.74700171E−05 |
| A22 = | 2.47572089E−05 | 8.34746347E−06 | 6.68855722E−06 | −4.06533844E−06 |
| A24 = | −2.23688318E−06 | −6.11773387E−07 | −4.94528716E−07 | 3.10632701E−07 |
| A26 = | 1.33907934E−07 | 2.99983325E−08 | 2.45628460E−08 | −1.58270141E−08 |
| A28 = | −4.76781078E−09 | −8.80377645E−10 | −7.31787187E−10 | 4.82095556E−10 |
| A30 = | 7.64027331E−11 | 1.16642285E−11 | 9.84159629E−12 | −6.63352978E−12 |
| Surface # | 15 | 16 | 17 | 18 |
| k = | −1.00000E+00 | 0.00000E+00 | −1.00000E+00 | −1.00000E+00 |
| A4 = | 8.39111090E−03 | 7.35542904E−03 | −6.48040489E−02 | −7.78463426E−02 |
| A6 = | −1.99612038E−02 | 2.96079432E−03 | 9.21465969E−03 | 1.67978404E−02 |
| A8 = | 1.34644453E−02 | −3.10685020E−03 | −6.72037015E−04 | −3.03779131E−03 |
| A10 = | −6.33512683E−03 | 1.00654770E−03 | −7.44029300E−05 | 4.28764018E−04 |
| A12 = | 2.09269964E−03 | −1.99742872E−04 | 2.92039693E−05 | −4.63801297E−05 |
| A14 = | −4.97243178E−04 | 2.76122232E−05 | −4.15940000E−06 | 3.84639663E−06 |
| A16 = | 8.65056133E−05 | −2.77074880E−06 | 3.61019778E−07 | −2.44161413E−07 |
| A18 = | −1.10972849E−05 | 2.04510454E−07 | −2.12836946E−08 | 1.17711657E−08 |
| A20 = | 1.04641512E−06 | −1.10957572E−08 | 8.84830297E−10 | −4.25054656E−10 |
| A22 = | −7.14962964E−08 | 4.36999902E−10 | −2.61074528E−11 | 1.12524055E−11 |
| A24 = | 3.43665253E−09 | −1.21506732E−11 | 5.37160898E−13 | −2.11130279E−13 |
| A26 = | −1.09981642E−10 | 2.26076449E−13 | −7.34664761E−15 | 2.65118275E−15 |
| A28 = | 2.09976274E−12 | −2.52551858E−15 | 6.01198712E−17 | −1.99436798E−17 |
| A30 = | −1.80633905E−14 | 1.28058914E−17 | −2.22948730E−19 | 6.78588798E−20 |

In the 5th embodiment, the equation of the aspheric surface profiles of the aforementioned lens elements is the same as the equation of the 1st embodiment. Also, the definitions of these parameters shown in Table 5C below are the same as those stated in the 1st embodiment, with corresponding values for the 5th embodiment; therefore, an explanation in this regard will not be provided again.

Moreover, these parameters can be calculated from Table 5A and Table 5B as the following values and satisfy the following conditions:

TABLE 5C
Values of Optical and Physical Parameters/Definitions

| | | | |
|---|---|---|---|
| f[mm] | 6.90 | R16/BL | 0.94 |
| Fno | 1.83 | T12/T23 | 0.21 |
| HFOV [deg.] | 45.1 | (CT5 + T56)/CT6 | 0.40 |
| FOV [deg.] | 90.2 | ATmax/CT7 | 0.94 |
| TL/f | 1.61 | T67/T78 | 0.05 |
| ImgH/EPD | 1.87 | V2/V3 | 0.51 |
| f/f12 | −0.05 | V5/V3 | 0.35 |
| f5/f1 | −0.49 | ET6/CT6 | 0.30 |
| f6/f1 | 1.08 | ET78/ET67 | 0.35 |
| f5/f6 | −0.45 | ET7/ET8 | 1.30 |
| R14/R1 | 0.43 | Y6R1/Y7R2 | 0.61 |
| R4/R6 | −0.25 | SAG3R1/SAG3R2 | −0.33 |
| \|R15/R9\| | 0.47 | SAG7R2/CT7 | 0.15 |

### 6th Embodiment

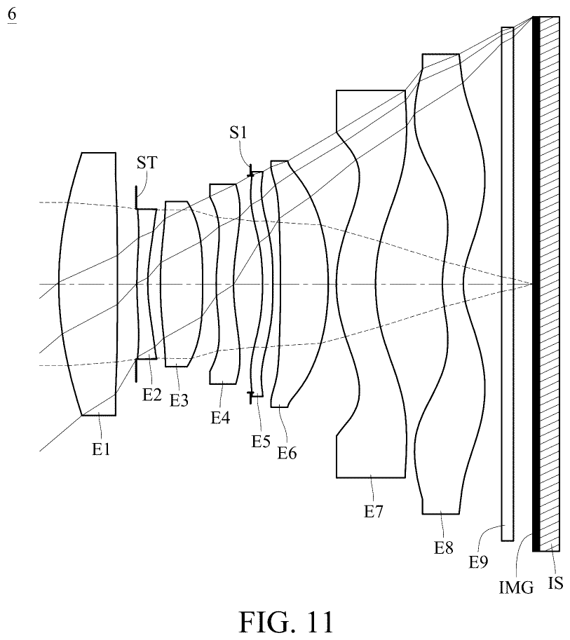

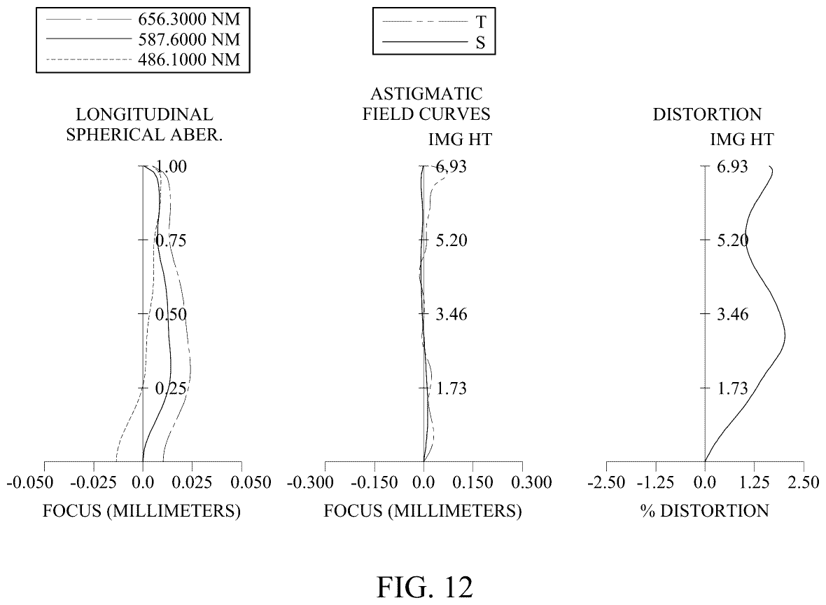

FIG. 11 is a schematic view of an image capturing unit according to the 6th embodiment of the present disclosure. FIG. 12 shows, in order from left to right, spherical aberration curves, astigmatic field curves and a distortion curve of the image capturing unit according to the 6th embodiment. In FIG. 11, the image capturing unit 6 includes the optical photographing lens system (its reference numeral is omitted) of the present disclosure and an image sensor IS. The optical photographing lens system includes, in order from an object side to an image side along an optical path, a first lens element E1, an aperture stop ST, a second lens element E2, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has two inflection points. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The object-side surface of the fifth lens element E5 has one critical point in an off-axis region thereof. The image-side surface of the fifth lens element E5 has one critical point in an off-axis region thereof.

The sixth lens element E6 with positive refractive power has an object-side surface being concave in a paraxial region thereof and an image-side surface being convex in a paraxial region thereof. The sixth lens element E6 is made of glass material and has the object-side surface and the image-side surface being both aspheric. The object-side surface of the sixth lens element E6 has three inflection points. The image-side surface of the sixth lens element E6 has one inflection point.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has three inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 6th embodiment are shown in Table 6A and the aspheric surface data are shown in Table 6B below.

TABLE 6A
6th Embodiment
f = 8.05 mm, Fno = 1.90, HFOV = 40.2 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 8.9275 | (ASP) | 1.519 | Plastic | 1.545 | 56.1 | 16.58 |
| 2 | | 694.0092 | (ASP) | 0.490 | | | | |
| 3 | Ape. Stop | Plano | | 0.018 | | | | |
| 4 | Lens 2 | 8.5264 | (ASP) | 0.282 | Plastic | 1.587 | 28.3 | −16.99 |
| 5 | | 4.5414 | (ASP) | 0.326 | | | | |
| 6 | Lens 3 | 9.5957 | (ASP) | 1.098 | Plastic | 1.544 | 56.0 | 12.70 |
| 7 | | −23.6807 | (ASP) | 0.351 | | | | |
| 8 | Lens 4 | 5.3901 | (ASP) | 0.449 | Plastic | 1.584 | 28.2 | 865.63 |
| 9 | | 5.2808 | (ASP) | 0.442 | | | | |
| 10 | Stop | Plano | | 0.310 | | | | |
| 11 | Lens 5 | −9.5682 | (ASP) | 0.270 | Plastic | 1.669 | 19.5 | −20.84 |
| 12 | | −30.8410 | (ASP) | 0.197 | | | | |
| 13 | Lens 6 | −71.8106 | (ASP) | 1.240 | Glass | 1.564 | 60.8 | 12.74 |
| 14 | | −6.5725 | (ASP) | 0.209 | | | | |
| 15 | Lens 7 | 3.7702 | (ASP) | 1.018 | Plastic | 1.529 | 45.4 | 19.04 |
| 16 | | 5.4621 | (ASP) | 1.732 | | | | |
| 17 | Lens 8 | 3.1144 | (ASP) | 0.541 | Plastic | 1.530 | 55.8 | −9.90 |
| 18 | | 1.8370 | (ASP) | 1.000 | | | | |

| | | | | | | | |
|---|---|---|---|---|---|---|---|
| 19 | Filter | Plano | 0.300 | Glass | 1.517 | 64.2 | — |
| 20 | | Plano | 0.508 | | | | |
| 21 | Image | Plano | — | | | | |

Note:
Reference wavelength is 587.6 nm (d-line).
An effective radius of the stop S1 (Surface 10) is 2.815 mm.

TABLE 6B
Aspheric Coefficients

| Surface # | 1 | 2 | 4 | 5 |
|---|---|---|---|---|
| k = | 0.00000E+00 | 0.00000E+00 | 0.00000E+00 | 0.00000E+00 |
| A4 = | −4.05665425E−04 | −1.33542546E−03 | −2.33474186E−02 | −2.26016233E−02 |
| A6 = | −2.95731518E−05 | 9.19574575E−05 | 3.51550802E−03 | 1.72341642E−03 |
| A8 = | 3.40696113E−06 | −2.48547705E−05 | −1.16391576E−03 | 6.82792983E−04 |
| A10 = | −6.45012620E−07 | 5.93887814E−06 | 5.38349946E−04 | −9.07904700E−04 |
| A12 = | 6.25775022E−08 | −5.47833886E−07 | −1.30377833E−04 | 5.40294335E−04 |
| A14 = | −1.83829212E−09 | 1.79224787E−08 | 1.21446903E−05 | −1.63080465E−04 |
| A16 = | — | — | 6.23255009E−07 | 2.52982485E−05 |
| A18 = | — | — | −1.49166290E−07 | −1.59059894E−06 |
| Surface # | 6 | 7 | 8 | 9 |
| k = | 0.00000E+00 | 0.00000E+00 | 0.00000E+00 | 0.00000E+00 |
| A4 = | −1.49241576E−03 | −2.10571851E−02 | −3.08027468E−02 | −1.45355193E−02 |
| A6 = | −1.08092142E−03 | 4.32985832E−03 | 1.70097313E−03 | −1.68628588E−03 |
| A8 = | 3.74971437E−04 | −9.45231944E−04 | −1.34693592E−04 | 1.63119786E−03 |
| A10 = | −5.36474306E−04 | −3.53919461E−04 | −1.74876263E−04 | −8.22389847E−04 |
| A12 = | 2.86267304E−04 | 3.63074376E−04 | 7.60010354E−05 | 2.86796436E−04 |
| A14 = | −7.40760028E−05 | −1.37429793E−04 | −1.08566610E−05 | −6.79146483E−05 |
| A16 = | 9.56088615E−06 | 2.84945384E−05 | 5.54276675E−07 | 1.02888537E−05 |
| A18 = | −4.13877933E−07 | −3.17915275E−06 | — | −9.32413540E−07 |
| A20 = | −9.96028355E−09 | 1.50502354E−07 | — | 4.50244385E−08 |
| A22 = | — | — | — | −8.55818182E−10 |
| Surface # | 11 | 12 | 13 | 14 |
| k = | 0.00000E+00 | 0.00000E+00 | 0.00000E+00 | 0.00000E+00 |
| A4 = | −4.16764420E−02 | −6.33097303E−02 | −2.22352398E−02 | −8.95129317E−04 |
| A6 = | 2.50642993E−02 | 4.38825263E−02 | 2.46664671E−02 | −1.51211917E−03 |
| A8 = | −1.05866900E−02 | −2.23798132E−02 | −1.38731830E−02 | 1.35723159E−03 |
| A10 = | 3.67756401E−03 | 8.42352117E−03 | 4.84629551E−03 | −9.35301513E−04 |
| A12 = | −8.75357131E−04 | −2.28270238E−03 | −1.13387381E−03 | 4.46249396E−04 |
| A14 = | 1.32249872E−04 | 4.50850126E−04 | 1.79812557E−04 | −1.46661850E−04 |
| A16 = | −1.21005603E−05 | −6.49721522E−05 | −1.90260885E−05 | 3.32787468E−05 |
| A18 = | 6.11269028E−07 | 6.68465538E−06 | 1.28493187E−06 | −5.19419204E−06 |
| A20 = | −1.30975508E−08 | −4.65000220E−07 | −5.08956889E−08 | 5.47006971E−07 |
| A22 = | — | 1.95122850E−08 | 1.01884039E−09 | −3.71069754E−08 |
| A24 = | — | −3.70794717E−10 | −8.02940683E−12 | 1.46315430E−09 |
| A26 = | — | — | — | −2.54516646E−11 |
| Surface # | 15 | 16 | 17 | 18 |
| k = | −1.00000E+00 | 0.00000E+00 | −1.00000E+00 | −1.00000E+00 |
| A4 = | 2.25763009E−03 | 9.49133526E−03 | −6.11687104E−02 | −7.08700849E−02 |
| A6 = | −3.92811728E−03 | −2.67696488E−03 | 1.06292679E−02 | 1.46422948E−02 |
| A8 = | 1.14943974E−03 | 1.36124915E−04 | −1.47050757E−03 | −2.38132422E−03 |
| A10 = | −2.89342093E−04 | 2.07894086E−05 | 1.47872085E−04 | 2.82868384E−04 |
| A12 = | 5.42840981E−05 | −4.34230855E−06 | −9.92463993E−06 | −2.42785358E−05 |
| A14 = | −7.21294380E−06 | 3.76154473E−07 | 4.35379685E−07 | 1.50563678E−06 |
| A16 = | 6.69227630E−07 | −1.87293330E−08 | −1.22349477E−08 | −6.72133849E−08 |
| A18 = | −4.26595296E−08 | 5.52876409E−10 | 2.07196902E−10 | 2.13372652E−09 |
| A20 = | 1.78507256E−09 | −8.99810662E−12 | −1.75008773E−12 | −4.69124996E−11 |
| A22 = | −4.39870612E−11 | 6.22480761E−14 | 1.48162021E−15 | 6.78176096E−13 |
| A24 = | 4.80513696E−13 | — | 5.66068822E−17 | −5.79269302E−15 |
| A26 = | — | — | — | 2.21339391E−17 |

In the 6th embodiment, the equation of the aspheric surface profiles of the aforementioned lens elements is the same as the equation of the 1st embodiment. Also, the definitions of these parameters shown in Table 6C below are the same as those stated in the 1st embodiment, with corresponding values for the 6th embodiment; therefore, an explanation in this regard will not be provided again.

Moreover, these parameters can be calculated from Table 6A and Table 6B as the following values and satisfy the following conditions:

TABLE 6C
Values of Optical and Physical Parameters/Definitions

| | | | |
|---|---|---|---|
| f [mm] | 8.05 | R16/BL | 1.02 |
| Fno | 1.90 | T12/T23 | 1.56 |
| HFOV [deg.] | 40.2 | (CT5 + T56)/CT6 | 0.38 |
| FOV [deg.] | 80.4 | ATmax/CT7 | 1.70 |
| TL/f | 1.53 | T67/T78 | 0.12 |
| ImgH/EPD | 1.64 | V2/V3 | 0.51 |
| f/f12 | 0.07 | V5/V3 | 0.35 |
| f5/f1 | −1.26 | ET6/CT6 | 0.35 |
| f6/f1 | 0.77 | ET78/ET67 | 0.36 |
| f5/f6 | −1.64 | ET7/ET8 | 1.88 |
| R14/R1 | 0.61 | Y6R1/Y7R2 | 0.60 |
| R4/R6 | −0.19 | SAG3R1/SAG3R2 | −0.33 |
| \|R15/R9\| | 0.33 | SAG7R2/CT7 | 0.75 |

### 7th Embodiment

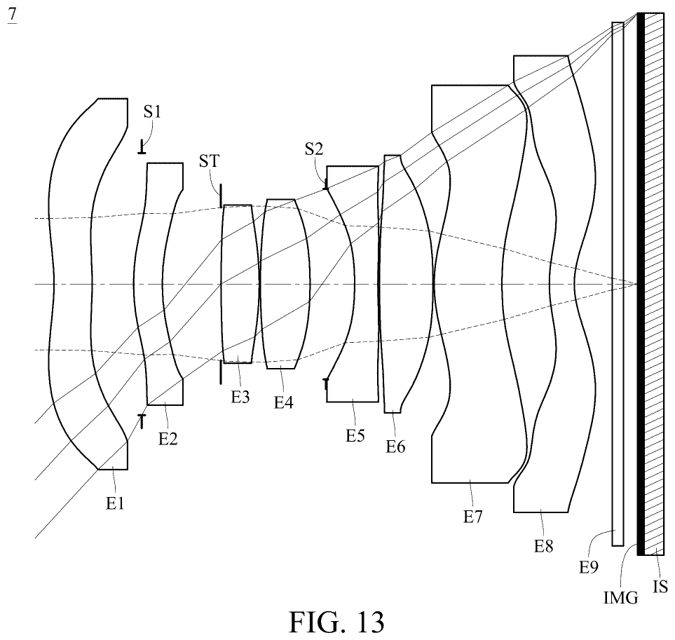

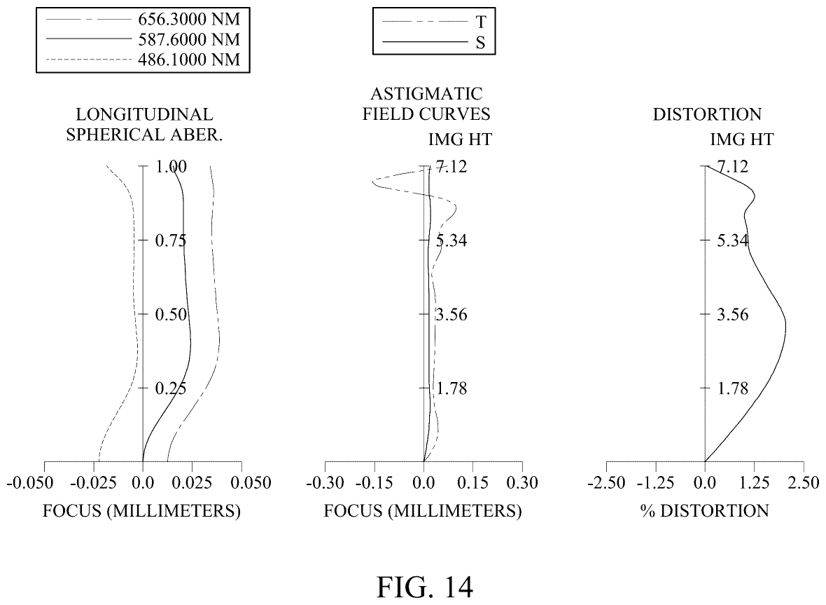

FIG. 13 is a schematic view of an image capturing unit according to the 7th embodiment of the present disclosure. FIG. 14 shows, in order from left to right, spherical aberration curves, astigmatic field curves and a distortion curve of the image capturing unit according to the 7th embodiment. In FIG. 13, the image capturing unit 7 includes the optical photographing lens system (its reference numeral is omitted) of the present disclosure and an image sensor IS. The optical photographing lens system includes, in order from an object side to an image side along an optical path, a first lens element E1, a stop S1, a second lens element E2, an aperture stop ST, a third lens element E3, a fourth lens element E4, a stop S2, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with negative refractive power has an object-side surface being concave in a paraxial region thereof and an image-side surface being convex in a paraxial region thereof. The first lens element E1 is made of plastic material and has the object-side surface and the image-side surface being both aspheric. The object-side surface of the first lens element E1 has two inflection points. The image-side surface of the first lens element E1 has two inflection points. The object-side surface of the first lens element E1 has one critical point in an off-axis region thereof. The image-side surface of the first lens element E1 has one critical point in an off-axis region thereof.

The second lens element E2 with positive refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has two inflection points.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The image-side surface of the third lens element E3 has one inflection point.

The fourth lens element E4 with positive refractive power has an object-side surface being convex in a paraxial region thereof and an image-side surface being convex in a paraxial region thereof. The fourth lens element E4 is made of plastic material and has the object-side surface and the image-side surface being both aspheric. The image-side surface of the fourth lens element E4 has one inflection point.

The fifth lens element E5 with negative refractive power has an object-side surface being concave in a paraxial region thereof and an image-side surface being concave in a paraxial region thereof. The fifth lens element E5 is made of plastic material and has the object-side surface and the image-side surface being both aspheric. The object-side surface of the fifth lens element E5 has one inflection point. The image-side surface of the fifth lens element E5 has three inflection points. The image-side surface of the fifth lens element E5 has three critical points in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has one critical point in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has four inflection points. The image-side surface of the eighth lens element E8 has two inflection points. The object-side surface of the eighth lens element E8 has one critical point in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 7th embodiment are shown in Table 7A and the aspheric surface data are shown in Table 7B below.

TABLE 7A
7th Embodiment
f = 6.52 mm, Fno = 1.88, HFOV = 47.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | −6.0077 | (ASP) | 1.006 | Plastic | 1.545 | 56.1 | −31.79 |
| 2 | | −9.7412 | (ASP) | 1.310 | | | | |
| 3 | Stop | Plano | | −0.215 | | | | |
| 4 | Lens 2 | 5.4225 | (ASP) | 0.757 | Plastic | 1.566 | 37.4 | 309.20 |
| 5 | | 5.3135 | (ASP) | 1.544 | | | | |
| 6 | Ape. Stop | Plano | | 0.005 | | | | |
| 7 | Lens 3 | 40.4289 | (ASP) | 1.005 | Plastic | 1.544 | 56.0 | 12.50 |
| 8 | | −8.1066 | (ASP) | 0.030 | | | | |
| 9 | Lens 4 | 16.6182 | (ASP) | 1.309 | Plastic | 1.544 | 56.0 | 11.38 |
| 10 | | −9.5974 | (ASP) | 0.416 | | | | |
| 11 | Stop | Plano | | 0.760 | | | | |
| 12 | Lens 5 | −7.6140 | (ASP) | 0.613 | Plastic | 1.615 | 25.3 | −6.89 |
| 13 | | 9.8518 | (ASP) | 0.041 | | | | |
| 14 | Lens 6 | 17.5136 | (ASP) | 1.413 | Plastic | 1.544 | 56.0 | 15.32 |
| 15 | | −15.4486 | (ASP) | 0.030 | | | | |
| 16 | Lens 7 | 3.7868 | (ASP) | 1.787 | Plastic | 1.551 | 44.8 | 11.30 |
| 17 | | 8.0538 | (ASP) | 1.249 | | | | |
| 18 | Lens 8 | 3.4446 | (ASP) | 0.659 | Plastic | 1.562 | 44.6 | −13.50 |
| 19 | | 2.2060 | (ASP) | 1.000 | | | | |

| | | | | | | | |
|---|---|---|---|---|---|---|---|
| 20 | Filter | Plano | 0.300 | Glass | 1.517 | 64.2 | — |
| 21 | | Plano | 0.368 | | | | |
| 22 | Image | Plano | — | | | | |

Note:
Reference wavelength is 587.6 nm (d-line).
An effective radius of the stop S1 (Surface 3) is 3.454 mm.
An effective radius of the stop S2 (Surface 11) is 2.513 mm.

TABLE 7B
Aspheric Coefficients

| Surface # | 1 | 2 | 4 | 5 |
|---|---|---|---|---|
| k = | 0.00000E+00 | 2.44648E+00 | −6.79367E−01 | −1.55363E+00 |
| A4 = | 2.00219985E−02 | 2.34329616E−02 | 2.98489213E−03 | 1.10755716E−03 |
| A6 = | −3.05112344E−03 | −3.92555053E−03 | −4.34016313E−03 | −3.97158929E−03 |
| A8 = | 4.99197521E−04 | 7.15871923E−04 | 1.15013512E−03 | 2.12536986E−03 |
| A10 = | −6.91102836E−05 | −1.18061574E−04 | −2.68908545E−04 | −9.82152327E−04 |
| A12 = | 7.52396825E−06 | 1.61837432E−05 | 4.61077340E−05 | 3.47723961E−04 |
| A14 = | −6.11959086E−07 | −1.68774900E−06 | −4.78256766E−06 | −8.25398502E−05 |
| A16 = | 3.58566119E−08 | 1.23087749E−07 | 2.75698115E−07 | 1.24507054E−05 |
| A18 = | −1.45512274E−09 | −5.77191595E−09 | −7.67734607E−09 | −1.06923604E−06 |
| A20 = | 3.85547581E−11 | 1.54063955E−10 | 6.66491164E−11 | 3.97538011E−08 |
| A22 = | −5.96152791E−13 | −1.76455960E−12 | — | — |
| A24 = | 4.04659019E−15 | — | — | — |
| Surface # | 7 | 8 | 9 | 10 |
| k = | 9.90000E+01 | −5.62424E−01 | 0.00000E+00 | 0.00000E+00 |
| A4 = | 3.87215182E−04 | 2.25549552E−03 | 4.23222477E−04 | −8.49732445E−03 |
| A6 = | −3.43427710E−04 | −8.25000328E−04 | −7.14872458E−04 | −4.23707567E−04 |
| A8 = | 3.04418755E−04 | 5.39472049E−04 | 4.23198094E−04 | 7.44317235E−04 |
| A10 = | −9.41780058E−05 | −1.19572456E−04 | −8.26634962E−05 | −3.80088408E−04 |
| A12 = | 1.99617857E−05 | 1.45326511E−05 | 5.08095941E−06 | 1.21544589E−04 |
| A14 = | −1.67670757E−06 | 6.94282231E−08 | 1.49764071E−06 | −2.26425837E−05 |
| A16 = | — | −1.43456878E−07 | −2.79956600E−07 | 2.30088564E−06 |
| A18 = | — | — | 1.25726014E−08 | −9.73198041E−08 |
| Surface # | 12 | 13 | 14 | 15 |
| k = | 0.00000E+00 | 4.14210E+00 | 1.70422E+01 | 0.00000E+00 |
| A4 = | −2.97585852E−02 | −5.64109652E−02 | −3.21465775E−02 | −1.89075472E−02 |
| A6 = | 1.02757377E−02 | 4.23554805E−02 | 3.60332498E−02 | 5.99407769E−03 |
| A8 = | −4.42471423E−03 | −2.31706496E−02 | −2.17533766E−02 | −2.88098161E−03 |
| A10 = | 1.70845664E−03 | 8.43037140E−03 | 8.17420397E−03 | 1.61670102E−03 |
| A12 = | −4.18958104E−04 | −2.04765531E−03 | −2.05460233E−03 | −6.69659557E−04 |
| A14 = | 6.13726471E−05 | 3.36887386E−04 | 3.56096278E−04 | 1.86813664E−04 |
| A16 = | −5.02697738E−06 | −3.74682309E−05 | −4.28294811E−05 | −3.53054887E−05 |
| A18 = | 1.88313973E−07 | 2.74317447E−06 | 3.51574520E−06 | 4.53974094E−06 |
| A20 = | −1.24013378E−09 | −1.23943489E−07 | −1.87864025E−07 | −3.91576547E−07 |
| A22 = | — | 2.99542689E−09 | 5.88548930E−09 | 2.16827419E−08 |
| A24 = | — | −2.63175498E−11 | −8.19868131E−11 | −6.95852895E−10 |
| A26 = | — | — | — | 9.82261082E−12 |
| Surface # | 16 | 17 | 18 | 19 |
| k = | −8.08767E−01 | 0.00000E+00 | −1.00000E+00 | −1.00000E+00 |
| A4 = | −1.79954191E−02 | 9.21336445E−03 | −4.49498999E−02 | −4.72101972E−02 |
| A6 = | 2.69622235E−03 | −4.04985919E−03 | 1.18119963E−02 | 9.31400609E−03 |
| A8 = | −4.84279488E−04 | 9.01216282E−04 | −4.28530793E−03 | −1.89604129E−03 |
| A10 = | 7.46929248E−05 | −1.51535183E−04 | 1.19394127E−03 | 3.16723269E−04 |
| A12 = | −1.55755834E−05 | 1.84292302E−05 | −2.23921666E−04 | −3.87981063E−05 |
| A14 = | 3.43362069E−06 | −1.52814400E−06 | 2.84455554E−05 | 3.37538298E−06 |
| A16 = | −5.15828174E−07 | 8.38974458E−08 | −2.48486806E−06 | −2.07622684E−07 |
| A18 = | 4.69423973E−08 | −2.97189563E−09 | 1.50555154E−07 | 9.02322989E−09 |
| A20 = | −2.49392956E−09 | 6.47450595E−11 | −6.30905080E−09 | −2.74913822E−10 |
| A22 = | 7.13854138E−11 | −7.81700657E−13 | 1.79312179E−10 | 5.74081816E−12 |
| A24 = | −8.52025045E−13 | 3.95903397E−15 | −3.29819837E−12 | −7.82448376E−14 |
| A26 = | — | — | 3.54173922E−14 | 6.26955624E−16 |
| A28 = | — | — | −1.68610442E−16 | −2.23999039E−18 |

In the 7th embodiment, the equation of the aspheric surface profiles of the aforementioned lens elements is the same as the equation of the 1st embodiment. Also, the definitions of these parameters shown in Table 7C below are the same as those stated in the 1st embodiment, with corresponding values for the 7th embodiment; therefore, an explanation in this regard will not be provided again.

Moreover, these parameters can be calculated from Table 7A and Table 7B as the following values and satisfy the following conditions:

TABLE 7C
Values of Optical and Physical Parameters/Definitions

| | | | |
|---|---|---|---|
| f[mm] | 6.52 | R16/BL | 1.32 |
| Fno | 1.88 | T12/T23 | 0.71 |
| HFOV [deg.] | 47.4 | (CT5 + T56)/CT6 | 0.46 |
| FOV [deg.] | 94.8 | ATmax/CT7 | 0.87 |
| TL/f | 2.36 | T67/T78 | 0.02 |
| ImgH/EPD | 2.05 | V2/V3 | 0.67 |
| f/f12 | −0.19 | V5/V3 | 0.45 |
| f5/f1 | 0.22 | ET6/CT6 | 0.30 |
| f6/f1 | −0.48 | ET78/ET67 | 0.18 |
| f5/f6 | −0.45 | ET7/ET8 | 1.41 |
| R14/R1 | −1.34 | Y6R1/Y7R2 | 0.62 |
| R4/R6 | −0.66 | SAG3R1/SAG3R2 | −0.38 |
| \|R15/R9\| | 0.45 | SAG7R2/CT7 | 0.09 |

### 8th Embodiment

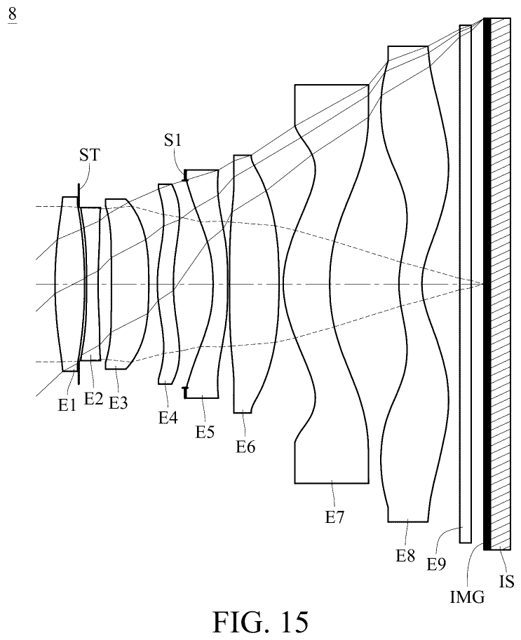

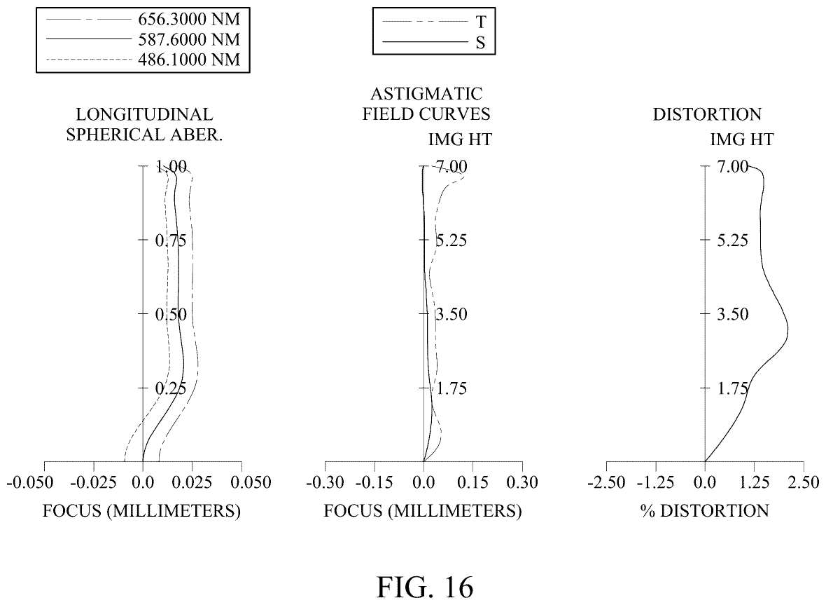

FIG. 15 is a schematic view of an image capturing unit according to the 8th embodiment of the present disclosure. FIG. 16 shows, in order from left to right, spherical aberration curves, astigmatic field curves and a distortion curve of the image capturing unit according to the 8th embodiment. In FIG. 15, the image capturing unit 8 includes the optical photographing lens system (its reference numeral is omitted) of the present disclosure and an image sensor IS. The optical photographing lens system includes, in order from an object side to an image side along an optical path, a first lens element E1, an aperture stop ST, a second lens element E2, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with positive refractive power has an object-side surface being convex in a paraxial region thereof and an image-side surface being convex in a paraxial region thereof. The first lens element E1 is made of plastic material and has the object-side surface and the image-side surface being both aspheric. The object-side surface of the first lens element E1 has one inflection point.

The second lens element E2 with negative refractive power has an object-side surface being concave in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points.

The third lens element E3 with positive refractive power has an object-side surface being concave in a paraxial region thereof and an image-side surface being convex in a paraxial region thereof. The third lens element E3 is made of glass material and has the object-side surface and the image-side surface being both aspheric.

The fourth lens element E4 with positive refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has two inflection points. The image-side surface of the fourth lens element E4 has two inflection points. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being concave in a paraxial region thereof and an image-side surface being convex in a paraxial region thereof. The fifth lens element E5 is made of plastic material and has the object-side surface and the image-side surface being both aspheric. The object-side surface of the fifth lens element E5 has two inflection points. The image-side surface of the fifth lens element E5 has two inflection points. The image-side surface of the fifth lens element E5 has one critical point in an off-axis region thereof.

The sixth lens element E6 with positive refractive power has an object-side surface being convex in a paraxial region thereof and an image-side surface being convex in a paraxial region thereof. The sixth lens element E6 is made of plastic material and has the object-side surface and the image-side surface being both aspheric. The object-side surface of the sixth lens element E6 has three inflection points. The image-side surface of the sixth lens element E6 has one inflection point. The object-side surface of the sixth lens element E6 has two critical points in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has two critical points in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 8th embodiment are shown in Table 8A and the aspheric surface data are shown in Table 8B below.

TABLE 8A
8th Embodiment
f = 7.38 mm, Fno = 1.80, HFOV = 43.1 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 10.2931 | (ASP) | 0.780 | Plastic | 1.544 | 56.0 | 10.83 |
| 2 | | −13.4179 | (ASP) | −0.155 | | | | |
| 3 | Ape. Stop | Plano | | 0.205 | | | | |
| 4 | Lens 2 | −107.1811 | (ASP) | 0.304 | Plastic | 1.566 | 37.4 | −18.18 |
| 5 | | 11.3979 | (ASP) | 0.353 | | | | |
| 6 | Lens 3 | −78.7402 | (ASP) | 0.986 | Glass | 1.552 | 63.4 | 34.14 |
| 7 | | −15.2839 | (ASP) | 0.225 | | | | |
| 8 | Lens 4 | 3.8520 | (ASP) | 0.421 | Plastic | 1.551 | 44.8 | 23.45 |
| 9 | | 5.2765 | (ASP) | 0.307 | | | | |
| 10 | Stop | Plano | | 0.740 | | | | |
| 11 | Lens 5 | −5.5638 | (ASP) | 0.384 | Plastic | 1.639 | 23.5 | −9.33 |
| 12 | | −85.6919 | (ASP) | 0.050 | | | | |
| 13 | Lens 6 | 72.7024 | (ASP) | 1.305 | Plastic | 1.544 | 56.0 | 26.87 |
| 14 | | −18.1784 | (ASP) | 0.111 | | | | |
| 15 | Lens 7 | 2.6866 | (ASP) | 1.223 | Plastic | 1.534 | 56.0 | 8.27 |
| 16 | | 5.7720 | (ASP) | 1.825 | | | | |
| 17 | Lens 8 | 2.8400 | (ASP) | 0.605 | Plastic | 1.544 | 56.0 | −12.09 |
| 18 | | 1.8348 | (ASP) | 1.000 | | | | |

| | | | | | | | |
|---|---|---|---|---|---|---|---|
| 19 | Filter | Plano | 0.300 | Glass | 1.517 | 64.2 | — |
| 20 | | Plano | 0.337 | | | | |
| 21 | Image | Plano | — | | | | |

Note:
Reference wavelength is 587.6 nm (d-line).
An effective radius of the stop S1 (Surface 10) is 2.736 mm.

TABLE 8B
Aspheric Coefficients

| Surface # | 1 | 2 | 4 | 5 |
|---|---|---|---|---|
| k = | 0.00000E+00 | 0.00000E+00 | 0.00000E+00 | 0.00000E+00 |
| A4 = | −1.70489155E−03 | −2.48848842E−03 | −1.29109583E−02 | −6.70658833E−03 |
| A6 = | 7.98487692E−04 | −1.11720750E−03 | −5.83292599E−03 | −8.53471054E−03 |
| A8 = | −5.37251858E−04 | 1.58028129E−03 | 5.68723578E−03 | 5.68520771E−03 |
| A10 = | 1.95541210E−04 | −5.79787307E−04 | −1.97494601E−03 | −2.03595761E−03 |
| A12 = | −3.71514154E−05 | 8.78716848E−05 | 3.63788178E−04 | 5.41201194E−04 |
| A14 = | 2.56987945E−06 | −4.73744420E−06 | −3.61556716E−05 | −1.01574116E−04 |
| A16 = | — | — | 2.29597870E−06 | 1.21375871E−05 |
| A18 = | — | — | −1.25128370E−07 | −6.65753750E−07 |
| Surface # | 6 | 7 | 8 | 9 |
| k = | 0.00000E+00 | 0.00000E+00 | 0.00000E+00 | 0.00000E+00 |
| A4 = | 4.24162524E−03 | −2.63071865E−02 | −3.30824125E−02 | −1.02890083E−02 |
| A6 = | −4.45150354E−03 | 7.66239251E−03 | 5.46964627E−03 | −1.93583103E−03 |
| A8 = | −7.89494903E−04 | −4.30831401E−03 | −3.19201035E−03 | −3.97374679E−04 |
| A10 = | 1.16674376E−03 | 1.83236285E−03 | 1.15147700E−03 | 4.06023017E−04 |
| A12 = | −5.18094786E−04 | −5.38205401E−04 | −2.12064621E−04 | −1.16349156E−04 |
| A14 = | 1.36604801E−04 | 1.06795977E−04 | 1.91998974E−05 | 2.10394236E−05 |
| A16 = | −2.18707199E−05 | −1.39081335E−05 | −6.66912296E−07 | −3.38875939E−06 |
| A18 = | 1.88623895E−06 | 1.07052127E−06 | — | 4.62197401E−07 |
| A20 = | −6.07698258E−08 | −3.70585370E−08 | — | −3.87154005E−08 |
| A22 = | — | — | — | 1.37569097E−09 |
| Surface # | 11 | 12 | 13 | 14 |
| k = | 0.00000E+00 | 0.00000E+00 | 0.00000E+00 | 0.00000E+00 |
| A4 = | −4.91457563E−02 | −6.53454694E−02 | −3.45458465E−03 | −7.79381661E−03 |
| A6 = | 2.96017143E−02 | 4.20356237E−02 | 1.04948655E−02 | −6.97908312E−04 |
| A8 = | −1.08808609E−02 | −1.82475212E−02 | −6.67154148E−03 | 1.27787694E−03 |
| A10 = | 3.13008522E−03 | 5.81510580E−03 | 2.42785408E−03 | −6.26074964E−04 |
| A12 = | −6.75352872E−04 | −1.32632577E−03 | −5.81946778E−04 | 2.04789203E−04 |
| A14 = | 1.00305554E−04 | 2.11813352E−04 | 9.52769209E−05 | −4.97623622E−05 |
| A16 = | −9.42506117E−06 | −2.32011063E−05 | −1.07312579E−05 | 9.01213439E−06 |
| A18 = | 4.99866075E−07 | 1.69249202E−06 | 8.19358641E−07 | −1.18593810E−06 |
| A20 = | −1.14162222E−08 | −7.77635414E−08 | −4.07089750E−08 | 1.08959102E−07 |
| A22 = | — | 1.99655467E−09 | 1.20177438E−09 | −6.57742565E−09 |
| A24 = | — | −2.09419290E−11 | −1.63207014E−11 | 2.33360449E−10 |
| A26 = | — | — | — | −3.67413329E−12 |
| Surface # | 15 | 16 | 17 | 18 |
| k = | −1.00000E+00 | 0.00000E+00 | −1.00000E+00 | −1.00000E+00 |
| A4 = | −1.85406450E−02 | 9.46945718E−03 | −5.29401691E−02 | −6.08557996E−02 |
| A6 = | 3.63462537E−03 | −2.66595127E−03 | 9.29011591E−03 | 1.14483206E−02 |
| A8 = | −8.36291652E−04 | 3.63182593E−04 | −1.50719782E−03 | −1.68977566E−03 |
| A10 = | 1.46325328E−04 | −4.09132926E−05 | 1.80366591E−04 | 1.79932033E−04 |
| A12 = | −2.04421879E−05 | 3.54601213E−06 | −1.42564502E−05 | −1.37841974E−05 |
| A14 = | 2.15589746E−06 | −2.14960919E−07 | 7.43707166E−07 | 7.65143993E−07 |
| A16 = | −1.62412980E−07 | 8.62250041E−09 | −2.58550458E−08 | −3.07160159E−08 |
| A18 = | 8.14479349E−09 | −2.16875394E−10 | 5.94229986E−10 | 8.79668047E−10 |
| A20 = | −2.44891140E−10 | 3.09310021E−12 | −8.68377725E−12 | −1.74656417E−11 |
| A22 = | 3.68292874E−12 | −1.90910228E−14 | 7.31537926E−14 | 2.27878392E−13 |
| A24 = | −1.70202501E−14 | — | −2.70597071E−16 | −1.75427196E−15 |
| A26 = | — | — | — | 6.03136047E−18 |

In the 8th embodiment, the equation of the aspheric surface profiles of the aforementioned lens elements is the same as the equation of the 1st embodiment. Also, the definitions of these parameters shown in Table 8C below are the same as those stated in the 1st embodiment, with corresponding values for the 8th embodiment; therefore, an explanation in this regard will not be provided again.

Moreover, these parameters can be calculated from Table 8A and Table 8B as the following values and satisfy the following conditions:

TABLE 8C
Values of Optical and Physical Parameters/Definitions

| | | | |
|---|---|---|---|
| f[mm] | 7.38 | R16/BL | 1.12 |
| Fno | 1.80 | T12/T23 | 0.14 |
| HFOV [deg.] | 43.1 | (CT5 + T56)/CT6 | 0.33 |
| FOV [deg.] | 86.2 | ATmax/CT7 | 1.49 |
| TL/f | 1.53 | T67/T78 | 0.06 |
| ImgH/EPD | 1.71 | V2/V3 | 0.59 |
| f/f12 | 0.29 | V5/V3 | 0.37 |
| f5/f1 | −0.86 | ET6/CT6 | 0.35 |
| f6/f1 | 2.48 | ET78/ET67 | 0.44 |
| f5/f6 | −0.35 | ET7/ET8 | 1.85 |
| R14/R1 | 0.56 | Y6R1/Y7R2 | 0.62 |
| R4/R6 | −0.75 | SAG3R1/SAG3R2 | 0.24 |
| \|R15/R9\| | 0.51 | SAG7R2/CT7 | 0.84 |

### 9th Embodiment

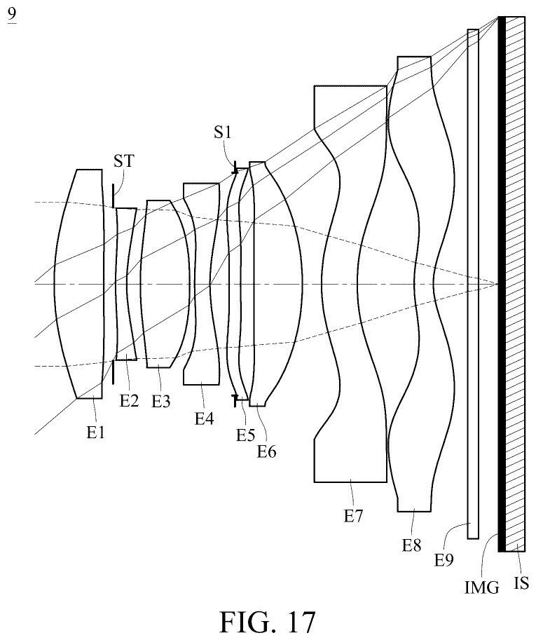

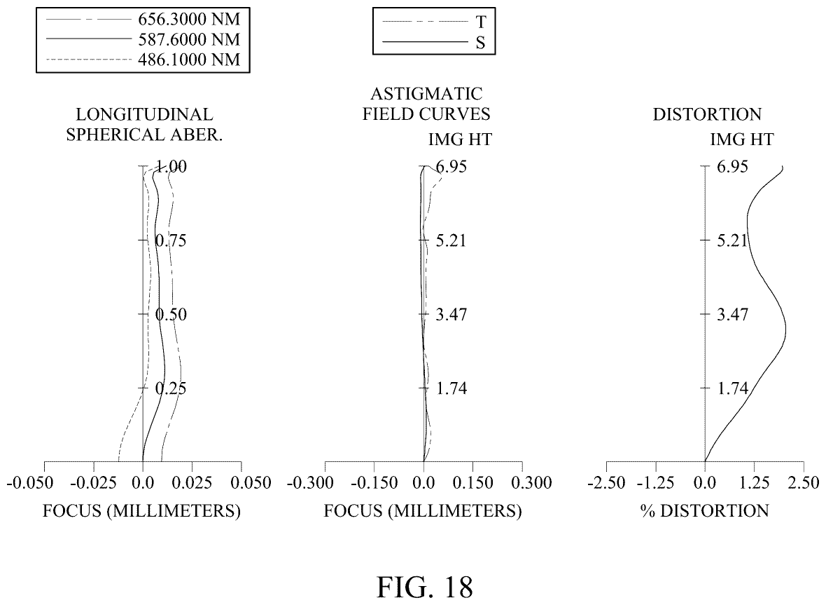

FIG. 17 is a schematic view of an image capturing unit according to the 9th embodiment of the present disclosure. FIG. 18 shows, in order from left to right, spherical aberration curves, astigmatic field curves and a distortion curve of the image capturing unit according to the 9th embodiment. In FIG. 17, the image capturing unit 9 includes the optical photographing lens system (its reference numeral is omitted) of the present disclosure and an image sensor IS. The optical photographing lens system includes, in order from an object side to an image side along an optical path, a first lens element E1, an aperture stop ST, a second lens element E2, a third lens element E3, a fourth lens element E4, a stop S1, a fifth lens element E5, a sixth lens element E6, a seventh lens element E7, an eighth lens element E8, a filter E9 and an image surface IMG. The optical photographing lens system includes eight lens elements (E1, E2, E3, E4, E5, E6, E7 and E8) with no additional lens element disposed between each of the adjacent eight lens elements.

The first lens element E1 with positive refractive power has an object-side surface being convex in a paraxial region thereof and an image-side surface being concave in a paraxial region thereof. The first lens element E1 is made of plastic material and has the object-side surface and the image-side surface being both aspheric. The image-side surface of the first lens element E1 has one inflection point. The image-side surface of the first lens element E1 has one critical point in an off-axis region thereof.

The second lens element E2 with negative refractive power has an object-side surface being convex in a paraxial region thereof and an image-side surface being concave in a paraxial region thereof. The second lens element E2 is made of plastic material and has the object-side surface and the image-side surface being both aspheric. The object-side surface of the second lens element E2 has one inflection point. The image-side surface of the second lens element E2 has two inflection points. The object-side surface of the second lens element E2 has one critical point in an off-axis region thereof.

The third lens element E3 with positive refractive power has an object-side surface being convex in a paraxial region thereof and an image-side surface being convex in a paraxial region thereof. The third lens element E3 is made of plastic material and has the object-side surface and the image-side surface being both aspheric. The object-side surface of the third lens element E3 has two inflection points.

The fourth lens element E4 with negative refractive power has an object-side surface being convex in a paraxial region thereof and an image-side surface being concave in a paraxial region thereof. The fourth lens element E4 is made of plastic material and has the object-side surface and the image-side surface being both aspheric. The object-side surface of the fourth lens element E4 has one inflection point. The image-side surface of the fourth lens element E4 has one inflection point. The object-side surface of the fourth lens element E4 has one critical point in an off-axis region thereof. The image-side surface of the fourth lens element E4 has one critical point in an off-axis region thereof.

The fifth lens element E5 with negative refractive power has an object-side surface being convex in a paraxial region thereof and an image-side surface being concave in a paraxial region thereof. The fifth lens element E5 is made of plastic material and has the object-side surface and the image-side surface being both aspheric. The object-side surface of the fifth lens element E5 has three inflection points. The image-side surface of the fifth lens element E5 has three inflection points. The object-side surface of the fifth lens element E5 has two critical points in an off-axis region thereof. The image-side surface of the fifth lens element E5 has two critical points in an off-axis region thereof.

The sixth lens element E6 with positive refractive power has an object-side surface being convex in a paraxial region thereof and an image-side surface being convex in a paraxial region thereof. The sixth lens element E6 is made of glass material and has the object-side surface and the image-side surface being both aspheric. The object-side surface of the sixth lens element E6 has four inflection points. The image-side surface of the sixth lens element E6 has one inflection point. The object-side surface of the sixth lens element E6 has one critical point in an off-axis region thereof. The image-side surface of the sixth lens element E6 has one critical point in an off-axis region thereof.

The seventh lens element E7 with positive refractive power has an object-side surface being convex in a paraxial region thereof and an image-side surface being concave in a paraxial region thereof. The seventh lens element E7 is made of plastic material and has the object-side surface and the image-side surface being both aspheric. The object-side surface of the seventh lens element E7 has two inflection points. The image-side surface of the seventh lens element E7 has two inflection points. The object-side surface of the seventh lens element E7 has one critical point in an off-axis region thereof. The image-side surface of the seventh lens element E7 has two critical points in an off-axis region thereof.

The eighth lens element E8 with negative refractive power has an object-side surface being convex in a paraxial region thereof and an image-side surface being concave in a paraxial region thereof. The eighth lens element E8 is made of plastic material and has the object-side surface and the image-side surface being both aspheric. The object-side surface of the eighth lens element E8 has two inflection points. The image-side surface of the eighth lens element E8 has three inflection points. The object-side surface of the eighth lens element E8 has two critical points in an off-axis region thereof. The image-side surface of the eighth lens element E8 has one critical point in an off-axis region thereof.

The filter E9 is made of glass material and located between the eighth lens element E8 and the image surface IMG, and does not affect the focal length of the optical photographing lens system. The image sensor IS is disposed on or near the image surface IMG of the optical photographing lens system.

The detailed optical data of the 9th embodiment are shown in Table 9A and the aspheric surface data are shown in Table 9B below.

TABLE 9A
9th Embodiment
f = 8.01 mm, Fno = 1.87, HFOV = 40.4 deg.

| | | | | | | | | Focal |
|---|---|---|---|---|---|---|---|---|
| Surface # | | Curvature Radius | | Thickness | Material | Index | Abbe # | Length |
| 0 | Object | Infinity | | Infinity | | | | |
| 1 | Lens 1 | 6.7296 | (ASP) | 1.295 | Plastic | 1.545 | 56.1 | 13.37 |
| 2 | | 82.3835 | (ASP) | 0.242 | | | | |
| 3 | Ape. Stop | Plano | | 0.066 | | | | |
| 4 | Lens 2 | 8.6149 | (ASP) | 0.290 | Plastic | 1.587 | 28.3 | −14.73 |
| 5 | | 4.2629 | (ASP) | 0.356 | | | | |
| 6 | Lens 3 | 8.2670 | (ASP) | 1.288 | Plastic | 1.544 | 56.0 | 8.75 |
| 7 | | −10.5940 | (ASP) | 0.130 | | | | |
| 8 | Lens 4 | 8.1447 | (ASP) | 0.400 | Plastic | 1.566 | 37.4 | −19.17 |
| 9 | | 4.5704 | (ASP) | 0.650 | | | | |
| 10 | Stop | Plano | | −0.150 | | | | |
| 11 | Lens 5 | 65.2606 | (ASP) | 0.300 | Plastic | 1.587 | 28.3 | −34.10 |
| 12 | | 15.2964 | (ASP) | 0.347 | | | | |
| 13 | Lens 6 | 124.5671 | (ASP) | 1.265 | Glass | 1.552 | 63.4 | 10.30 |
| 14 | | −5.9400 | (ASP) | 0.500 | | | | |
| 15 | Lens 7 | 4.6472 | (ASP) | 0.933 | Plastic | 1.544 | 56.0 | 41.14 |
| 16 | | 5.4502 | (ASP) | 1.484 | | | | |
| 17 | Lens 8 | 3.2547 | (ASP) | 0.500 | Plastic | 1.530 | 55.8 | −9.35 |
| 18 | | 1.8604 | (ASP) | 0.900 | | | | |

| | | | | | | | |
|---|---|---|---|---|---|---|---|
| 19 | Filter | Plano | 0.280 | Glass | 1.517 | 64.2 | — |
| 20 | | Plano | 0.524 | | | | |
| 21 | Image | Plano | — | | | | |

Note:
Reference wavelength is 587.6 nm (d-line).
An effective radius of the stop S1 (Surface 10) is 2.906 mm.

TABLE 9B
Aspheric Coefficients

| Surface # | 1 | 2 | 4 | 5 |
|---|---|---|---|---|
| k = | 0.00000E+00 | 0.00000E+00 | 0.00000E+00 | 0.00000E+00 |
| A4 = | −6.79070558E−04 | −2.52115053E−03 | −2.50848859E−02 | −2.64638538E−02 |
| A6 = | −1.02181339E−04 | 4.08307438E−04 | 6.31198940E−03 | 5.75024023E−03 |
| A8 = | 1.59062214E−05 | −1.82966596E−04 | −2.00280505E−03 | −1.32206056E−03 |
| A10 = | −3.39868774E−06 | 3.80604593E−05 | 4.48078869E−04 | −3.23584808E−05 |
| A12 = | 2.64758262E−07 | −3.50987499E−06 | −2.47627209E−05 | 1.72427900E−04 |
| A14 = | −4.75057436E−09 | 1.25846701E−07 | −1.40952521E−05 | −5.90680067E−05 |
| A16 = | — | — | 3.66942839E−06 | 9.42929588E−06 |
| A18 = | — | — | −2.95964836E−07 | −6.10675066E−07 |
| Surface # | 6 | 7 | 8 | 9 |
| k = | 0.00000E+00 | 0.00000E+00 | 0.00000E+00 | 0.00000E+00 |
| A4 = | −3.15128047E−03 | −2.43792349E−02 | −3.82335879E−02 | −1.79852257E−02 |
| A6 = | −6.16864625E−04 | 7.70123265E−03 | 5.60098906E−03 | −3.36622289E−04 |
| A8 = | 2.82291227E−04 | −2.29230986E−03 | −8.25405052E−04 | 1.93500047E−03 |
| A10 = | −3.18256597E−04 | 1.37389476E−04 | −1.83360413E−04 | −1.15374851E−03 |
| A12 = | 1.63619217E−04 | 1.74178866E−04 | 1.05665373E−04 | 4.04671249E−04 |
| A14 = | −4.84017212E−05 | −7.68787493E−05 | −1.54515882E−05 | −9.36242753E−05 |
| A16 = | 8.65384570E−06 | 1.57414577E−05 | 7.66498536E−07 | 1.41981145E−05 |
| A18 = | −8.06304270E−07 | −1.67191815E−06 | — | −1.33981100E−06 |
| A20 = | 2.92309070E−08 | 7.47416380E−08 | — | 7.07527016E−08 |
| A22 = | — | — | — | −1.58953157E−09 |
| Surface # | 11 | 12 | 13 | 14 |
| k = | 0.00000E+00 | 0.00000E+00 | 0.00000E+00 | 0.00000E+00 |
| A4 = | −3.59777978E−02 | −4.25731575E−02 | −5.07788889E−03 | 6.75635649E−04 |
| A6 = | 1.75703694E−02 | 2.00515167E−02 | 4.23770491E−03 | −2.66194077E−03 |
| A8 = | −5.87295460E−03 | −8.01235979E−03 | −2.00359092E−03 | 2.30780283E−03 |
| A10 = | 1.79911278E−03 | 2.99320068E−03 | 8.21748198E−04 | −1.47046347E−03 |
| A12 = | −4.01841349E−04 | −9.47354983E−04 | −3.10118289E−04 | 6.98062875E−04 |
| A14 = | 5.83329521E−05 | 2.35327934E−04 | 8.92797444E−05 | −2.34218564E−04 |
| A16 = | −5.24207409E−06 | −4.18079086E−05 | −1.78882866E−05 | 5.42623668E−05 |
| A18 = | 2.67693359E−07 | 4.95027213E−06 | 2.39413951E−06 | −8.59918597E−06 |
| A20 = | −6.01339292E−09 | −3.66742211E−07 | −2.03640154E−07 | 9.14601270E−07 |
| A22 = | — | 1.53200693E−08 | 9.93050596E−09 | −6.23903284E−08 |
| A24 = | — | −2.75147709E−10 | −2.10668980E−10 | 2.46501620E−09 |
| A26 = | — | — | — | −4.28428813E−11 |
| Surface # | 15 | 16 | 17 | 18 |
| k = | −1.00000E+00 | 0.00000E+00 | −1.00000E+00 | −1.00000E+00 |
| A4 = | 5.27841649E−03 | 1.06827112E−02 | −6.18716671E−02 | −7.21179661E−02 |
| A6 = | −4.53283500E−03 | −3.89116981E−03 | 1.15312175E−02 | 1.55713996E−02 |
| A8 = | 1.16671621E−03 | 5.27600061E−04 | −1.67021864E−03 | −2.65243348E−03 |
| A10 = | −2.49381396E−04 | −4.74680461E−05 | 1.71155474E−04 | 3.31948111E−04 |
| A12 = | 4.14024389E−05 | 2.90961049E−06 | −1.16127852E−05 | −3.01878111E−05 |
| A14 = | −5.19474180E−06 | −1.17146337E−07 | 5.17897685E−07 | 1.98366348E−06 |
| A16 = | 4.79392343E−07 | 2.98267625E−09 | −1.51062642E−08 | −9.32850562E−08 |
| A18 = | −3.14123692E−08 | −4.70988322E−11 | 2.80274355E−10 | 3.08999237E−09 |
| A20 = | 1.37715182E−09 | 4.74812428E−13 | −3.07500264E−12 | −7.01051714E−11 |
| A22 = | −3.58833779E−11 | −2.94168463E−15 | 1.67054517E−14 | 1.03418972E−12 |
| A24 = | 4.15455399E−13 | — | −2.48817019E−17 | −8.92110209E−15 |
| A26 = | — | — | — | 3.41074311E−17 |

In the 9th embodiment, the equation of the aspheric surface profiles of the aforementioned lens elements is the same as the equation of the 1st embodiment. Also, the definitions of these parameters shown in Table 9C below are the same as those stated in the 1st embodiment, with corresponding values for the 9th embodiment; therefore, an explanation in this regard will not be provided again.

Moreover, these parameters can be calculated from Table 9A and Table 9B as the following values and satisfy the following conditions:

TABLE 9C
Values of Optical and Physical Parameters/Definitions

| | | | |
|---|---|---|---|
| f [mm] | 8.01 | R16/BL | 1.09 |
| Fno | 1.87 | T12/T23 | 0.87 |
| HFOV [deg.] | 40.4 | (CT5 + T56)/CT6 | 0.51 |
| FOV [deg.] | 80.8 | ATmax/CT7 | 1.59 |
| TL/f | 1.45 | T67/T78 | 0.34 |
| ImgH/EPD | 1.62 | V2/V3 | 0.51 |
| f/f12 | 0.12 | V5/V3 | 0.51 |
| f5/f1 | −2.55 | ET6/CT6 | 0.31 |
| f6/f1 | 0.77 | ET78/ET67 | 0.22 |
| f5/f6 | −3.31 | ET7/ET8 | 2.21 |
| R14/R1 | 0.81 | Y6R1/Y7R2 | 0.59 |
| R4/R6 | −0.40 | SAG3R1/SAG3R2 | −0.36 |
| \|R15/R9\| | 0.05 | SAG7R2/CT7 | 0.83 |

### 10th Embodiment

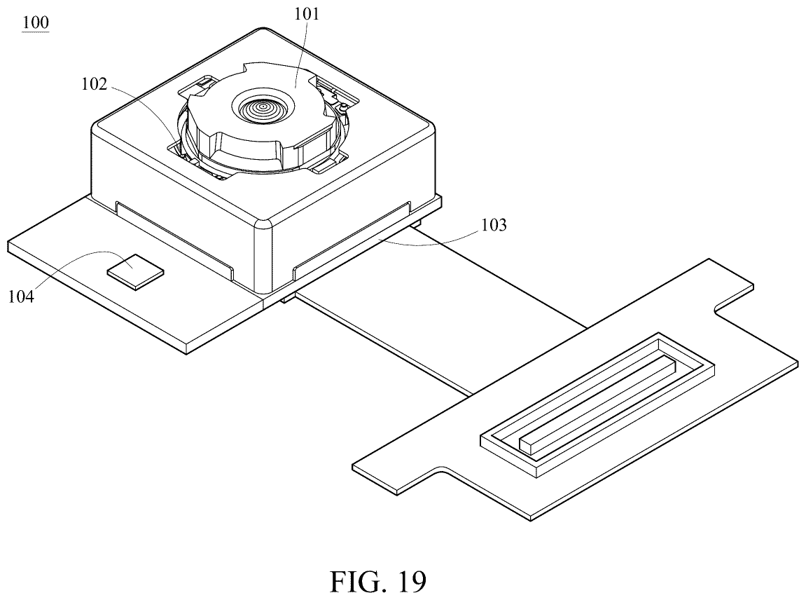

FIG. 19 is a perspective view of an image capturing unit according to the 10th embodiment of the present disclosure. In this embodiment, an image capturing unit 100 is a camera module including a lens unit 101, a driving device 102, an image sensor 103 and an image stabilizer 104. The lens unit 101 includes the optical photographing lens system as disclosed in the 1st embodiment, a barrel and a holder member (their reference numerals are omitted) for holding the optical photographing lens system. However, the lens unit 101 may alternatively be provided with the optical photographing lens system as disclosed in other embodiments of the present disclosure, and the present disclosure is not limited thereto. The imaging light converges in the lens unit 101 of the image capturing unit 100 to generate an image with the driving device 102 utilized for image focusing on the image sensor 103, and the generated image is then digitally transmitted to other electronic component for further processing.

The driving device 102 can have an auto-focusing function, and the driving device 102 can utilize various driving configurations, such as voice coil motors (VCM), micro electro-mechanical systems (MEMS), piezoelectric systems, and shape memory alloys. The driving device 102 is favorable for obtaining a better imaging position for the lens unit 101, so that a clear image of the imaged object can be captured by the lens unit 101 with different object distances. The image sensor 103 (for example, CMOS or CCD), which can feature high photosensitivity and low noise, is disposed on the image surface of the optical photographing lens system to provide higher image quality.

The image stabilizer 104, such as an accelerometer, a gyro sensor and a Hall Effect sensor, is configured to work with the driving device 102 to provide optical image stabilization (OIS). The driving device 102 working with the image stabilizer 104 is favorable for compensating for pan and tilt of the lens unit 101 to reduce blurring associated with motion during exposure. In some cases, the compensation can be provided by electronic image stabilization (EIS) with image processing software, thereby improving image quality while in dynamic or low-light scenarios.

### 11th Embodiment

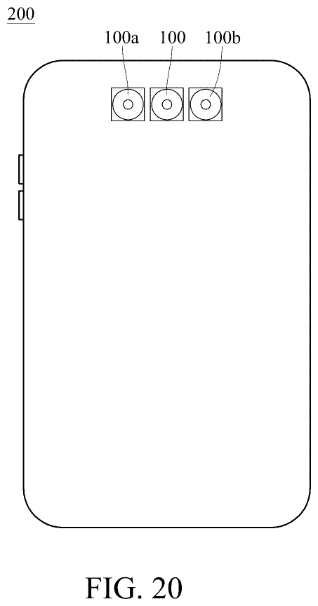

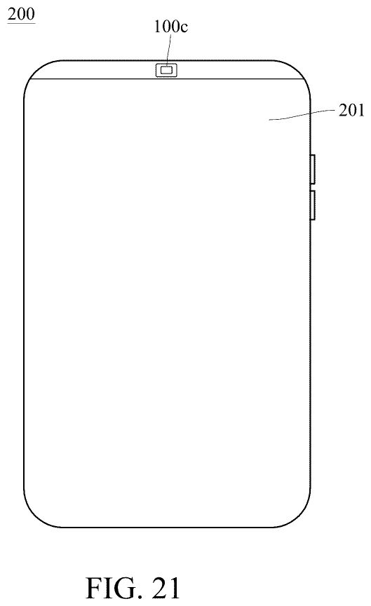

FIG. 20 is one schematic view of an electronic device according to the 11th embodiment of the present disclosure, and FIG. 21 is another schematic view of the electronic device in FIG. 20.

In this embodiment, an electronic device 200 is a smartphone including the image capturing unit 100 as disclosed in the 10th embodiment, an image capturing unit 100a, an image capturing unit 100b, an image capturing unit 100c and a display module 201. As shown in FIG. 20, the image capturing unit 100, the image capturing unit 100a and the image capturing unit 100b are disposed on the same side of the electronic device 200, and each of the image capturing units 100, 100a and 100b has a single focal point. As shown in FIG. 21, the image capturing unit 100c and the display module 201 are disposed on the opposite side of the electronic device 200, allowing the image capturing unit 100c to serve as a front-facing camera of the electronic device 200 for taking selfies, but the present disclosure is not limited thereto. Furthermore, each of the image capturing units 100a, 100b and 100c can include the optical photographing lens system of the present disclosure and can have a configuration similar to that of the image capturing unit 100. In detail, each of the image capturing units 100a, 100b and 100c can include a lens unit, a driving device, an image sensor and an image stabilizer. In addition, each lens unit of the image capturing units 100a, 100b and 100c can include the optical photographing lens system of the present disclosure, a barrel and a holder member for holding the optical photographing lens system.

The image capturing unit 100 is a wide-angle image capturing unit, the image capturing unit 100a is a telephoto image capturing unit, the image capturing unit 100b is an ultra-wide-angle image capturing unit, and the image capturing unit 100c is a wide-angle image capturing unit. In this embodiment, the image capturing units 100, 100a and 100b have different fields of view, such that the electronic device 200 can have various magnification ratios so as to meet the requirement of optical zoom functionality. Moreover, as shown in FIG. 21, the image capturing unit 100c can have a non-circular opening, and the barrel or lens elements in the image capturing unit 100c can have trimmed edges at their outermost positions so as to coordinate with the shape of the non-circular opening. Therefore, it is favorable for reducing the size of the image capturing unit 100c so as to increase the ratio of the area of the display module 201 relative to that of the electronic device 200, and reduce the thickness of the electronic device 200, thereby achieving module miniaturization. In this embodiment, the electronic device 200 includes multiple image capturing units 100, 100a, 100b and 100c, but the present disclosure is not limited to the number and arrangement of image capturing units.

### 12th Embodiment

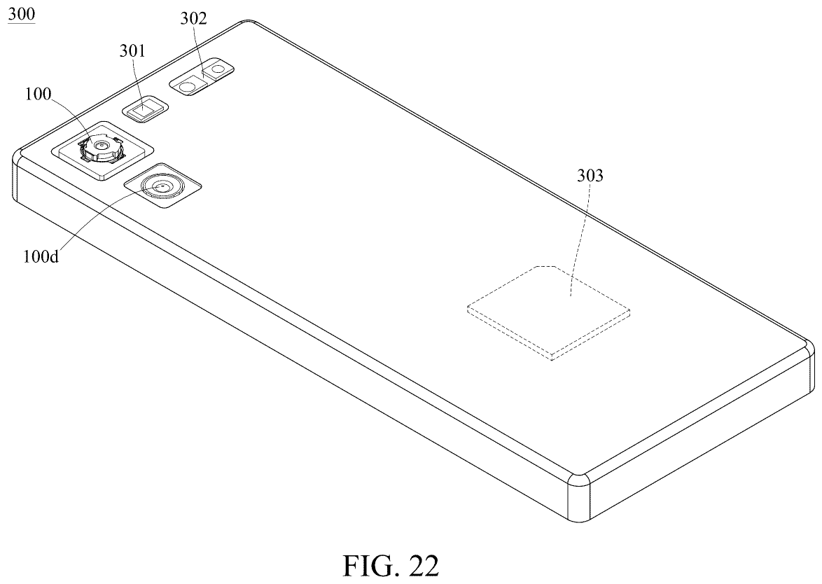

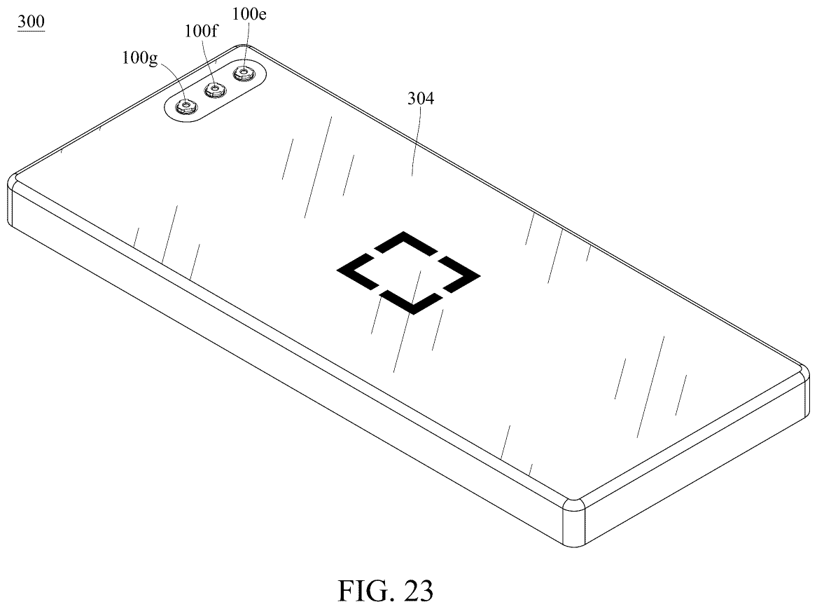

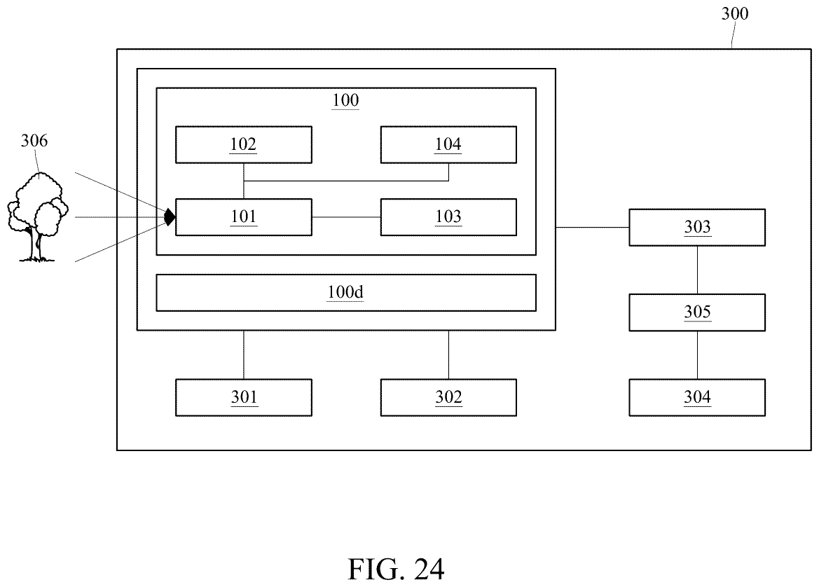

FIG. 22 is one perspective view of an electronic device according to the 12th embodiment of the present disclosure, FIG. 23 is another perspective view of the electronic device in FIG. 22, and FIG. 24 is a block diagram of the electronic device in FIG. 22.

In this embodiment, an electronic device 300 is a smartphone including the image capturing unit 100 as disclosed in the 10th embodiment, an image capturing unit 100d, an image capturing unit 100e, an image capturing unit 100f, an image capturing unit 100g, a flash module 301, a focus assist module 302, an image signal processor 303, a display module 304 and an image software processor 305. The image capturing unit 100 and the image capturing unit 100d are disposed on the same side of the electronic device 300. The focus assist module 302 can be a laser rangefinder or a ToF (time of flight) module, but the present disclosure is not limited thereto. The image capturing unit 100e, image capturing unit 100f, the image capturing unit 100g and the display module 304 are disposed on the opposite side of the electronic device 300, and the display module 304 can serve as a user interface, allowing the image capturing units 100e, 100f and 100g to serve as front-facing cameras of the electronic device 300 for taking selfies, but the present disclosure is not limited thereto. Furthermore, each of the image capturing units 100d, 100e, 100f and 100g can include the optical photographing lens system of the present disclosure and can have a configuration similar to that of the image capturing unit 100. In detail, each of the image capturing units 100d, 100e, 100f and 100g can include a lens unit, a driving device, an image sensor and an image stabilizer. In addition, each lens unit of the image capturing units 100d, 100e, 100f and 100g can include the optical photographing lens system of the present disclosure, a barrel and a holder member for holding the optical photographing lens system.

The image capturing unit 100 is a wide-angle image capturing unit, the image capturing unit 100d is an ultra-wide-angle image capturing unit, the image capturing unit 100e is a wide-angle image capturing unit, the image capturing unit 100f is an ultra-wide-angle image capturing unit, and the image capturing unit 100g is a ToF image capturing unit. In this embodiment, the image capturing units 100 and 100d have different fields of view, such that the electronic device 300 can have various magnification ratios so as to meet the requirement of optical zoom functionality. In addition, the image capturing unit 100g can obtain depth information of the imaged object. In this embodiment, the electronic device 300 includes multiple image capturing units 100, 100d, 100e, 100f and 100g, but the present disclosure is not limited to the number and arrangement of image capturing units.

When a user captures images of an object 306, the light rays converge in the image capturing unit 100 or the image capturing unit 100d to generate images, and the flash module 301 is activated for light supplement. The focus assist module 302 detects the object distance of the imaged object 306 to achieve fast auto focusing. The image signal processor 303 is configured to optimize the captured image to improve image quality. The light beam emitted from the focus assist module 302 can be either conventional infrared or laser. In addition, the light rays may converge in the image capturing unit 100e, 100f or 100g to generate images. The display module 304 can include a touch screen, and the user is able to interact with the display module 304 and the image software processor 305 having multiple functions to capture images and complete image processing. Alternatively, the user may capture images via a physical button. The image processed by the image software processor 305 can be displayed on the display module 304.

### 13th Embodiment

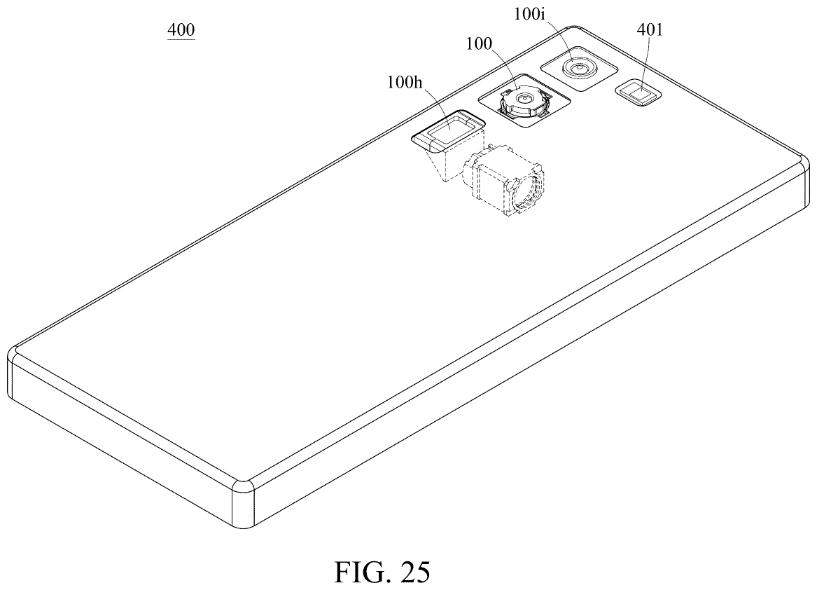

FIG. 25 is a perspective view of an electronic device according to the 13th embodiment of the present disclosure.

In this embodiment, an electronic device 400 is a smartphone including the image capturing unit 100 as disclosed in the 10th embodiment, an image capturing unit 100h, an image capturing unit 100i, a flash module 401, a focus assist module, an image signal processor, a display module, and an image software processor (not shown). The image capturing units 100, 100h and 100i are disposed on the same side of the electronic device 400, while the display module is disposed on the opposite side of the electronic device 400. Furthermore, each of the image capturing units 100h and 100i can include the optical photographing lens system of the present disclosure and can have a configuration similar to that of the image capturing unit 100, and the details in this regard will not be provided again.

The image capturing unit 100 is a wide-angle image capturing unit, the image capturing unit 100h is a telephoto image capturing unit, and the image capturing unit 100i is an ultra-wide-angle image capturing unit. In this embodiment, the image capturing units 100, 100h and 100i have different fields of view, such that the electronic device 400 can have various magnification ratios so as to meet the requirement of optical zoom functionality. In addition, the image capturing unit 100h is a telephoto image capturing unit configured with an optical path folding element, allowing the total track length of the image capturing unit 100h to be unrestricted by the thickness of the electronic device 400. Moreover, the light-folding configuration of the image capturing unit 100h can be similar to, for example, the configuration as shown in FIG. 31, which can be referred to foregoing descriptions corresponding to FIG. 31, and the details in this regard will not be provided again. In this embodiment, the electronic device 400 includes multiple image capturing units 100, 100h and 100i, but the present disclosure is not limited to the number and arrangement of image capturing units. When a user captures images of an object, the light rays converge in the image capturing unit 100, 100h or 100i to generate images, and the flash module 401 is activated for light supplement. Further, the subsequent processes are performed in a manner similar to the abovementioned embodiments, and the details in this regard will not be provided again.

### 14th Embodiment

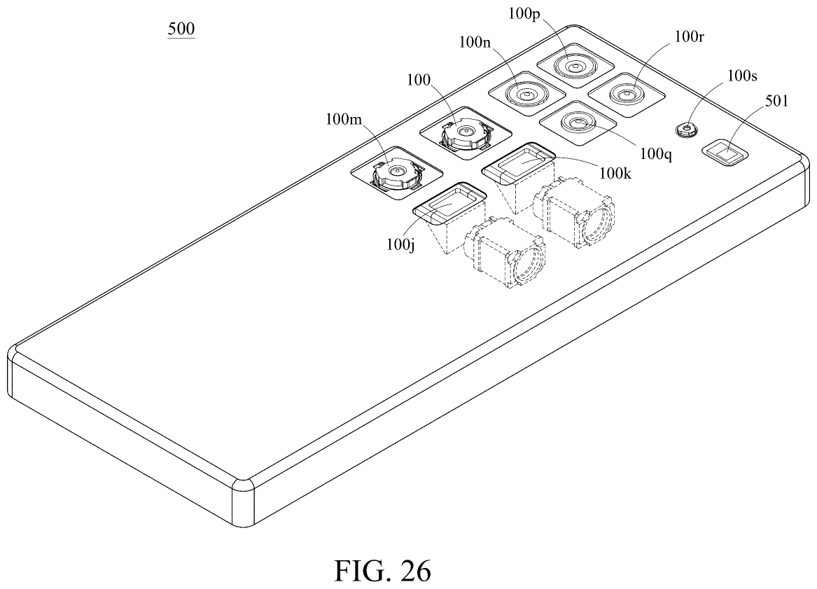

FIG. 26 is a perspective view of an electronic device according to the 14th embodiment of the present disclosure.

In this embodiment, an electronic device 500 is a smartphone including the image capturing unit 100 as disclosed in the 10th embodiment, an image capturing unit 100j, an image capturing unit 100k, an image capturing unit 100m, an image capturing unit 100n, an image capturing unit 100p, an image capturing unit 100q, an image capturing unit 100r, an image capturing unit 100s, a flash module 501, a focus assist module, an image signal processor, a display module, and an image software processor (not shown). The image capturing units 100, 100j, 100k, 100m, 100n, 100p, 100q, 100r and 100s are disposed on the same side of the electronic device 500, while the display module is disposed on the opposite side of the electronic device 500. Furthermore, each of the image capturing units 100j, 100k, 100m, 100n, 100p, 100q, 100r and 100s can include the optical photographing lens system of the present disclosure and can have a configuration similar to that of the image capturing unit 100, and the details in this regard will not be provided again.

The image capturing unit 100 is a wide-angle image capturing unit, the image capturing unit 100j is a telephoto image capturing unit, the image capturing unit 100k is a telephoto image capturing unit, the image capturing unit 100m is a wide-angle image capturing unit, the image capturing unit 100n is an ultra-wide-angle image capturing unit, the image capturing unit 100p is an ultra-wide-angle image capturing unit, the image capturing unit 100q is a telephoto image capturing unit, the image capturing unit 100r is a telephoto image capturing unit, and the image capturing unit 100s is a ToF image capturing unit. In this embodiment, the image capturing units 100, 100j, 100k, 100m, 100n, 100p, 100q and 100r have different fields of view, such that the electronic device 500 can have various magnification ratios so as to meet the requirement of optical zoom functionality. In addition, each of the image capturing unit 100j and the image capturing unit 100k is a telephoto image capturing unit configured with an optical path folding element. Moreover, the light-folding configuration of the image capturing units 100j and 100k can be similar to, for example, the configuration as shown in FIG. 31, which can be referred to foregoing descriptions corresponding to FIG. 31, and the details in this regard will not be provided again. Moreover, the image capturing unit 100s can obtain depth information of the imaged object. In this embodiment, the electronic device 500 includes multiple image capturing units 100, 100j, 100k, 100m, 100n, 100p, 100q, 100r and 100s, but the present disclosure is not limited to the number and arrangement of image capturing units. When a user captures images of an object, the light rays converge in the image capturing unit 100, 100j, 100k, 100m, 100n, 100p, 100q, 100r or 100s to generate images, and the flash module 501 is activated for light supplement. Further, the subsequent processes are performed in a manner similar to the abovementioned embodiments, and the details in this regard will not be provided again.

### 15th Embodiment

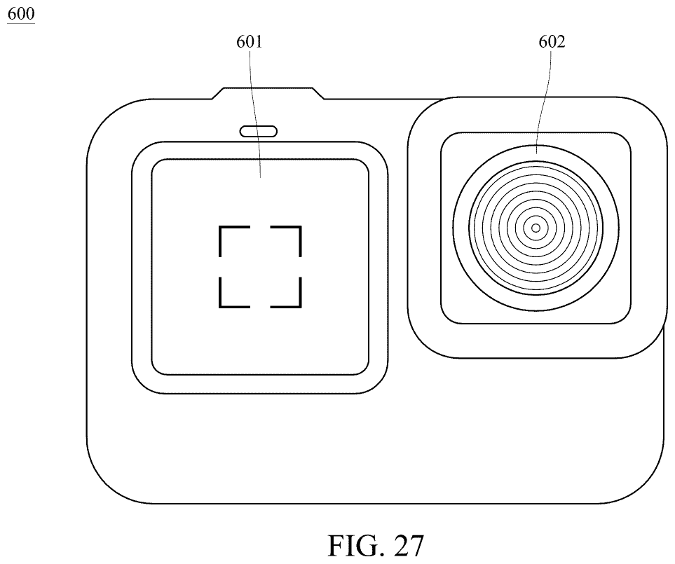

FIG. 27 is a schematic view of an electronic device according to the 15th embodiment of the present disclosure.

In this embodiment, an electronic device 600 is a compact camera, such as an action camera. The electronic device 600 includes a screen 601 and an image capturing unit 602. The image capturing unit 602 is electrically connected to the screen 601. The image capturing unit 602 includes the optical photographing lens system as disclosed in the 1st embodiment. The image capturing unit 602 can be a wide-angle image capturing unit. Similar to the image capturing unit 100, the image capturing unit 602 can further include a barrel, a holder member, or a combination thereof. The electronic device 600 utilizes the image capturing unit 602 for functions such as photographing. Preferably, the electronic device can further include a control unit, a display unit, a storage unit, a random access memory (RAM), or a combination thereof.

### 16th Embodiment

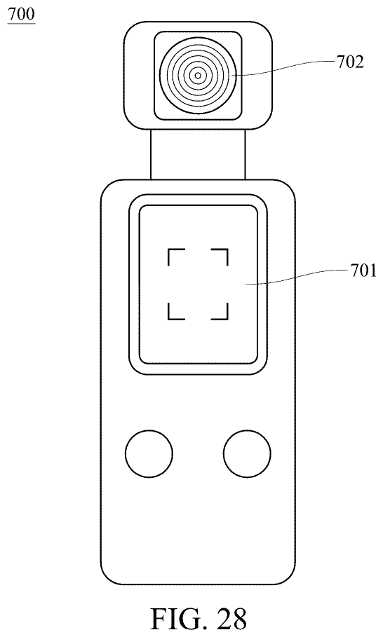

FIG. 28 is a schematic view of an electronic device according to the 16th embodiment of the present disclosure.

In this embodiment, an electronic device 700 is a compact camera, such as a handheld camera. The electronic device 700 includes a screen 701 and an image capturing unit 702. The image capturing unit 702 is electrically connected to the screen 701. The image capturing unit 702 includes the optical photographing lens system as disclosed in the 1st embodiment. The image capturing unit 702 can be a wide-angle image capturing unit. Similar to the image capturing unit 100, the image capturing unit 702 can further include a barrel, a holder member, or a combination thereof. The electronic device 700 utilizes the image capturing unit 702 for functions such as photographing. Preferably, the electronic device can further include a control unit, a display unit, a storage unit, a random access memory (RAM), or a combination thereof.

The smartphones and compact cameras in the embodiments are only exemplary for showing the image capturing unit of the present disclosure installed in an electronic device, and the present disclosure is not limited thereto. The image capturing unit can be optionally applied to optical systems with a movable focus. Furthermore, the optical photographing lens system of the image capturing unit features good capability in aberration corrections and high image quality, and can be applied to 3D (three-dimensional) image capturing applications, in products such as digital cameras, mobile devices, digital tablets, smart televisions, network surveillance devices, dashboard cameras, vehicle backup cameras, multi-camera devices, image recognition systems, motion sensing input devices, wearable devices, and other electronic imaging devices.

The foregoing description, for the purpose of explanation, has been described with reference to specific embodiments. It is to be noted that TABLES 1A-9C show different data of the different embodiments; however, the data of the different embodiments are obtained from experiments. The embodiments were chosen and described in order to best explain the principles of the disclosure and its practical applications, to thereby enable others skilled in the art to best utilize the disclosure and various embodiments with various modifications as are suited to the particular use contemplated. The embodiments depicted above and the appended drawings are exemplary and are not intended to be exhaustive or to limit the scope of the present disclosure to the precise forms disclosed. Many modifications and variations are possible in view of the above teachings.

What is claimed is:

1. An optical photographing lens system comprising eight lens elements, the eight lens elements being, in order from an object side to an image side along an optical path, a first lens element, a second lens element, a third lens element, a fourth lens element, a fifth lens element, a sixth lens element, a seventh lens element and an eighth lens element, and each of the eight lens elements having an object-side surface facing toward the object side and an image-side surface facing toward the image side;
wherein the fifth lens element has negative refractive power, the image-side surface of the sixth lens element is convex in a paraxial region thereof, the seventh lens element has positive refractive power, the object-side surface of the seventh lens element is convex in a paraxial region thereof, the image-side surface of the seventh lens element is concave in a paraxial region thereof, the image-side surface of the seventh lens element has at least one inflection point, the eighth lens element has negative refractive power, the object-side surface of the eighth lens element is convex in a paraxial region thereof, the image-side surface of the eighth lens element is concave in a paraxial region thereof, and the image-side surface of the eighth lens element has at least one inflection point;
wherein a curvature radius of the object-side surface of the first lens element is R1, a curvature radius of the image-side surface of the seventh lens element is R14, an Abbe number of the third lens element is V3, an Abbe number of the fifth lens element is V5, an axial distance between the sixth lens element and the seventh lens element is T67, an axial distance between the seventh lens element and the eighth lens element is T78, and the following conditions are satisfied:
$$- 2.50 < R 14 / R 1 < 1.1 ;$$
$$0.2 < V 5 / V 3 < 0.7 ; and$$
$$0 < T 67 / T 78 < 0.60 .$$

2. The optical photographing lens system of claim 1, wherein the image-side surface of the second lens element is concave in a paraxial region thereof, the third lens element has positive refractive power, the image-side surface of the third lens element is convex in a paraxial region thereof, the object-side surface of the fourth lens element is convex in a paraxial region thereof, and the sixth lens element has positive refractive power.

3. The optical photographing lens system of claim 1, wherein an axial distance between the object-side surface of the first lens element and an image surface is TL, a focal length of the optical photographing lens system is f, and the following condition is satisfied:
$$1.4 < TL / f < 2.70 .$$

4. The optical photographing lens system of claim 1, wherein a focal length of the optical photographing lens system is f, a composite focal length of the first lens element and the second lens element is f12, and the following condition is satisfied:
$$- 0.50 < f / f 12 < 0.50 .$$

5. The optical photographing lens system of claim 1, wherein the image-side surface of the eighth lens element has at least one critical point in an off-axis region thereof; and
wherein the curvature radius of the object-side surface of the first lens element is R1, the curvature radius of the image-side surface of the seventh lens element is R14, and the following condition is satisfied:
$$- 1.8 < R 14 / R 1 < 1. .$$

6. The optical photographing lens system of claim 1, wherein an Abbe number of the second lens element is V2, the Abbe number of the third lens element is V3, the Abbe number of the fifth lens element is V5, and the following conditions are satisfied:
$$0.2 < V 2 / V 3 < 1. ; and$$
$$0.28 < V 5 / V 3 < 0.55 .$$

7. The optical photographing lens system of claim 1, wherein each of at least four lens elements in the optical photographing lens system has a refractive index smaller than 1.75; and
wherein an axial distance between the first lens element and the second lens element is T12, an axial distance between the second lens element and the third lens element is T23, and the following condition is satisfied:
$$0 < T 12 / T 23 < 2.00 .$$

8. The optical photographing lens system of claim 1, wherein a curvature radius of the object-side surface of the fifth lens element is R9, a curvature radius of the object-side surface of the eighth lens element is R15, and the following condition is satisfied:
$$0 < \vert R 15 / R 9 \vert < 0. 80 .$$

9. The optical photographing lens system of claim 1, wherein a focal length of the first lens element is f1, a focal length of the sixth lens element is f6, and the following condition is satisfied:
$$- 0.80 < f 6 / f 1 < 4. .$$

10. The optical photographing lens system of claim 1, wherein a maximum image height of the optical photographing lens system is ImgH, an entrance pupil diameter of the optical photographing lens system is EPD, the axial distance between the sixth lens element and the seventh lens element is T67, the axial distance between the seventh lens element and the eighth lens element is T78, and the following conditions are satisfied:
$$1.45 < ImgH / EPD < 2 \text{.40} ;$$
$$and$$
$$0.01 < T 67 / T 78 < 0.40 .$$

11. The optical photographing lens system of claim 1, wherein a curvature radius of the image-side surface of the second lens element is R4, a curvature radius of the image-side surface of the third lens element is R6, and the following condition is satisfied:
$$- 1.3 < R 4 / R 6 < 0.10 .$$

12. The optical photographing lens system of claim 1, wherein a distance in parallel with an optical axis between a maximum effective radius position of the image-side surface of the sixth lens element and a maximum effective radius position of the object-side surface of the seventh lens element is ET67, a distance in parallel with the optical axis between a maximum effective radius position of the image-side surface of the seventh lens element and a maximum effective radius position of the object-side surface of the eighth lens element is ET78, and the following condition is satisfied:
$$0.05 < ET 78 / ET 67 < 0.65 .$$

13. The optical photographing lens system of claim 1, wherein a displacement in parallel with an optical axis from an axial vertex of the object-side surface of the third lens element to a maximum effective radius position of the object-side surface of the third lens element is SAG3R1, a displacement in parallel with the optical axis from an axial vertex of the image-side surface of the third lens element to a maximum effective radius position of the image-side surface of the third lens element is SAG3R2, a displacement in parallel with the optical axis from an axial vertex of the image-side surface of the seventh lens element to a maximum effective radius position of the image-side surface of the seventh lens element is SAG7R2, a central thickness of the seventh lens element is CT7, and the following conditions are satisfied:
$$- 1. < SAG 3 R 1 / SAG 3 R 2 < 0 \text{.35} ;$$
$$and$$
$$- 0.3 < SAG 7 R 2 / CT 7 < 1.2 .$$

14. An image capturing unit comprising:
the optical photographing lens system of claim 1; and
an image sensor disposed on an image surface of the optical photographing lens system.

15. An optical photographing lens system comprising eight lens elements, the eight lens elements being, in order from an object side to an image side along an optical path, a first lens element, a second lens element, a third lens element, a fourth lens element, a fifth lens element, a sixth lens element, a seventh lens element and an eighth lens element, and each of the eight lens elements having an object-side surface facing toward the object side and an image-side surface facing toward the image side;
wherein the third lens element has positive refractive power, the image-side surface of the sixth lens element is convex in a paraxial region thereof, the seventh lens element has positive refractive power, the object-side surface of the seventh lens element is convex in a paraxial region thereof, the image-side surface of the seventh lens element is concave in a paraxial region thereof, the object-side surface of the seventh lens element has at least one inflection point, the eighth lens element has negative refractive power, the object-side surface of the eighth lens element is convex in a paraxial region thereof, and the image-side surface of the eighth lens element is concave in a paraxial region thereof;
wherein a curvature radius of the object-side surface of the first lens element is R1, a curvature radius of the image-side surface of the seventh lens element is R14, a central thickness of the fifth lens element is CT5, a central thickness of the sixth lens element is CT6, a central thickness of the seventh lens element is CT7, an axial distance between the fifth lens element and the sixth lens element is T56, a maximum value among all axial distances between each of all adjacent lens elements of the optical photographing lens system is ATmax, and the following conditions are satisfied:
$$- 2. 0 < R 14 / R 1 < 1. ;$$
$$0.1 < ( CT 5 + T 56 ) / CT 6 < 0 \text{.90} ;$$
$$and$$
$$0.4 < AT max / CT 7 < 2.20 .$$

16. The optical photographing lens system of claim 15, wherein the image-side surface of the second lens element is concave in a paraxial region thereof, the image-side surface of the third lens element is convex in a paraxial region thereof, the object-side surface of the fourth lens element is convex in a paraxial region thereof, the fifth lens element has negative refractive power, the sixth lens element has positive refractive power, and the object-side surface of the seventh lens element has at least one critical point in an off-axis region thereof.

17. The optical photographing lens system of claim 15, wherein the curvature radius of the object-side surface of the first lens element is R1, the curvature radius of the image-side surface of the seventh lens element is R14, a maximum image height of the optical photographing lens system is ImgH, an entrance pupil diameter of the optical photographing lens system is EPD, and the following conditions are satisfied:
$$- 1.5 < R 14 / R 1 < 0 \text{.95} ;$$
$$and$$
$$1.55 < ImgH / EPD < 2.30 .$$

18. The optical photographing lens system of claim 15, wherein a focal length of the fifth lens element is f5, a focal length of the sixth lens element is f6, an Abbe number of the third lens element is V3, an Abbe number of the fifth lens element is V5, and the following conditions are satisfied:
$$- 5. 0 < f 5 / f 6 < 0 ;$$
$$and$$
$$0.25 < V 5 / V 3 < 0.60 .$$

19. The optical photographing lens system of claim 15, wherein a focal length of the first lens element is f1, a focal length of the fifth lens element is f5, and the following condition is satisfied:
$$- 4.00 < f 5 / f 1 < 0.5 .$$

20. The optical photographing lens system of claim 15, wherein the central thickness of the fifth lens element is CT5, the central thickness of the sixth lens element is CT6, the axial distance between the fifth lens element and the sixth lens element is T56, and the following condition is satisfied:
$$0.15 < ( CT 5 + T 56 ) / CT 6 < 0.70 .$$

21. The optical photographing lens system of claim 15, wherein at least five lens elements in the optical photographing lens system are made of plastic material; and
wherein the maximum value among all axial distances between each of all adjacent lens elements of the optical photographing lens system is ATmax, the central thickness of the seventh lens element is CT7, and the following condition is satisfied:
$$0.6 < AT max / CT 7 < 1.8 .$$

22. The optical photographing lens system of claim 15, wherein a focal length of the first lens element is f1, a focal length of the sixth lens element is f6, and the following condition is satisfied:
$$- 0.70 < f 6 / f 1 < 3.5 .$$

23. The optical photographing lens system of claim 15, wherein a curvature radius of the image-side surface of the eighth lens element is R16, an axial distance between the image-side surface of the eighth lens element and an image surface is BL, an axial distance between the sixth lens element and the seventh lens element is T67, an axial distance between the seventh lens element and the eighth lens element is T78, and the following conditions are satisfied:
$$0.6 < R 16 / BL < 2. ;$$
$$and$$
$$0.01 < T 67 / T 78 < 0.20 .$$

24. The optical photographing lens system of claim 15, wherein a distance in parallel with an optical axis between a maximum effective radius position of the object-side surface of the sixth lens element and a maximum effective radius position of the image-side surface of the sixth lens element is ET6, the central thickness of the sixth lens element is CT6, and the following condition is satisfied:
$$0.15 < ET 6 / CT 6 < 0.80 .$$

25. The optical photographing lens system of claim 15, wherein a distance in parallel with an optical axis between a maximum effective radius position of the object-side surface of the seventh lens element and a maximum effective radius position of the image-side surface of the seventh lens element is ET7, a distance in parallel with the optical axis between a maximum effective radius position of the object-side surface of the eighth lens element and a maximum effective radius position of the image-side surface of the eighth lens element is ET8, a maximum effective radius of the object-side surface of the sixth lens element is Y6R1, a maximum effective radius of the image-side surface of the seventh lens element is Y7R2, and the following conditions are satisfied:
$$0.75 < ET 7 / ET 8 < 2 \text{.50} ;$$
$$and$$
$$0.5 < Y 6 R 1 / Y 7 R 2 < 0.75 .$$

26. The optical photographing lens system of claim 15, wherein the curvature radius of the object-side surface of the first lens element is R1, the curvature radius of the image-side surface of the seventh lens element is R14, an Abbe number of the third lens element is V3, an Abbe number of the fifth lens element is V5, the axial distance between the fifth lens element and the sixth lens element is T56, an axial distance between the sixth lens element and the seventh lens element is T67, an axial distance between the seventh lens element and the eighth lens element is T78, the central thickness of the fifth lens element is CT5, the central thickness of the sixth lens element is CT6, the central thickness of the seventh lens element is CT7, the maximum value among all axial distances between each of all adjacent lens elements of the optical photographing lens system is ATmax, an axial distance between the object-side surface of the first lens element and an image surface is TL, a focal length of the optical photographing lens system is f, a maximum image height of the optical photographing lens system is ImgH, an entrance pupil diameter of the optical photographing lens system is EPD, and the following conditions are satisfied:
$$- 1.34 \leq R 14 / R 1 \leq 0.81 ;$$
$$0.33 \leq V 5 / V 3 \leq 0.51 ;$$
$$0.02 \leq T 67 / T 78 \leq 0 \text{.34} ;$$
$$0.25 \leq ( CT 5 + T 56 ) / CT 6 \leq 0 \text{.51} ;$$
$$0.87 \leq AT max / CT 7 \leq 1.7 ;$$
$$1.45 \leq TL / f \leq 2 \text{.36} ;$$
$$and$$
$$1.62 \leq ImgH / EPD \leq 2.05 .$$

27. An electronic device comprising:
an image capturing unit comprising:
the optical photographing lens system of claim 15; and
an image sensor disposed on an image surface of the optical photographing lens system.
